(19) United States
(12) Patent Application Publication
(10) Pub. No.: US 2005/0113025 A1
(43) Pub. Date: May 26, 2005

(54) Output device, output method, radio communication device, and recording medium

(75) Inventors: Hirotaka Akamatsu, Nagano (JP); Akihito Tanimoto, Nagano (JP); Kiyoshi Hashimoto, Nagano (JP); Masumi Irikura, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/892,474

(22) Filed: Jul. 16, 2004

(30) Foreign Application Priority Data
Jul. 17, 2003 (JP) P2003-198805
Feb. 10, 2004 (JP) P2004-034184
Jul. 16, 2004 (JP) P2004-209758

(51) Int. Cl. H04B 7/00

(52) U.S. Cl. 455/41.3; 455/41.2

(57) ABSTRACT

An output device includes a radio communication interface portion having a communication port that can receive data from a mobile terminal, a displaying portion for informing of a communication state upon receiving the data via the communication port, and an outputting portion for executing an outputting process based on the data that are received via the radio communication interface portion. The displaying portion and the communication port are positioned in a same visual field as an operator who operates the mobile terminal to transmit the data from a position that is a maximum communicable distance away from the communication port.

### BACKGROUND OF THE INVENTION

The present invention relates to an output device for receiving data from a mobile terminal such as a cellular phone, or the like via a radio communication such as an infrared communication, or the like and then executing an outputting process based on the data and, more particularly, to the technology to inform an operator of a communication condition upon receiving the data.

In recent years, most of the cellular phones are normally equipped with the infrared communication port. As its application, the phone number, et al. saved in the cellular phone can be transmitted to other cellular phones via the infrared communication. Also, some of the cellular phones have both a phone book function and a camera function. Personal information prepared by the phone book function and image data picked up by the camera function are saved in the proper file format. For instance, the personal information is saved in a vCard file format, and the image data are saved in a vNote file format. Since the layouts of the data saved in these file formats are decided on the side of the dedicated display application program installed into the cellular phone, the data did not have the layout information in themselves.

The technology to connect the mobile personal computer and the printer via the infrared communication and print the data in the personal computer is known (JP-A-8-300772, for example). In this case, the layout can be set by the application program installed into the mobile personal computer. However, the cellular phone has a limit on the memory capacity and also the cellular phone is not an information device that is originally used for the printing purpose. Therefore, the programs are not installed so far as the print layout setting program, and also it does not suit the actual state to install such program.

Meanwhile, a processing speed of the data transmission in the cellular phone is relatively slow, and it takes several tens second to one minute to transmit the data. In particular, in the case of the infrared communication having a relatively sharp directivity, in many cases the operator watches intently the communication port since the operator has to hold the cellular phone as it is during the data transmission while directing the communication port of the operator's cellular phone to the communication port of the destination. The indication to the effect that an error occurs in the data transmission is displayed on the screen of the cellular phone, nevertheless it is possible that the user who is watching the communication port is not aware of such indication and thus still goes on executing the data transmission. This is not limited to the error situation, and is similarly true of the end-of-transmission situation.

As the printer that can overcome the problem of this type, followings are disclosed. In the printer communication adapter that receives print data from the personal computer, or the like via the infrared communication and then outputs the data to the printer, the display LED is ON-controlled while the communication is established between the personal computer and the printer communication adapter whereas the display LED is ON/OFF-controlled when the communication disturbance is continued for a predetermined time (JP-A-8-300772, for example).

However, even though data in the cellular phone are transmitted to the printer via the infrared communication in the same way, the data cannot be printed or mere character strings of the text data are printed. This problem is caused because there is no compatibility between the data that are transmitted from the cellular phone in a predetermined file format and the data that the printer can print and the layout information are not contained in the data. Therefore, the mere character strings of the text can be printed sometimes if the data contain the text, nevertheless it is impossible substantially to print the data even if it is tried to print the data that have a special format with no compatibility.

Also, in the printer communication adapter set forth in JP-A-8-300772, both the infrared-ray emitting portion and the infrared-ray receiving portion (communication port) are arranged on the front surface, but the display LED is arranged on the top surface side. In the case where the printer is positioned at the same height as the user's eye or the height higher than the user's eye, the user cannot check the display LED. Also, some of the printers have the screen on the operation panel. In this case, it is possible to inform the user of the situation by displaying information such as the receiving error, or the like on the screen, but in many cases the operation panel is also provided onto the top surface of the printer. As a result, similarly it is impossible to inform the user of the receiving error without fail in this case.

Also, in the case where the printer can be adaptive to a plurality of communication systems, normally only one communication system via which the data arrive at for the first time becomes available. Therefore, even though the data are transmitted at that time via other communication system, such data cause the receiving error. However, since the operator cannot decide whether or not the printer is ready for receiving the data, it is possible that the error situation is caused every time when the user transmits the data many times. In addition, the transmitted data are not accepted if the printer cannot respond to such data. In this event, such a problem exists that, if the indication to the effect that the data are not accepted to cause the receiving error is not informed immediately after the start of the transmission, the transmissions executed up to that time come to nothing. Especially the problem of this type is ready to occur if the data are received via the communication adapter that is different from the printer. Also, in the configuration that the data transferring process is carried out between the cellular phone and the communication adapter and between the communication adapter and the main body of the printer, it is possible that the error is detected on the printer side after the data transmission between the cellular phone and the communication adapter is completed and then the communication link between them is disconnected. Like this case, there is no measure to inform the user, who operates the cellular phone, of the effect of the receiving error after the communication link is cut off. As a result, the user feels that the printing is not started although the data transmission results in success.

### SUMMARY OF THE INVENTION

It is an object of the present invention to provide an output device and a radio communication device capable of informing appropriately an operator (user) who makes a data transmission of a communication condition upon transmitting data to the output device from a mobile terminal, or the like via a radio communication.

The gist of the invention is an output device that includes a radio communication interface portion having a communication port that can receive data from a mobile terminal, a displaying portion for informing of a communication state upon receiving the data via the communication port, and an outputting portion for executing an outputting process based on the data that are received via the radio communication interface portion, wherein the displaying portion and the communication port are positioned in a same visual field as an operator who operates the mobile terminal to transmit the data from a position that is a maximum communicable distance away from the communication port.

According to this configuration, when the data are transmitted from the mobile terminal, the operator makes the data transmission to direct the communication port of the mobile terminal to the communication port on the output device side while looking at the communication port as the destination. At this time, since the displaying portion and the communication port are positioned in the same visual field as the operator, the operator can view easily the data receiving condition. In particular, when the communication medium such as the infrared ray having a sharp directivity, or the like is employed, the mobile terminal sometimes fails to transmit the data because of a movement of the user's hand. Therefore, in some cases the operator makes carefully the data transmission while looking at the communication port on the output device side. In this event, for example, when a data transmission speed of the cellular phone is relatively slow, it takes several tens second to one minute, for example, until the data transmission is completed. But the operator can make the data transmission while checking the data receiving state by the displaying portion that is caught immediately by the operator's eye when the operator looks at the communication port of the destination.

The gist of the invention is an output device that includes a radio communication interface portion having a communication port that can receive data from a mobile terminal, a displaying portion for informing of a data receiving in the radio communication interface portion, and an outputting portion for executing an outputting process based on the data that are received via the radio communication interface portion, wherein both the displaying portion and the communication port are positioned in a communicable area of the communication portion when the communication portion of the mobile terminal is placed a maximum communicable distance away from the communication port to oppose to the communication port.

According to this configuration, the user has such an understanding that the user can make the data transmission when the mobile terminal enters into the communicable area off the output device. Thus, it is possible at that time that the user casts naturally his or her eye upon the displaying portion that emits a light, and then makes the data transmission toward the displaying portion as the destination of the eye. In this case, if the user makes the data transmission at a position that is a maximum communication distance away from the output device, the communication port on the output device side is positioned within a communication area of the mobile terminal and therefore the output device can receive the data. In particular, normally it is an isolated case that, when the operator makes the data transmission while looking at the displaying portion, the direction of the transmitted data misses so largely the communication port. Therefore, even when the mobile terminal is positioned closer than the maximum communication distance to make the data transmission, the communication port of the output device can receive the data. Also, when the data are transmitted from the mobile terminal by using the communication medium with the sharp directivity (infrared ray, or the like), for example, the operator makes the data transmission to direct the communication port of the mobile terminal to the communication port of the output device side while looking at the communication port of the destination. In this case, since the displaying portion positioned in vicinity of the looked communication port can inform of the data receiving condition, the operator can also view easily the data receiving condition.

Also, the gist of the present invention is an output device that includes a radio communication device set extractably in a slot that is provided to a main body of an output device, and an outputting portion for executing an outputting process based on data that are received via the radio communication device, wherein a communication port for receiving the data from the mobile terminal and a displaying portion for informing of a communication state upon receiving the data via the communication port are provided to the radio communication device.

According to this configuration, since both the communication port and the displaying portion are provided to the radio communication device, the displaying portion is inevitably positioned near the communication port. For this reason, when the operator makes the data transmission while looking at the communication port of the destination, such operator can also check the data receiving state by the displaying portion that catches the user's eye immediately.

The gist of the present invention is an output device that further includes an indicator, which displays a receiving progress of the data that is being received from the communication port, is provided at a position that satisfies same positional conditions as the displaying portion with respect to the communication port. According to this configuration, since the operator can watch the displaying portion and the indicator simultaneously, such operator can also check both the communication state and the receiving progress.

Also, the gist of the present invention is an output device in which a screen of an operation panel is provided to a main body of the output device to direct upward, and the displaying portion is provided onto a front surface or a side surface of the main body of the output device.

According to this configuration, since the screen of the operation panel is provided upwardly to a top surface of the main body of the printer, for example, it is difficult for the user, who puts out his or her hand from a front position remote from the printer to enter the mobile terminal into the communicable area and make the data transmission, to look at the screen of the operation panel arranged on the top surface. However, since the displaying portion is arranged on the front surface or the side surface of the same main body, the user can see clearly the displaying portion while making the data transmission in such a posture and can check the data receiving state.

The gist of the present invention is an output device in which the communication port is arranged at a position, at which the communication port can receive the data from the communication portion of the mobile terminal that is a maximum communicable distance away from the communication port, on a same plane as a loading plane on which the output device is loaded.

According to this configuration, the data transmission can be made to the output device while the mobile terminal is put on the same loading plane (the desk, the table, or the like) as the output device. For example, in case a data transmission speed from the mobile terminal to the output device is relatively slow, sometimes it takes about several tens second to one minute as a time required for the data transmission. Thus, if the user still holds the mobile terminal in his or her hand, perhaps the user's hand moves in the middle of the data transmission to cause the receiving error. In such case, because the mobile terminal is placed on the same loading surface as the output device to direct the communication port toward the output device side, the user can make the data transmission while putting the mobile terminal on the loading surface.

The gist of the present invention is an output device in which the output device is a printer that executes a printing process as the outputting process, a paper discharge port is provided on a front surface of the output device, and the communication port is arranged on the front surface of the output device on at least one side out of both sides of the paper discharge port.

According to this configuration, the data transmission can be made to the output device while the mobile terminal is put on the same loading plane (the desk, the table, or the like) as the printer as the output device. Also, the paper that is discharged from the paper discharge port, or the like never cuts off the communication.

Also, the gist of the present invention is an output device in which the communication port is arranged at a height of 10 cm or less from a bottom surface of the main body of the output device.

Also, the gist of the present invention is an output device that further includes a holder provided to the main body of the output device to hold the mobile terminal, wherein the communication port is arranged at a position at which the communication port can communicate with the mobile terminal held in the holder, and the displaying portion is arranged at a position at which the displaying portion is not blocked by the mobile terminal held in the holder and the holder. According to this configuration, since the mobile terminal is held in the holder, not only the operator does not have to still hold the mobile terminal in his or her hand during the data transmission but also the transmitting error caused by the movement of the hands is hard to occur. In addition, since the displaying portion is in no way hidden by the holder or the mobile terminal held in the holder, the operator can check the communication state by the displaying portion.

In addition, the gist of the present invention is an output device that includes a first deciding portion built in a radio communication device having a communication port for receiving data from a mobile terminal via a radio communication, a second deciding portion built in a main body of the output device to which the radio communication device is connected to communicate therewith, and a displaying portion for informing respective results of a first check of the data, which are received by the radio communication device, by the first deciding portion and a second check of the data, which are transferred from the radio communication device to the main body of the output device, by the second deciding portion.

According to this, since the radio communication device and the main body of the output device can share the check of data, a burden on the radio communication device in the processing can be reduced. In addition, since the inadequate data can be canceled at an early stage of data reception, i.e., in the radio communication device, a burden on the main body of the output device in the processing can be reduced.

The gist of the present invention is an output device in which the radio communication device includes a first transferring portion for receiving the data from the mobile terminal, and a second transferring portion for transferring the data to the main body of the output device, whereby the displaying portion displays an effect of an error occurrence when the error occurs in the second transferring portion after the first transferring portion completes a transferring process.

According to this, the data transmission is made between the mobile terminal and the radio communication device, and the data transmission is made between the radio communication device and the main body of the output device. When the transfer error occurs in the former transfer, the data are never transferred to the main body side of the output device. Therefore, the request to retransmit can be issued quickly when the transfer error occurs.

The gist of the present invention is an output device that further includes a deciding portion for deciding the communication state, and a display controlling portion for causing the displaying portion to display a result of decision made by the deciding portion.

According to this configuration, the result of decision obtained when the deciding portion decides the communication state is displayed on the displaying portion. The operator can grasp the communication state by watching the displaying portion.

Also, the gist of the present invention is an output device that includes a radio communication interface portion having a communication port that receives data from a mobile terminal, a deciding portion for deciding a communication state upon receiving the data via the communication port, a displaying portion for informing of the communication state, a display controlling portion for causing the displaying portion to display a result of decision made by the deciding portion, and an outputting portion for executing an outputting process based on the data that are received via the radio communication interface portion. According to this configuration, the operator can check the data communication state of the output device by looking at the display on the displaying portion.

Also, in the output device of the present invention, the displaying portion has a screen that displays the to-be-informed communication state by character information. According to this, the operator can check the communication state by the character information.

Also, in the output device of the present invention, the displaying portion is formed of a light emitting portion that informs of the communication state by a lightening mode. According to this configuration, the operator can check the data communication state by the lightening mode of the light emitting portion.

Also, in the output device of the present invention, the displaying portion includes the light emitting portion for informing of the communication state by lightening, and a screen for displaying image or character information to inform of contents of the communication state. According to this, the operator can know not only the communication state indicated by the lightening of the light emitting portion but also the contents of the communication state indicated by the image or character information displayed on the screen.

Also, the gist of the present invention is an output device in which the display controlling portion controls a lightening color of the light emitting portion in response to the result of decision. According to this, since the operator can check the communication state by the lightening color of the light emitting portion, such operator is ready to decide the communication state.

Also, the gist of the present invention is an output device that includes a radio communication interface portion having a communication port for receiving data from a mobile terminal, a deciding portion for deciding a received state via the radio communication interface portion, a displaying portion having a screen for displaying a communication state decided by the deciding portion by using at least one of a character and an image, and an outputting portion for executing an outputting process based on the data that are received via the radio communication interface portion.

According to this configuration, since the received state is informed on the screen by using at least one of a character and an image, the operator can understand directly the received condition in contrast to the lightening display, or the like, for example.

Also, the gist of the present invention is an output device that includes a radio communication device extractably inserted into a slot that is provided to a main body of the output device, and an outputting portion for executing an outputting process based on data that are received via the radio communication device, wherein the radio communication device includes a displaying portion provided to the radio communication device, a deciding portion for deciding a validity of data received by the radio communication device, and a display controlling portion for controlling the displaying portion to a display mode in response to a result of decision made by the deciding portion.

According to this configuration, in the case where particularly the data receiving error is detected after the data communication between the mobile terminal and the output device is disconnected, the output device can inform the user of the receiving error after the communication link between the mobile terminal and the output device is cut off. As a result, even in the case where the error is detected after the communication link is disconnected, such a situation can be avoided that the user, who believes that the data transmission ended in success, feels irritation because the output device will not immediately start to output the data after the data transmission is completed.

Also, in an output device of the present invention that includes a radio communication device extractably set in a slot that is provided to a main body of the output device, and an outputting portion for executing an outputting process based on data that are received via the radio communication device, the radio communication device includes a displaying portion, a deciding portion for deciding a validity of received data, and a display controlling portion for causing the displaying portion to display a result of decision made by the deciding portion.

According to this configuration, when the data that cannot be dealt with (handled) on the output device side are received, such situation is decided in the receiving stage in the radio communication device immediately after the data reception is started, and then the displaying portion is brought into a display mode to inform that effect. Thus, the output device can inform the sender of that effect. For example, when it is decided whether or not the received data can be dealt with in the output device, an informing timing is slightly delayed because it takes a time until the data are transferred into the output device and then the result of decision is returned from the output device to the radio communication device side. Also, even though in particular the receiving error is decided after the data reception from the mobile terminal is completed and then the communication link is disconnected, the output device can inform the user of the receiving error because the displaying portion takes a displaying mode to inform that effect. As a result, when the receiving error is decided after the communication link is disconnected, such a situation can be avoided that the user, who believes that the data transmission resulted in success, feels irritation because the output will not be immediately started after the data transmission is ended. Also, the decision of data validity made by the deciding portion may be executed immediately after the data reception is started. In this case, for example, since it is decided whether or not the received data can be dealt with by the output device directly after the output device finishes receiving the data, such a situation can be avoided that the user is made unpleasant because such user is informed of the error after the user finished transmitting the data by spending about several tens second to one minute. In other words, the output device can detect the error caused by the unacceptable data in an early stage immediately after the data reception is started, and thus the output device can inform quickly the user of that effect. As “immediately after the data reception is started”, a time period of “within 10 second” is preferable, for example, and a time period of “within 5 second” is more preferable.

Also, an output device of the present invention is constructed to provide at least one other communication portion in different communication system to the main body of the output device and inhibit the simultaneous data reception between the radio communication device and other communication portion.

According to this configuration, at least one other communication portion in different communication system is provided to the main body of the output device, and all the radio communication device and other communication portions cannot simultaneously receive the data. In this case, it is decided by the deciding portion in the radio communication device that the data cannot be accepted, the data are by no means transferred to the output device side. Therefore, the data reception of other communication portion is never disturbed by the situation that the communication port is occupied to transfer vainly the data from the radio communication device to the main body side of the output device. As a result, the effective communication can be realized not to disturb unnecessarily the data reception of other communication portion.

Also, the gist of the present invention is an output device that includes a setup portion for setting reference data, which is used by the deciding portion to decide a validity of the received data, into the radio communication device from the main body side of the output device.

According to this configuration, even though acceptable data become different when the type of the output device is different, the reference data can be set in the radio communication device according to the type of device. Therefore, the radio communication device can be used commonly in a plurality of types of device or old and new types of device.

Also, the gist of the present invention is an output device including a radio communication device extractably set in a slot that is provided to a main body of the output device, and an outputting portion for executing an outputting process based on data that are received via the radio communication device, which includes a displaying portion provided to the radio communication device, a deciding portion provided to the main body of the output device to decide a validity of data received via the radio communication device, and a display controlling portion for causing the displaying portion to display a result of decision made by the deciding portion.

According to this configuration, a burden on the radio communication device in the processing can be reduced. More particularly, in the case where the deciding portion is provided to the radio communication portion to execute many decision checks of the received data, normally a buffer for storing the data temporarily must be provided. However, since the decision to check a validity of the data is made on the main body side of the output device, neither the deciding portion having a high processing capability nor the buffer having a relatively large capacity must be provided to the radio communication device. Also, even when particularly the data receiving error is detected after the communication link between the mobile terminal and the output device is disconnected, the output device can inform the user of such receiving error. As a result, in the case where the error is detected after the communication link is disconnected, such a situation can be avoided that the user, who believes that the data transmission ended in success, feels irritation because the output device will not immediately start to output the data after the data transmission is completed.

Also, the gist of the present invention is an output device including a radio communication device extractably set in a slot that is provided to the main body of the output device, and an outputting portion for executing an outputting process based on data that are received via the radio communication device, which includes a displaying portion provided to the radio communication device, a first deciding portion provided to the radio communication device to decide a validity of received data, and a second deciding portion provided to the main body of the output device to decide another validity, contents of which are different from the first deciding portion, of data received via the radio communication device, wherein results of decision made by the first deciding portion and the second deciding portion are displayed on the displaying portion.

According to this configuration, since the radio communication device and the main body of the output device can share the check of data, a burden on the radio communication device in the processing can be reduced. In addition, since the inadequate data can be canceled at an early stage of data reception, i.e., in the radio communication device, a burden on the main body of the output device in the processing can be reduced.

Also, the gist of the present invention is an output device in which the display controlling portion causes the displaying portion to display the effect that the output device is ready for receiving the data when it is decided by the deciding portion that the communication state is a ready-for-receiving state.

According to this configuration, when the output device is ready for receiving the data, the output device can informs the user of that effect. Therefore, such a situation can be avoided that the user is made unpleasant by the error that is caused every time when the user tries to execute the data transmission because such user is not informed of the fact that the output device is unready for receiving the data.

Also, the gist of the present invention is an output device in which the main body of the output device includes at least one communication portion used in another communication system that is different from the radio communication device, the output device cannot simultaneously receive from the communication portion and the communication port of the radio communication device, and the deciding portion decides whether or not the radio communication device is ready for receiving the data.

According to this configuration, when the output device is receiving the data in other communication system and thus the radio communication device is unready for receiving the data, the output device can inform the user of the effect that the radio communication device is unready for receiving the data, by the display mode of the displaying portion. Therefore, such a situation can be avoided that the user is made unpleasant by the error that is caused every time when the user tries to execute the data transmission because such user is not informed of the fact that the output device is unready for receiving the data.

Also, the gist of the present invention is an output device in which the display controlling portion causes the displaying portion to display the effect that the output device is now receiving the data when the communication state decided by the deciding portion is an in-reception state.

According to this configuration, the output device can inform the user of the effect that the output device is receiving the data. Therefore, for example, such a situation can be avoided that, although the output device is now receiving the data, the user (sender) who believes firmly that he or she failed to transmit the data tries again to execute the data transmission.

Also, the gist of the present invention is an output device in which the display controlling portion controls the displaying portion into a display mode indicating the effect that the output device is in a receiving completion state when it is decided by the deciding portion that the communication state is a receiving completion state.

According to this configuration, the output device can inform the user of the fact that the data transmission is completed. Therefore, such a situation can be avoided that, although the data transmission is completed, the user is not aware of such completion after a while after the data transmission is completed until the user checks the display of the mobile terminal.

Also, the gist of the present invention is an output device in which the display controlling portion causes the displaying portion to display the effect that the receiving error occurs when it is decided by the deciding portion that the communication state is an error occurrence state.

According to this configuration, when the user fails to transmit the data (error occurrence) during the data transmission, the output device can inform quickly the user, who holds the mobile terminal while looking at the communication port of the transmission destination, of the effect of failure. Therefore, such a situation can be avoided that, when the data transmission is disconnected in the middle to cause the failure, the user who looks at the communication port during the data transmission continues to transmit the data since the user does not check that effect displayed on the mobile terminal and thus is not aware of the failure for a while.

Also, the gist of the present invention is an output device in which the outputting portion is a printer for executing a printing process as the outputting process.

Also, the gist of the present invention is an output device in which the printing portion starts the printing process after data reception from the mobile terminal is completed.

According to this configuration, since the printing process is started after all the data necessary for the printing are obtained, such a problem can be overcome that the printing is in vain because the data that are now receiving are shut off in the middle.

Also, the gist of the present invention is an output device that includes a radio communication interface portion having a communication port that can receive data from a mobile terminal, an informing portion for informing of a communication state upon receiving the data via the communication port, and an outputting portion for executing an outputting process based on the data that are received via the radio communication interface portion, wherein the informing portion informs of the communication state by a sound that is set previously to different contents in response to the communication state.

According to this configuration, when the output device of the present invention receives the data from the mobile terminal, the speaker as the informing portion can inform the user of the communication state at the communication port by the sound. Therefore, even if the user is in either the place that is remote from the output device or the place where the user cannot see the output device, the user can know the communication state of the output device. Also, in the case where the method of differentiating the ON state, the lightening color, the ON/OFF (flashing) state, or the like of the displaying portion is employed as the informing portion, the user has to know previously which display mode means which communication state. In contrast, if particularly the mechanical synthetic sound of the language explaining the communication state is employed as the sound from the informing portion, the output device can inform the user of its communication state that the output device takes now.

Also, the gist of the present invention is a radio communication device, which is set extractably in a slot that is provided to a main body of an output device, that includes a main body of the communication device set extractably in the slot, a communication port provided to an exposed portion of the main body of the communication device, when inserted into the slot, to receive data from a mobile terminal, and a displaying portion provided to an exposed portion of the main body of the communication device, when inserted into the slot, to display a display mode in response to a communication mode upon receiving the data via the communication port.

According to this configuration, since the user can see the display mode of the display portion provided to the exposed portion of the main body of the radio communication device that is set (inserted) in the slot, such user can know the receiving state of the radio communication device.

Also, the gist of the present invention is a radio communication card, which is set extractably in a slot that is provided to a main body of an output device, that includes a main body of the communication device set extractably in the slot, a communication port provided to an exposed portion of the main body of the communication device, which is inserted into the slot, to receive data from a mobile terminal, a displaying portion provided to an exposed portion of the main body of the communication device, which is inserted into the slot, a monitoring portion for monitoring a communication state upon receiving the data via the communication port, and a display controlling portion for controlling the displaying portion into a display mode in response to a monitoring result obtained by the monitoring portion.

According to this configuration, when the user transmits the data to the output device in the card slot of which the radio communication card is set, such user can grasp the data receiving state on the output device side based on the display mode on the displaying portion.

### BRIEF DESCRIPTION OF THE DRAWINGS

FIG. 1 is a perspective view of a printer in a first embodiment of the present invention;

FIG. 2 is a plan view showing a major portion of an operation panel;

FIG. 3 is a perspective view of a CF-type communication card (infrared communication card);

FIG. 4A is a plan view of a cellular phone, and FIG. 4B is a screen view showing an example of personal information displayed on the cellular phone;

FIG. 5 is an electric block diagram showing electrical configurations of the cellular phone, the infrared communication card, and the printer;

FIG. 6 is a block diagram showing functional configurations of the cellular phone, the infrared communication card, and the printer;

FIG. 7 is a block diagram showing electrical configurations used in a data converting method;

FIG. 8 is a perspective view of a cutter unit;

FIG. 9 is a block diagram showing a shared configuration in the printer;

FIG. 10 is a view of a data structure used in the OBEX transfer;

FIG. 11 is a sequence diagram of data transmission from the cellular phone to the printer;

FIG. 12 is a block diagram showing a display control device in a displaying portion;

FIG. 13 is a table showing an applicable relationship between communication statuses and lightening modes;

FIG. 14 is a transition diagram of the communication status;

FIG. 15 is a transition diagram of the communication status that is different from FIG. 14;

FIG. 16 is a block diagram explaining an interlocking process;

FIG. 17 is a flowchart showing an initial process in recognizing the card;

FIG. 18 is a flowchart showing a data validity deciding process;

FIG. 19 is a sequence diagram explaining an interlock releasing process;

FIG. 20 is a sequence diagram explaining another interlock releasing process;

FIG. 21 is a sequence diagram explaining still another interlock releasing process;

FIG. 22 is a sequence diagram explaining yet still another interlock releasing process;

FIG. 23 is a sequence diagram explaining further interlock releasing process;

FIG. 24 is a sequence diagram showing a contention avoiding process between the infrared communication and the radio wave communication;

FIG. 25A is a screen view informing of a data reception condition,

FIG. 25B is a screen view of images of a moving picture every frame, and

FIG. 25C is a screen view informing of a state that the image is under printing;

FIG. 26 is a view showing data in a vCard file in a single case;

FIG. 27 is a view showing data in a vCard file with an image in a single case;

FIG. 28 is a view showing data in vCard files in all cases;

FIG. 29 is a view showing data in a name-card layout template;

FIG. 30 is a view showing data in an image-attached name-card format template;

FIG. 31 is a view showing data in a template format data;

FIG. 32 is a layout diagram of a name-card format template;

FIGS. 33A to 33C are layout diagrams of the name-card format template, and FIG. 33D is a layout diagram of a phone book format template;

FIGS. 34A and 34B are layout diagrams of the image-attached name-card format template;

FIGS. 35A to 35F are layout diagrams of a template containing an image and a text;

FIGS. 36A to 36C are layout diagrams of a template containing a plurality of texts, and FIGS. 36D to 36F are layout diagrams of a template containing a plurality of images;

FIG. 37 is a flowchart showing a process in an IrDA profile portion;

FIG. 38 is a flowchart showing a cut controlling process;

FIGS. 39A and 39B are screen views showing an example of personal information displayed on the cellular phone in a second embodiment of the present invention;

FIG. 40 is a flowchart showing a process in an IrDA profile portion in a third embodiment of the present invention;

FIG. 41 is a layout diagram of a name-card format template for use in printing the personal information in all cases;

FIG. 42 is a perspective view of a printer in which two card slots are provided in a fourth embodiment of the present invention;

FIG. 43 is a block diagram showing electrical configurations of the printer in which two card slots are provided, the infrared communication card, and the cellular phone;

FIG. 44 is a sequence diagram showing a contention avoiding process between the infrared communication card and the memory card;

FIG. 45 is a block diagram showing functional configurations of major portions of a printer in a fifth embodiment of the present invention;

FIG. 46 is a plan view of an order sheet;

FIG. 47 is a perspective view of a scanner built-in printer (composite machine);

FIG. 48 is a view of vCalendar data containing event information;

FIG. 49 is a view of vCalendar data containing TODO information;

FIG. 50 is a plan view of a schedule sheet;

FIG. 51 is a plan view of a checklist sheet;

FIG. 52 is an enlarged view showing a portion adjacent to a CF card slot in a variation; and

FIG. 53 is a partial perspective view of a printer equipped with a cellular phone holder.

### DETAILED DESCRIPTION OF THE PREFERRED EMBODIMENTS

### First Embodiment

A first embodiment to embody the present invention will be explained with reference to the drawings hereinafter.

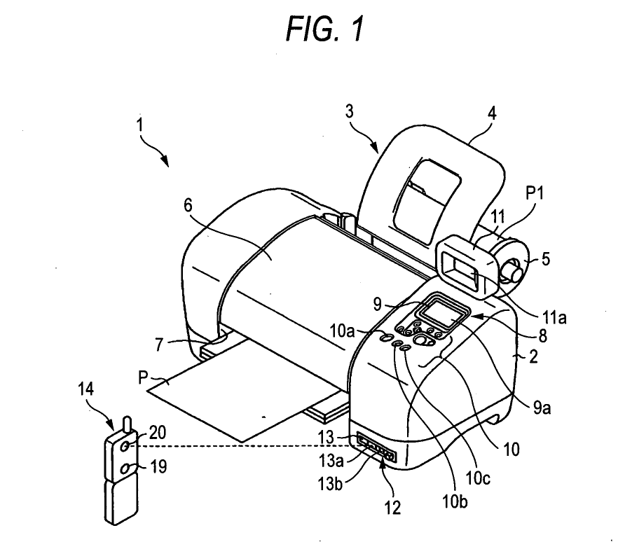

FIG. 1 is a perspective view of a printer 1. In FIG. 1, the printer 1 as an output device is an ink jet printer, and a sheet feeder 4 and a roll paper supporting portion 5 of an automatic paper feeder 3 are provided on the back surface side of a main body 2. The cut papers (not shown) are set in the sheet feeder 4 and fed to the inside of the main body 2. Also, a roll paper P1 is set in the roll paper supporting portion 5 and fed to the inside of the main body 2. A cover 6 is provided in the middle of the main body 2, and a printing mechanism is arranged in the cover 6. The printing paper P (cut paper or roll paper) as the printing medium is discharged by an operation of the printing mechanism from a paper discharge port 7 provided to the front lower portion. Also, an operation panel 8 is provided on the right upper side of the main body 2.

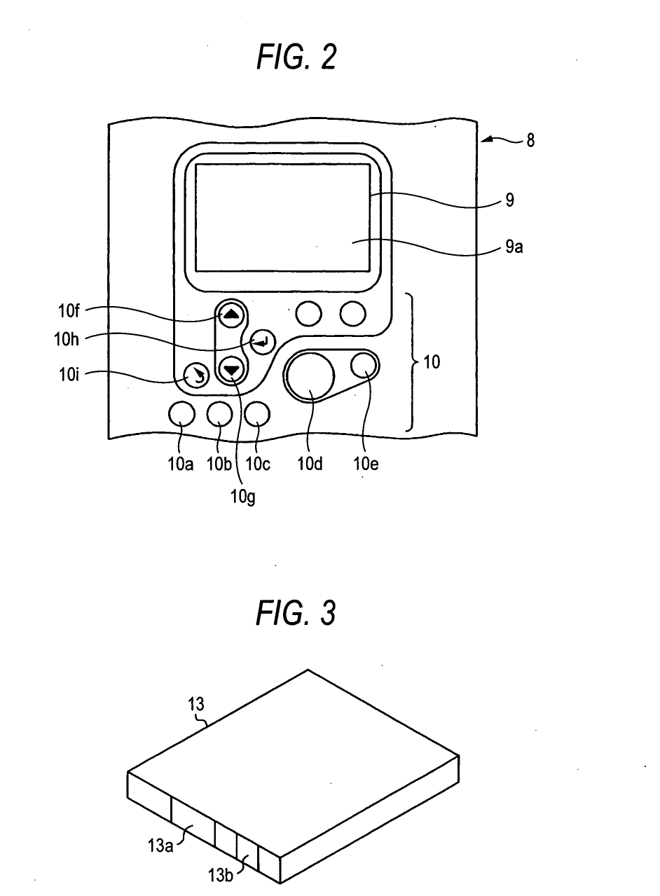

As shown in FIG. 2, the operation panel 8 has a display device 9 having a screen 9a, and an operation portion 10 consisting of a plurality of operation switches. The display device 9 is formed of a liquid crystal display device, and displays a menu to manually select type of the paper (cut paper or roll paper), size of the paper, layout, photo choice, number of the printed sheet, etc., for example, on the screen 9a.

Also, a power switch 10a for turning ON a power supply of the printer 1, a maintenance switch 10b being pushed at the time of error occurrence, and a roll paper switch 10c being pushed at the time of operating the roll paper are provided to the operation portion 10. In addition, a printing start switch 10d, a stop switch 10e, an upper switch 10f, a lower switch 10g, a decision switch 10h, and a return switch 10i are also provided to the operation portion 10. The printing start switch 10d is pressed to start the printing of the image on the cut paper or the roll paper. The stop switch 10e is pressed either to stop the printing in operation or to cancel input contents on the screen 9a in the non-printing state. The upper switch 10f and the lower switch 10g are pressed to move a cursor in selecting the menu or various set items or to increment/decrement a numerical value to be input. The decision switch 10h is pressed to advance the display contents on the screen 9a to a next screen or to define the set contents being input by using the screen 9a. The return switch 10i is pushed to return the screen displayed on the screen 9a to an initial screen or to return the display on the screen 9a to a previous screen.

As shown in FIG. 1, a second display device 11 is fitted to the right upper side of the main body 2 of the printer 1. The printed image to be printed on the paper P is displayed in advance on a display screen 11a of the second display device 11.

A card slot (CF card slot) 12 is provided to the front right side of the main body 2. An infrared communication function built-in CF (compact flash (R))-type card (infrared communication card) (referred to as a “CF-type communication card” hereinafter) 13 is extractably set in the card slot 12. The CF-type communication card 13 is an IrDA module having an infrared communication function based on IrDA (Infrared Data Association), and gives the infrared communication function that is capable of receiving the infrared data to the printer 1 when the card is set in the card slot 12. The printer 1 accepts the data that the CF-type communication card 13 receives from a cellular phone 14, and executes the printing process based on the data. In this case, a main body of the communication device is composed of a main body case of the CF-type communication card 13.

The cellular phone 14 in the present embodiment has multiple functions such as a phone book function capable of registering/managing the personal information containing a phone number, or the like, an electronic mail function capable of transmitting/receiving the electronic mail between the cellular phone and other cellular phones, a camera function capable of picking up the still picture or the moving picture, and so on, in addition to the phone function and the infrared communication function. The cellular phone 14 manages personal information data (text data) that are dealt with the phone book function and image data that are dealt with the camera function in a file format corresponding to the infrared communication respectively. In detail, the personal information data is managed in a vCard™ file format, and the image data is managed in a vNote™ file format. Therefore, the personal information data managed in a vCard™ file format and the image data managed in a vNote™ file format in the cellular phone 14 can be received by the printer 1 via the CF-type communication card 13 being set in the card slot 12. Also, the cellular phone 14 can transmit/receive the electronic mails and the image data to/from other cellular phone, the personal computer, or the like via a mobile phone network. In this case, if a CF-type memory card for a digital camera is set in the card slot 12, the image data picked up by the digital camera can be read from the CF-type memory card into the printer 1 and printed on the paper.

As shown in FIG. 3, an infrared-ray receiving/transmitting portion 13a serving as the communication port and a displaying portion 13b are provided onto a front surface of the CF-type communication card 13. The infrared-ray receiving/transmitting portion 13a has a light receiving element and a light emitting element. The light emitting element outputs the infrared ray as the bit signal, which is carried by a carrier wave whose carrier frequency is 25 to 50 kHz, for example, and is pulse-phase-modulated, by its ON/OFF lightening. Also, the light receiving element receives the infrared ray as the bit signal represented in the similar system. The displaying portion 13b consists of a plurality of light emitting diodes (LEDs) having a different lightening color respectively, and informs of the data receiving state of the CF-type communication card 13 by its combination of lightening color, ON, ON/OFF, and OFF. Also, a connector (not shown) is formed on the back surface of the CF-type communication card 13. This connector is electrically connected to the printer-side connector provided to a bottom surface of the card slot 12.

The CF-type communication card 13 constitutes a communication interface portion in the IrDA communication. As shown in FIG. 1, both the infrared-ray receiving/transmitting portion 13a and the displaying portion 13b provided to the front surface of the CF-type communication card 13 are placed in the exposed position in a state that the CF-type communication card 13 is set in the card slot 12, and can be viewed by the user (operator) who operates the cellular phone 14. A maximum communicable distance between the infrared-ray receiving/transmitting portions 13a, 20 (referred simply to as a “maximum communication distance” hereinafter) is within 10 to 50 cm, for example. Since the infrared ray is the communication medium having a relatively sharp directivity, the infrared-ray receiving/transmitting portion 20 of the cellular phone 14 must be directed toward the infrared-ray receiving/transmitting portion 13a as straight as possible within a predetermined spreading angle (60 degree in this example) upon transmitting the data from the cellular phone 14 and then be held in that state for about ten second to one minute that is required for the data transmission. For this reason, the user executes a transmitting operation while looking at the infrared-ray receiving/transmitting portion 13a as the destination of the data transmission. The user holds the cellular phone 14 at a position that is closer than the maximum communication distance from the infrared-ray receiving/transmitting portion 13a, and then holds a posture of the cellular phone 14 for almost several tens second to one minute, for example, while looking at the infrared-ray receiving/transmitting portion 13a. At this time, the displaying portion 13b comes into visual field of the user (operator) who operates or holds the cellular phone 14 while looking at the infrared-ray receiving/transmitting portion 13a. Also, since the user turns the user's eye naturally upon the displaying portion 13b that is turned ON during the data transmission, such user is liable to direct naturally the destination of the transmission to the direction to which the user's eyes are now directed. In this case, even if the infrared-ray receiving/transmitting portion 20 transmits the data to the displaying portion 13b from a position that is remote by a ½ maximum communication distance, the transmitted data can be received by the infrared-ray receiving/transmitting portion 13a. For example, suppose that L is the maximum communication distance (cm) and θ is the receivable spreading angle (° ), the above conditions can be satisfied if a position of the displaying portion 13b is within a (L/2)·tan θ (cm) radius of the infrared-ray receiving/transmitting portion 13a.

Here, as the visual field of one eye, normally a nose side 69 degree, an ear side 100 degree, an upper side 60 degree, and a lower side 75 degree are defined by a viewing angle. The position of the displaying portion 13b with respect to the infrared-ray receiving/transmitting portion 13a may be set to any place within the range of visual field. In this case, if the displaying portion 13b is positioned merely within the visual field of the user, the user must withdraw his or her eyes from the infrared-ray receiving/transmitting portion 13a to check the displaying portion 13b. Thus, in order to prevent such situation, it is preferable that the position of the displaying portion 13b with respect to the infrared-ray receiving/transmitting portion 13a should be set within a range of the ⅓ viewing angle. Further, a range of the ¼ viewing angle is appropriate. Concretely, it is preferable that the displaying portion 13b should be positioned within a 20 cm radius of the infrared-ray receiving/transmitting portion 13a although a positional relationship between them on a surface of the main body 2, when measured only by the viewing angle, is changed according to the maximum communication distance. A range of a 10 cm radius is more preferable.

Also, the receiving state is displayed on the screen 9a provided to the printer 1. Since the screen is provided to direct upward, it is impossible for the user, who executes the transmitting operation to reach the user's hand toward the printer 1 from the front side of the printer 1 while holding the cellular phone 14 in the user's hand, for example, to view the contents displayed on the screen 9a. Therefore, the displaying portion 13b is provided on the same surface of the front surface, which is different from the top surface of the main body 2 on which the screen 9a of the operation panel 8 is provided, as the infrared-ray receiving/transmitting portion 13a in this printer 1. That is, the position of the card slot 12 is set to have such positional relationship with the screen 9a. Of course, both the infrared-ray receiving/transmitting portion 13a and the displaying portion 13b may be positioned on not the front surface of the main body 2 but the side surface thereof.

Also, the position of the infrared-ray receiving/transmitting portion 13a is set such that such portion is arranged at a height of 10 cm or less from a bottom surface of the printer 1. This is because the data transmission is made possible while putting the cellular phone 14 on the same loading surface (desk, table, or the like) as the printer 1. As the cellular phone 14, there are the type of the device in which the infrared-ray receiving/transmitting portion 20 is provided onto the side surface (referred to as the “type of side-surface device” hereinafter) and the type of the device in which the infrared-ray receiving/transmitting portion 20 is provided onto the back surface (the surface on the opposite side to the operation buttons) (referred to as the “type of back-surface device” hereinafter). The cellular phone 14 is arranged such that the infrared-ray receiving/transmitting portion 13a on the printer 1 side is positioned within the communication area of the infrared-ray receiving/transmitting portion 20 when the cellular phone 14 of the type of side-surface device is put on the desk to direct the side surface laterally or when the cellular phone 14 of the type of back-surface device is put on the desk to lay down on the side. When the cellular phone 14 is put on the desk on which the printer 1 is loaded, normally such cellular phone is positioned closer than the maximum communication distance to the output device. Therefore, for example, suppose that the cellular phone 14 is put on the desk in such a way that the infrared-ray receiving/transmitting portion 20 is positioned a half of the maximum communication distance away from the infrared-ray receiving/transmitting portion 13a to oppose squarely to it. At this time, the displaying portion 13b is positioned within the communication area of the infrared-ray receiving/transmitting portion 13a on the front surface of the printer 1. For example, in case the maximum communication distance is 20 cm and a communicable spreading angle is 60, the infrared-ray receiving/transmitting portion 13a and the infrared-ray receiving/transmitting portion 13a are positioned in a 11 cm radius area of the destination side mutually. A height of the infrared-ray receiving/transmitting portion 20 is in a range of about 5 to 20 mm when the cellular phone 14 of the type of back-surface device is put to lay down on the side, while a height of the infrared-ray receiving/transmitting portion 20 is in a range of about 15 to 40 mm when the cellular phone 14 of the type of side-surface device stands to direct laterally. In the present embodiment, a height of the infrared-ray receiving/transmitting portion 13a is within 10 cm from the bottom of the printer 1. Such position is set to permit the user to transmit the data while the cellular phone 14 of either the type of side-surface device or the type of back-surface device is put on the same desk or table as the printer 1. Meanwhile, since the paper discharge port 7 is provided in the center of the front surface of the printer 1, the infrared-ray receiving/transmitting portion 13a can be arranged merely in the position that averts this port. For this reason, in the present embodiment, the infrared-ray receiving/transmitting portion 13a as the communication port is arranged at a height of 10 cm or less in the lower position on both sides of the paper discharge port 7 on the front surface of the printer 1. As a result, not only the data transmission can be carried out while putting the cellular phone 14 on the same desk as the printer 1 but also the communication is scarcely cut off by the paper being discharged from the paper discharge port 7. Here, in the present embodiment, the infrared-ray receiving/transmitting portion 13a is positioned particularly at a height of 2 to 5 cm out of the height of 10 cm or less from the bottom of the printer 1.

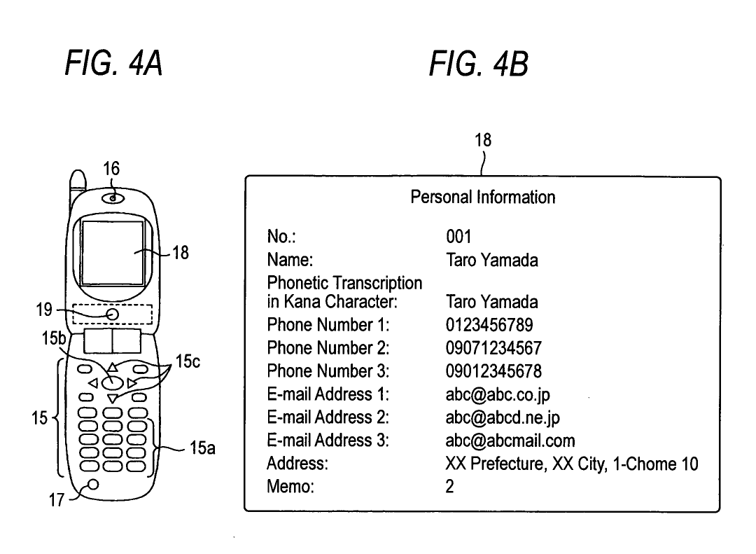

FIG. 4A shows the cellular phone viewed from the front. As shown in FIG. 4A, the cellular phone 14 has a plurality of operation buttons 15 (15a to 15c, etc.), an earpiece port 16, a mouthpiece port 17, a display 18, and a CCD (Charge-Coupled Device) imaging device 19.

The cellular phone 14 can not only display the image being now picked up by the CCD imaging device 19 on the display 18 in operation of the camera function but also save the picked-up image as a sheet of image data by operating the operation button 15b as a shutter.

In the present embodiment, the image data (still image data) picked up by the camera function of the cellular phone 14 are saved in the cellular phone 14 as JPEG data. When the image data are transmitted from the cellular phone 14 to the printer 1 via the infrared communication, the JPEG data save in the cellular phone 14 are converted into a vNote™ format as one of the file formats that are applicable to the infrared communication, and then transmitted. The printer 1 that received the data in the vNote format encodes (compresses) the JPEG data by an encode/decode converter called Base64, and the encoded JPEG image data are saved. Also, the cellular phone 14 can register the personal information, which are formed on the display 18 by operating the operation button 15a, by using the phone book function.

FIG. 4B shows an example of the personal information registered by using the phone book function of the cellular phone and displayed on the display. A method of registering the personal information will be explained hereunder. First, when a personal information forming mode (new registration mode) in the phone book function is selected by operating the operation button 15, a personal information forming program built in the cellular phone 14 is started. Respective items shown on the left side in FIG. 4B, i.e., “name”, “phonetic transcription in kana”, “phone number 1”, “phone number 2”, “phone number 3”, “E-mail address 1”, “E-mail address 2”, “E-mail address 3”, “address”, and “memo (note)” are displayed on the display 18. When a desired item is chosen by operating the operation button 15c, then the concerned data are input, and then these operations are repeated by the number of necessary items, one personal information shown in FIG. 4B is formed. In the present embodiment, the personal information data (text data) formed by the phone book function are saved in the vCard™ format as one of the file formats that are applicable to the infrared communication.

In addition, the cellular phone 14 has an infrared communication function based on IrDA (Infrared Data Association), and has the infrared-ray receiving/transmitting portion 20 (shown in FIG. 1) to execute the infrared communication between the CF-type communication card 13 and the cellular phone 14. The cellular phone 14 transmits the image data and the personal information data to the CF-type communication card 13 when the user operates the operation button 15. The infrared-ray receiving/transmitting portion 20 has a light receiving element and a light emitting element that can receive and emit the light in the same infrared communication system as the infrared-ray receiving/transmitting portion 13a provided to the CF-type communication card 13.

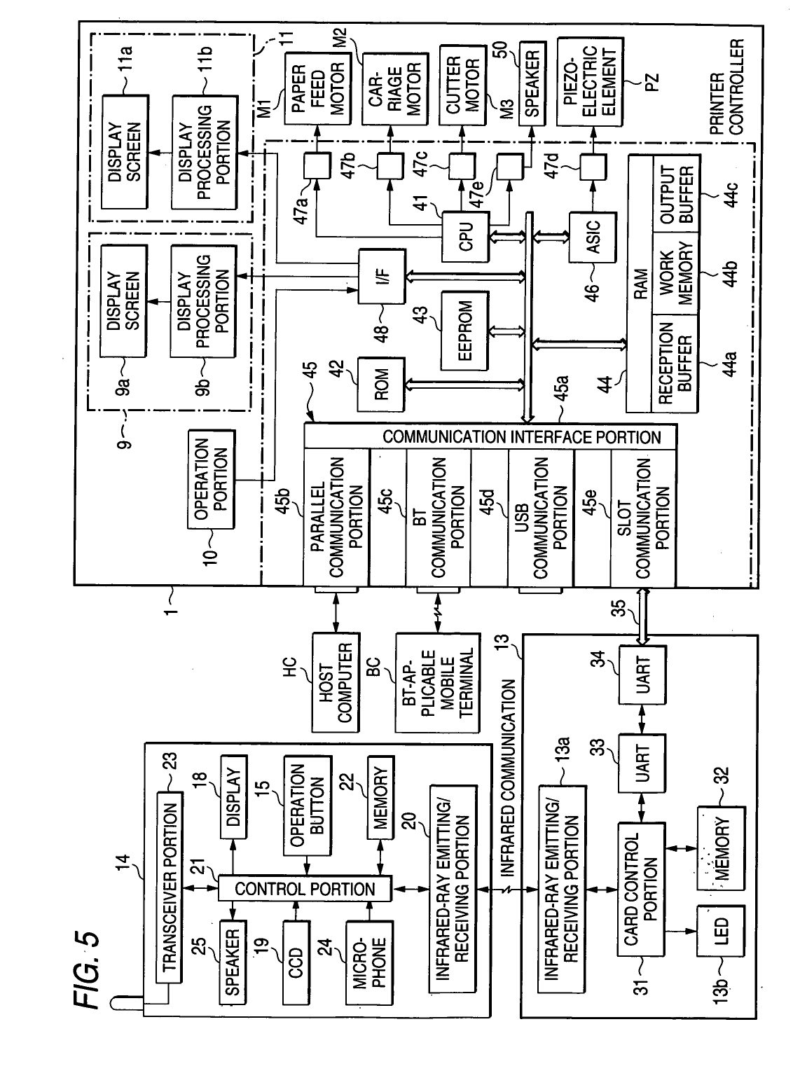

Next, electrical configurations of the printer 1, the CF-type communication card 13, and the cellular phone 14 constructed as above will be explained with reference to FIG. 5 hereunder.

First, an electrical configuration of the cellular phone 14 will be explained herein. The cellular phone 14 includes a control portion 21, a memory 22, a transceiver portion 23, a microphone 24, a speaker 25, the operation button 15, the display 18, the CCD imaging device 19, and the infrared-ray emitting/receiving portion 20.

The image data picked up by the CCD imaging device 19 and the personal information data are saved temporarily in the memory 22 by the control portion 21. The microphone 24 outputs the sound spoken at the earpiece port 16 as a sound signal to the control portion 21. The speaker 25 converts the sound signal fed from the control portion 21 into the sound and outputs such sound from the mouthpiece port 17.

The transceiver portion 23 is an input/output (I/O) interface. This transceiver portion 23 transmits the sound signal, the mail, the image data being output from the control portion 21 to other cellular phone or the personal computer, and also receives the sound signal, the mail, the image data being fed from other cellular phone or the personal computer to output them to the control portion 21.

The control portion 21 has CPU, ROM, EEPROM, etc. The CPU executes various operations in compliance with the control program or various application programs stored in ROM and EEPROM. That is, the control portion 21 executes processing operations of talking, mail formation, data transmission/reception, and save based on the operation of the operation button 15. Also, the control portion 21 executes processing operations to display and save the image data picked up by the CCD imaging device 19 based on the operation of the operation button 15.

At this time, the image data saved in the memory 22 in the JPEG data format by the control portion 21. Also, the control portion 21 executes processing operations to form and save the personal information based on the operation of the operation button 15. At this time, the personal information data (text data) saved in the memory 22 in a name-card data format (vCard format in this example) by the control portion 21.

In addition, the control portion 21 executes processing operations to transmit the personal information data and the image data saved as above to the printer 1 (CF-type communication card 13) via the infrared-ray emitting/receiving portion 20 based on the operation of the operation button 15. When such data are transmitted from the control portion 21 to the CF-type communication card 13; the personal information data are transmitted in the vCard file format, and the image data (encoded JPEG data) are transmitted in the vNote file format. The control portion 21 transmits these data in compliance with the object exchange protocol. In the present embodiment, IrOBEX™ used to exchange the object called a vFormat such as phone book (vCard), schedule (vCalendar), memo (vNote), or the like is employed as the object exchange protocol.

Next, an electrical configuration of the CF-type communication card 13 will be explained hereunder.

The CF-type communication card 13 includes a card control portion 31, a memory 32, a card-side UART (Universal Asynchronous Receiver Transmitter) 33, a printer-side UART (Universal Asynchronous Receiver Transmitter) 34, the infrared ray receiving/emitting portion 13a, and the displaying portion (LED) 13b.

The card control portion 31 controls the memory 32, the card-side UART 33, the infrared-ray receiving/transmitting portion 13a, and the displaying portion 13b. The card control portion 31 has CPU, ROM, and the like. The CPU executes various operations based on the control program and various application programs stored in the ROM. When the card control portion 31 receives the data from the cellular phone 14 via the infrared-ray receiving/transmitting portion 13a, such card control portion 31 instructs the card-side UART 33 to transfer the object data (the personal information data or the image data) to the printer 1. At this time, a part of the memory 32 is used as a buffer that saves temporarily the object data.

In accordance with the instruction issued from the card control portion 31, the card-side UART 33 converts the object data (the personal information data or the image data) into the serial bit stream, and then outputs the bit stream to the printer-side UART 34.

The printer-side UART 34 is controlled by a communication interface (I/F) 45 on the printer 1 side via a bus 35 that is coupled by connecting electrically the connectors on both sides when the CF-type communication card 13 is set in the card slot 12. When the printer-side UART 34 starts to receive the object data from the card-side UART 33, such printer-side UART 34 outputs an interrupt signal to request the data reading of the printer 1 side. The printer 1 side, when received this interrupt signal, starts the reading of the object data into the printer 1 by opening the input port. At this time, the printer-side UART 34 outputs the object data to the printer 1 side while converting the serial bit stream received from the card-side UART 33 into the parallel byte data.

Also, the printer-side UART 34 outputs various signals being input from the printer 1 side to the card control portion 31 via the card-side UART 33. The card control portion 31 manages the data receiving state (communication status) by monitoring various signals being input from the printer 1 side, and controls the display of the displaying portion 13b into the lightening mode in response to the communication status at that time. Therefore, the output device can inform the user of the data receiving state at that time by the lightening mode of the displaying portion 13b provided on the front surface of the CF-type communication card 13. At this time, the card control portion 31 transmits the information of the communication status to the cellular phone 14 via the infrared-ray receiving/emitting portion 13a. Thus, the data receiving state on the printer 1 side are displayed by the character information, or the like on the display 18 of the cellular phone 14.

Also, a speaker 50 is provided to the printer 1. A CPU 41 outputs the sound as the sound signal to the speaker 50 in response to the communication status of the CF-type communication card 13. For example, when the CF-type communication card 13 is unready for receiving the data, printer 1 informs the user of “Now data cannot be received. You are informed whenever this printer becomes ready for receiving.” by the sound. The sound data to generate these sounds are prepared every communication status, and are stored in a ROM 42 or an EEPROM 43, for example. Also, the method of informing of the user is not limited to the sound, and such information may be given by combination of tones or occurring frequencies of a buzzer sound or a melody sound.

Next, an electrical configuration of the printer 1 will be explained herein.

The printer 1 includes the CPU 41, the ROM 42, the EEPROM 43, a RAM 44, a communication interface (I/F) 45, an ASIC (Application Specific IC) 46, drivers 47a to 47e, and a user interface (I/F) 48. These are connected electrically mutually via a data bus 49 respectively.

The communication interface (I/F) 45 has a communication interface portion 45a, a parallel communication portion 45b, a Bluetooth™ communication portion 45c, a USB (Universal Serial Bus) communication portion 45d, a slot communication portion 45e, and a serial communication portion (not shown). The communication portions 45b to 45e, etc. have a communication port (input/output port) respectively. The communication interface portion 45a consists of a group of communication interfaces that are provided in plural to the communication portions 45b to 45e independently, for example, and informs the CPU 41, which manages the priority of the communication (data reception), of that effect when the communication portions 45b to 45e receive the data respectively. The CPU 41 decides based on the information accepted from the communication interface portion 45a and indicating the effect that the data are received whether or not such data can be received. For example, in case the communication interface 45 receives the data for the first time after such communication interface is ready for receiving the next data, the CPU 41 issues the instruction to the communication interface portion 45a to open the input port of the concerned communication portion. The communication interface portion 45a opens one instructed port out of the input ports of the communication portions 45b to 45e in compliance with the instruction from the CPU 41 to receive the data sent out from a predetermined host equipment, and then outputs the received data onto the common data bus 49. When the data arrive first at any one port out of these plural input ports, the communication interface portion 45a starts the acceptance of the data from the port and also inhibits remaining ports from receiving the data by rendering the remaining ports busy until the acceptance of the data is completed. The communication interface portion 45a executes such processing in accordance with the instruction from the CPU 41. As soon as the data reception is started from one communication port, the CPU 41 makes sure of a data transfer route through which the received data pass to reach the printing process until the printing is ended, and also instructs the communication interface portion 45a to inhibit remaining communication ports from receiving the data the whole while. Also, the CPU 41 executes an interlocking process to decide whether the data reception from the communication port should be allowed or inhibited.

When the communication interface portion 45a accepts the receiving request from the host equipment or the CF-type communication card 13, the CPU 41 receives a notice of that effect from the communication interface portion 45a and then manages empty states of the communication ports, receiving states of the communication ports, etc. based on the notice information.

The parallel communication portion 45b can receive the data from a host computer (personal computer) HC via a communication cable in parallel communication. The Bluetooth™ communication portion 45c can receive the data from a Bluetooth-applicable mobile terminal BC in compliance with a predetermined communication protocol in a near radio communication using a radio wave in a predetermined standard frequency band. The USB (Universal Serial Bus) communication portion 45d can receive the data from an USB-applicable device (not shown) in compliance with a predetermined communication protocol. The slot communication portion 45e can receive the data from the CF-type communication card 13 or the CF-card (memory card) inserted into the CF-card slot 12. In this case, respective communication portions 45b, 45c, 45d, 45e can transmit predetermined signals or data such as information necessary for the communication with the host equipment, a signal for informing of the status of the printer 1, etc.

The CPU 41 controls the communication interface (I/F) 45, the ASIC 46, the drivers 47a to 47c based on the control program stored in the ROM 42 and various application programs stored in the EEPROM 43. The CPU 41 outputs a command signal for operating a part of the printing mechanism to the ASIC 46, and instructs to transfer the data between the ASIC 46 and the RAM 44 and between various processing circuits in the ASIC 46. A DMA controller for a transfer process, for example, is built in the CPU 41. Also, the CPU 41 drives/controls a paper feed motor M1, a carriage motor M2, a cutter motor M3 for a cutter unit that cuts the printed portion of the roll paper into a predetermined size, via the drivers 47a to 47c.

The ASIC 46 generates print data by applying the imaging process to the data, and drives/controls a plurality of piezoelectric elements PZ via the driver 47c, based on the command signal from the CPU 41 and the print data. A reception buffer 44a, a work memory 44b, an output buffer 44c, and others are provided to the RAM 44. The data received via respective communication portions 45b to 45e are stored once in the reception buffer 44a, the data used in applying predetermined processes are stored in the work memory 44b, and the print data generated finally are stored in the output buffer 44c.

The paper feed motor M1 is a motor that carries the cut paper or the roll paper P1 being set in the automatic paper feeder 3 to the paper discharge port 7 via the printing position. The carriage motor M2 is a motor that moves reciprocally the carriage on which a recording head with a plurality of injection nozzles is mounted, in a main scanning direction. The piezoelectric elements PZ are elements that are provided every nozzle of a plurality of injection nozzles provided to the recording head to cause the nozzle to inject an ink. The cutter motor M3 is a motor that drives the cutter unit to cut the roll paper into a predetermined size by moving a cutting blade in the main scanning direction.

Also, the CPU 41 reads menu display data stored previously in the EEPROM 43 and transfers the data to a display processing portion 9b of the display device 9. The display processing portion 9b displays the menu used to choose manually type of the paper, size of the paper, layout, photo choice, number of the printed sheet, etc. on the display screen 9a based on the menu display data. The “layout” is prepared in the items of the menu. This “layout” is such a function that forms printing images (printed-state images) by designing the layout of one or plural images, which are input from the memory card, or the like being set in the card slot 12 to print, on the paper. A plurality of layout templates used to design the layout are stored in the EEPROM 43. The display data formed by this layout function are saved temporarily in the RAM 44. The CPU 41 reads the display data from the RAM 44 and transfers the data to a display processing portion 11b when the operation portion 10 is operated before the printing is executed. Thus, the printed image is displayed on the display screen 11a.

Also, the CPU 41 receives signals generated based on the operations of respective switches 10a to 10i provided onto the operation panel 8, via the user I/F 48.

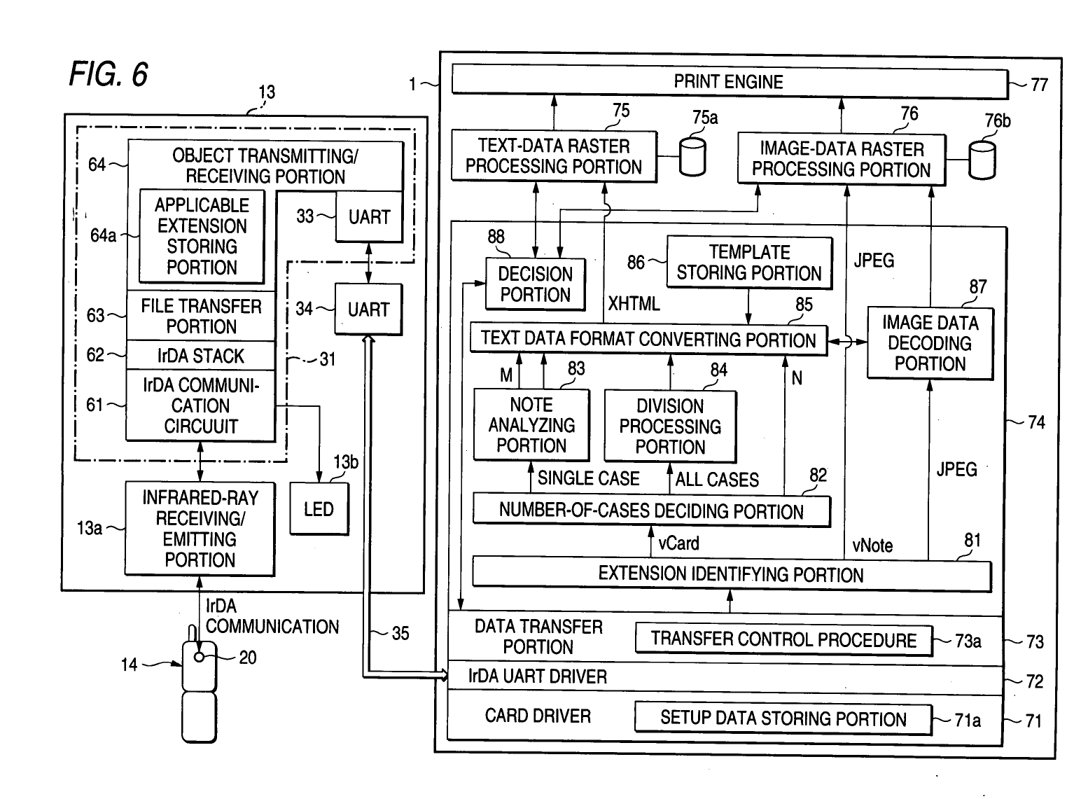

FIG. 6 is a functional block diagram explaining the data communication executed between the cellular phone and the printer via the CF-type communication card and a printing process of the received data. Respective functional portions shown in FIG. 6 are realized by hardware circuits including various circuits and the CPU that executes the communication protocol program, applications programs, etc.

The card control portion 31 built in the CF-type communication card (infrared communication card) 13 includes an IrDA communication circuit 61, an IrDA stack (IrDA protocol stack) 62, a file transferring portion 63, an object transmitting/receiving portion 64. The IrDA communication circuit 61 consists of hardwares including the CPU and the communication circuit (both not shown), and corresponds to a physical layer in communication layers. The IrDA stack 62 consists of a group of IrDA communication protocols, and corresponds to a data link layer and a network layer in communication layers. The file transferring portion 63 performs the transfer control of files received from the cellular phone 14 in the infrared communication, and corresponds to a transport layer and a session layer in communication layers. The object transmitting/receiving portion 64 performs the data transfer control between two communication systems, i.e., the IrDA communication between the cellular phone 14 and the card and the serial communication between the printer and the card, and necessary processes such as the received data check. The object transmitting/receiving portion 64 consists of a portion that corresponds to a presentation layer and an application layer, which process the data from the file transferring portion 63, and a portion that constituting the presentation layer to the data link layer, which are upper layers of the UART 33 and are constructed by serial communication protocol stacks.

The file transferring portion 63 is a functional portion that is constructed when the CPU in the CF-type communication card 13 executes an OBEX (Object Exchange)™ program, and performs the file transfer control based on OBEX specifications. In detail, the file transferring portion 63 executes the establishment and the disconnection of the logical communication link with the OBEX on the cellular phone 14 side, and executes the restoring process to build up respective packets split and fed at the time of transferring the file into an original file, etc.

Also, the object transmitting/receiving portion 64 has an applicable extension storing portion 64a. The object transmitting/receiving portion 64 stores (set up) in the applicable extension storing portion 64a the extension data that are sent to the CF-type communication card 13 from the printer 1 when the printer 1 detects for the first time such a state that the CF-type communication card 13 is inserted into the card slot 12, after the power supply is turned ON. Also, the object transmitting/receiving portion 64 acquires a file name from the received data, and then decides whether or not the received data are printing applicable data a printing capability of which is given to the printer 1, by comparing the extension in the file name with the extension data. In more detail, the object transmitting/receiving portion 64 decides whether or not the received data are the printing applicable data by reading the file name “aaaa.bbb” in the header of the data, then extracting the extension “bbb” from the file name, and then this extension “bbb” with the extension data. The uppercase letter and the lowercase letter are discriminated in this comparison. Then, the object transmitting/receiving portion 64 executes the data selecting process to allow the reception of the printing applicable data but reject the reception of the printing unapplicable data, based on the result of decision. In case the received data are the printing applicable data, the object transmitting/receiving portion 64 transfers the object data and data of the file extension “bbb” (referred to as a “file extension data” hereinafter) to the printer 1 side.

Then, a card driver 71, an IrDA UART driver (referred to as a “UART driver” hereinafter) 72, a data transferring portion 73, an IrDA profile processing portion 74, a text-data raster processing portion 75, an image-data raster processing portion 76, and a print engine 77 are provided to the printer 1 side.

The card driver 71 and the UART driver 72 are constructed by a hardware consisting of the driver circuit built in the slot communication portion 45e shown in FIG. 5 and a software. Also, the data transferring portion 73 is a functional portion that is implemented when the CPU 41 executes the communication protocol program. Also, the IrDA profile processing portion 74, the text-data raster processing portion 75, and the image-data raster processing portion 76 are functional portions that are implemented when the CPU 41 executes the application programs. In addition, the print engine 77 is constructed by a software portion implemented when the CPU 41 executes the application program and hardware portions consisting of the ASIC 46, the drivers 47a to 47d, the paper feed motor M1, the carriage motor M2, the piezoelectric elements PZ, the cutter motor M3, and the like to execute the printing process.

In this case, in case these constituent elements are applied to the OSI reference model, the card driver 71 and the UART driver 72 correspond to a data link layer and a network layer. Also, the data transferring portion 73 corresponds to a transport layer and a session layer, and the IrDA profile processing portion 74, the text-data raster processing portion 75, and the image-data raster processing portion 76 correspond to a presentation layer and an application layer.

The card driver 71 is a communication driver for transmitting/receiving the signals and the data to/from the CF-type communication card 13. The card driver 71 issues necessary instructions to the UART driver 72 based on the instruction, or the like from the CPU 41.

The UART driver 72 controls a communication operation of the printer-side UART 34 built in the CF-type communication card 13 and, for example, controls the printer-side UART 34 based on the instructions from the CPU 41 and the card driver 71. When the UART driver 72 accepts the interruption request from the printer-side UART 34, such UART driver 72 starts the acceptance of the data by opening the input port so far as the printer 1 is not in a busy state where the printer 1 is now receiving the data from other communication portions 45b to 45d.

Also, the card driver 71 receives extension data from the CPU 41 at the initializing process that the CPU 41 executes upon turning ON the power supply of the printer 1, and stores the extension data in a setup data storing portion 71a. Then, the card driver 71 reads the extension data stored in the setup data storing portion 71a based on the instruction issued from the CPU 41, which detects the electrical connection between the printer 1 and the CF-type communication card 13 for the first time after the power supply is turned ON, and then transmits such extension data to the CF-type communication card 13. In the present embodiment, as the extension of the printing-applicable file, “vcf”, “vnt”, “jpeg”, and “jpg” are set as the extension data. The extension data sent to the CF-type communication card 13 are set on the CF-type communication card 13 side when such extension data are stored in the applicable extension storing portion 64a by the object transmitting/receiving portion 64. The UART driver 72, when received notices such as the error notice detected by the data transferring portion 73 and the IrDA profile processing portion 74, transmits that effect signal to the card control portion 31. The card control portion 31 manages the communication status representing the data receiving state by monitoring the data and the signals received from the cellular phone 14 and the printer 1, and controls the display of the displaying portion (LED) 13b into a lightening mode in response to the communication status at that time. The CF-type communication card 13 informs the sender of the data receiving state by the lightening mode of the displaying portion 13b.

The data transferring portion 73, when receives the object data and the file extension data sent from the object transmitting/receiving portion 64 in the CF-type communication card 13, sends the file extension data to the IrDA profile processing portion 74 and also decides whether or not the object data could be received correctly. This judgment is made based on the transfer controlling procedure in which procedures to verify whether or not the object data could be received correctly are programmed. As the transmission controlling procedure, the basic procedure and the HDLC (High Level Data Link) procedure may be listed. In this example, the transmission controlling procedure obtained by simplifying the basic procedure is employed.

Here, the transmission controlling procedure in this example will be explained simply hereunder. The object transmitting/receiving portion 64 acts as a control station for transferring the telegraphic message, while the data transferring portion 73 acts as a tributary station for receiving the telegraphic message. According to this transmission controlling procedure, the control station for transferring the telegraphic message establishes the data link by issuing <ENQ> and then conforming a <DLE><ACK0> response issued from the tributary station. Then, when the data link is established, the control station sends out the telegraphic message and then conforms a <DLE><ACK0/ACK1> response issued from the tributary station. When the tributary station confirms the data error, such tributary station issues a <NAK> response to ask the control station for the data retransmission. When the telegraphic message is transferred normally, the control station issues <EOT> and ends the transmission. A structure of the telegraphic message has a “<DLE><STX> telegraphic message main body (text)<DLE><ETX><CRC>” format. If the telegraphic message main body exceeds 1024 characters, for example, the final telegraphic message is set to “<DLE><STX> telegraphic message split block <DLE><ETX><CRC>” by dividing the telegraphic message in unit of 1024 characters and then framing the split telegraphic message by “<DLE><STX> telegraphic message split block <DLE><ETB><CRC>”. In the CRC (cyclic redundancy code) calculation, the cyclic redundancy code calculation is applied sequentially the data subsequent to <STX> to the data prior to <DLE><ETX> or <DLE><ETB> and then 2 byte CRC is transmitted directly after <ETX> or <ETB>. When the tributary station finds the coincidence of calculation by checking carefully <CRC>, such tributary station sends back <DLE><ACK0/ACK1>, and thus the telegraphic message transmission is ended. In remaining cases, the tributary station sends back <NAK> to issue the request-for-retransmit. In this case, the error detecting system employed in the error control is not limited to the CRC detecting system, and the parity check system, the check sum, or the Hamming code may be employed.

When the data transferring portion 73 could receive correctly the data according to a transfer control procedure 73a, such portion sends out sequentially the data (telegraphic message main body or telegraphic message split block) to the next IrDA profile processing portion 74. When the data transferring portion 73 could not receive correctly the data, such portion requests the object transmitting/receiving portion 64 to send again the data. The object transmitting/receiving portion 64, when received this request-to-retransmit, sends out again the data that are transmitted to the data transferring portion 73 precedingly. If time has run out before the data are not transmitted again after the request-to-retransmit, the data transferring portion 73 instructs the UART driver 72 to transmit the error informing signal to the object transmitting/receiving portion 64.

The IrDA profile processing portion 74 includes an extension identifying portion 81, a number-of-cases deciding portion 82, a Note analyzing portion 83, a division processing portion 84, a text-data format converting portion 85, a template storing portion 86, an image-data decoding portion 87, and a decision portion 88. The IrDA profile processing portion 74 is realized based on program data and various data stored in the ROM 42 and the EEPROM 43.

The extension identifying portion 81 identifies the file format of the object data based on the file extension data being input from the data transferring portion 73. More particularly, the extension is identified to decide to which one of the personal information data (vCard file format), the attached-type image data (vNote file format), and the image data (JPEG file) the file format corresponds. That is, the file format is identified as “vCard file” if the file extension data is “vcf”, the file format is identified as “vNote file” if the file extension data is “vnt”, and the file format is identified as “JPEG file” if the file extension data is “jpeg” or “jpg”. Then, the extension identifying portion 81 allocates the processing route to the object data fed from the data transferring portion 73 in response to the identified extension. That is, the extension identifying portion 81 sends the vCard file (personal information data) to the the number-of-cases deciding portion 82 if the extension is “vcf”, and sends the vNote file (image data) to the image-data decoding portion 87 if the extension is “vnt”. Also, the extension identifying portion 81 sends the JPEG data to the image-data raster processing portion 76 if the extension is “jpeg” or “jpg”.

The number-of-cases deciding portion 82 decides whether the vCard file corresponds to a “single case” file that contains the personal information of a single case or an “all cases” file that contains the personal information of plural cases. Then, the number-of-cases deciding portion 82 sends the vCard file to the Note analyzing portion 83 if such file is decided as the “single case” file, and sends the vCard file to the division processing portion 84 if such file is decided as the “all cases” file. Also, the decision result of the number-of-cases deciding portion 82 is “N=0” in the case of “single case” and “N=1” in the case of “all cases”, and the decision value N is sent to the text-data format converting portion 85.

The Note analyzing portion 83 picks up the text described in the Note area of the vCard file and analyzes the text. In the case where the personal information of a single case are to be printed, the print layout can be pointed by describing the predetermined designated character in the Note area. Thus, the Note analyzing portion 83 analyzes the description contents in the Note area to decide whether or not the designation of the print layout by the designated character is present. In the present embodiment, numerals (numbers) are employed as the designated character. The reason why the numerals are employed is that not only the number of characters to be descried is small but also the numerals are ready to identify. Except the numerals, alphabets (e.g., A, B, C, . . . ) may be employed as the designated character. The Note analyzing portion 83 sends designated character information M obtained as the analyzed result (e.g., number M=1, 2, . . . , n) to the text-data format converting portion 85.

As soon as the “all cases” files are input sequentially in unit of the telegraphic message split block, the division processing portion 84 checks contents of the data while storing such data in a buffer (not shown) and then divides the data into predetermined several cases by extracting a partition of each case. Then, the division processing portion 84 sends out the personal information data every predetermined several split cases to the text-data format converting portion 85 for the next process. In the present embodiment, the number of predetermined cases is set to one, and thus the all case data of the vCard file are sent out from the division processing portion 84 to the text-data format converting portion 85 in the next process every one case while being divided sequentially into the personal information of one case.

The text-data format converting portion 85 converts the personal information data (text data) from the vCard format to the XHTML (Extensible Hyper Text Markup Language) format. In this case, before the format conversion is executed, it is verified that the data are in the vCard file format, by analyzing the contents of the data to check whether or not the object data are in the vCard file format. For example, it is checked whether or not the property (“BEGIN VCARD”, “N”, “SOUND”, or the like) provided as a matter of course to the data in the vCard file format are present. Unless the data are in the vCard file format, the text-data format converting portion 85 cancels such data and also informs the CF-type communication card 13 of the effect that that the data are wrong data, via the UART driver 72. In contrast, if the data are in the vCard file format, the text-data format converting portion 85 applies the format converting process to the object data. Also, the vCard file format of the type with an image attaching function may be prepared according to the cellular phone maker. When the file format is analyzed as the vCard file format of the type with an image attaching function, the text-data format converting portion 85 extracts the encoded JPEG image data attached to the file and transfers the image to the image-data decoding portion 87. In this manner, the text-data format converting portion 85 analyzes and verifies previously whether or not the contents of the data are also correctly in the vCard format even though the extension is “vCard”. Also, when the text-data format converting portion 85 accepts the vNote file of the type containing the text data described by the memo-pad function in the image-data decoding portion 87, such portion 85 receives only the text data from the image-data decoding portion 87. At this time, the text-data format converting portion 85 does not anew analyze the data since the image-data decoding portion 87 has already verified the contents of the data.

In applying the format converting process, the text-data format converting portion 85 first reads the print layout template descried in the XHTML format (referred to as the “template” hereinafter) from the template storing portion 86. In the template, the layout frame is designated by the tag description such that respective item (property) values constituting the object data are assigned in predetermined positions. The personal information in the vcard format are converted into the XHTML format with template by incorporating values (text data) of the concerned items (properties) into the layout frame. In other words, the vCard format is the file format that does not originally have a layout concept, but the file format is converted from the file format in which the layout cannot be defined (vCard) to the file format in which the layout can be defined (XHTML) such that the data can be printed in a predetermined layout in printing. Then, because the template described in the XHTML format is used in converting the format, the layout is defined by the tag. The text-data format converting portion 85 sends out the XHTML data in which the personal information are incorporated into the template to the text-data raster processing portion 75.

Meanwhile, the image-data decoding portion 87 receives the object data in the vNote file format from the extension identifying portion 81, and analyzes contents of the object data to verify whether or not the data are in the vNote file format. For example, it is checked whether or not the property, etc. provided as a matter of course to the data in the vNote file format are present. Unless the data are in the vNote file format, the image-data decoding portion 87 cancels such data and also informs the CF-type communication card 13 of the effect that that the data are wrong data, via the UART driver 72. In contrast, if the data are in the vNote file format, the image-data decoding portion 87 extracts the encoded image data attached to the data and also transfer the text data to the text-data format converting portion 85 when such portion 87 analyzed that the text data described by the memo-pad function are contained. Then, the image-data decoding portion 87 starts the previously prepared decoding program (Base64) to decode the encoded JPEG image data into the JPEG image data.

In this fashion, the image-data decoding portion 87 analyzes and verifies beforehand whether or not the contents of the data are also correctly in the vNote format even though the extension is “vnt”. The image-data decoding portion 87 sends out the decoded JPEG image data to the image-data raster processing portion 76.

The text-data raster processing portion 75 applies the raster process to the XHTML data received from the text-data format converting portion 85. An XHTML analyzing process, a layout setting process, a color converting process, and a binary-coding process are contained in this raster process. First, in the XHTML analyzing process, the XHTML data are analyzed and decomposed into the template information of the layout described in the XHTML language and the personal information described by the text. The layout area for the personal information text (value of each property) is calculated by analyzing the descriptive contents (template information in the layout) described in the XHTML language (tag), and positional coordinate data (address data) of each calculated layout area are acquired. In the layout setting process, the character codes in the personal information text are converted into character data, and also resultant character data are expanded into addresses, which are decided from the layout area designated by the template, as the dot data in a predetermined character size. The color converting process and the binary-coding process are applied to the expanded dot data, and then a process of rearranging the data in the dot forming sequence in the printing is applied to the binary-coded data. Here, as the result of the XHTML analyzing process, in case the XHTML data contain the image (only the addressing), the text-data raster processing portion 75 issues the transferring request that causes the cellular phone 14 to transfer the image data by designating the address data of the image. When the image data are transferred from the cellular phone 14 in response to this transferring request, the text-data raster processing portion 75 executes the layout setting process of the overall layout including both the image and the text. Therefore, if the text and the image are contained, the layout in which the text and the image are arranged in predetermined positions is decided. Here, if the image are contained in the vCard data, the decoding process (Base64) is required of the encoded image data. In the present embodiment, the decoding process is carried out indirectly by sending the image data acquired from the cellular phone 14 to the image data decoding portion 87 once and then returning the JPEG data, which were subjected to the decoding process in the image data decoding portion 87, to the text-data raster processing portion 75. In this manner, if the vCard data contain the image, only the address data of the image may be embedded in the vcard data like the present embodiment, or the image data may be embedded in the vCard data from the first. In the case of the latter configuration, a transferring process for transferring the image data only later can be omitted.

The image-data raster processing portion 76 applies the raster process to the LPEG image data. In this case, as with the JPEG data that are sent directly without interposition of the image data decoding portion 87, prior to the raster process, it is verified by analyzing contents of the data whether or not the data are in the JPEG file format. For example, it is checked whether or not the information provided as a matter of course to the data in the JPEG file format are present. Unless the data are in the JPEG file format, the image-data raster processing portion 76 cancels such data and also informs the CF-type communication card 13 of the effect that that the data are wrong data, via the UART driver 72. In contrast, if the data are in the JPEG file format, the image-data raster processing portion 76 goes to the raster process. In this way, the image-data raster processing portion 76 analyzes and verifies beforehand whether or not the contents of the data are also correctly in the JPEG format even though the extension is “jpeg”.

In the raster process, the JPEG analysis and the decoding process, the layout setting process, the color converting process, and the binary-coding process are contained. In the JPEG analysis and the decoding process, since the JPEG image data are the compressed-system image data, first this data are depressed into the non-compressed-system image data in the YcbCr color system (color system representing by using a luminance (Y), a blue color difference (Cb), and a red color difference (Cr)). Then, the multi-valued image data in the YcbCr color system obtained by the depression are further converted into the multi-valued image data in the RGB color system. Then, in the layout setting process, the layout area into which the multi-valued image data in the RGB color system are assigned onto the paper is calculated, and then the image is expanded as the dot data in a predetermined size onto the address on the work memory (image buffer) 44b decided by the calculated layout area. The color converting process and the binary-coding process are applied to the expanded image data (dot data), and then the process of rearranging the data in the dot forming sequence in the printing is applied to the binary-coded data. The similar process is carried out in the raster process of the JPEG image executed after the layout setting process in the text-data raster processing portion 75 explained previously. Also, in case the text is contained in the vNote data, the image-data raster processing portion 76 executes the layout setting process of the overall text and image. In this case, a second deciding portion is constructed by the text-data format converting portion 85, the image data decoding portion 87, and the image-data raster processing portion 76, which analyses and verifies the contents of the object data in respective file formats (vCard, vNote, JPEG).

The print engine 77 sets up a printer print command by combining the CMYK binary image data (raster data), which are expanded on the work memory 44b and are subjected to the raster process, together with a print command header. Then, when the printing mechanism is driven by an engine controller based on the printer print command, the printing is applied to the paper.

Here, the text-data raster processing portion 75 and the image-data raster processing portion 76 are existing portions that that are provided prior to the employment of the CF-type communication card receiving system such that the data in the file format (the XHTML format and the JPEG format) handled in the Bluetooth-applicable mobile terminal BC can also be printed. In this example, since the existing portions are applied as the functional portion that must be newly added to print the file data in the cellular phone-applicable format received via the CF-type communication card 13, the minimization of such new functional portion can be achieved. In other words, since the functional portion for converting the data in the cellular phone-applicable format (the vCard format and the vNote format) to the data in the Bluetooth-applicable format is added to the IrDA profile processing portion 74, respective raster processing portions 75, 76 can also be applied to the data processing executed after the format conversion.

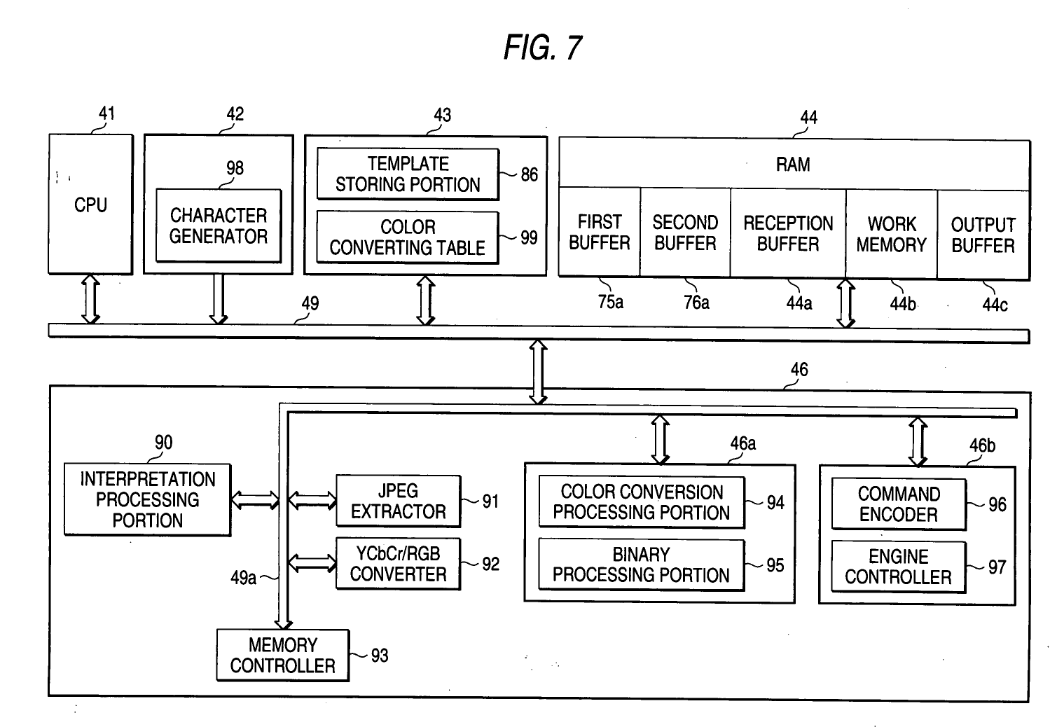

FIG. 7 shows a schematic configuration of an image processing apparatus that is constructed by two raster processing portions and a part of the print engine and generates print data from respective data in the XHTML format and the JPEG format. This image processing apparatus is constructed mainly by the CPU 41, the ASIC 46, the ROM 42, the EEPROM 43, and the RAM 44. In this case, a part of the process is realized by the software whose program is executed by the CPU 41. It is of course that most of the process are not realized by the hardware circuit but a half or more of the process can be realized by the software.

As shown in FIG. 7, an interpretation processing portion 90, a JPEG extractor 91, a YcbCr/RGB converter 92, a memory controller 93, an image processing portion 46a, and a print processing portion 46b are built in the ASIC 46. Also, the image processing portion 46a has a color-conversion processing portion 94, a binary processing portion 95, and the like. The print processing portion 46b has a command encoder 96 and an engine controller 97. A character generator 98 is built in the ROM 42. Also, the EEPROM 43 contains a template storing portion 86 in a part of the storing area and also stores a color converting table 99.

The memory controller 93 is such a circuit that expands the dot data consisting of at least one of the character data and the image data on the work memory 44b and also performs the image process to rearrange the pixel sequence of the expanded dot data in order of the raster scan.

Also, respective buffers 75a, 76a that the raster processing portions 75, 76 in FIG. 6 have respectively are assured in the RAM 44 as a dedicated storing area respectively. Of course, the dedicated storing area may be assured in an SDRAM, for example, except the RAM.

XHTML Data Raster Process

First, a process in the text-data raster processing portion 75 for applying the raster process to the XHTML data will be explained hereunder. In this case, the text-data raster processing portion 75 is constructed by the interpretation processing portion 90, the memory controller 93, the character generator 98, the first buffer 75a, and the like.

In the ROM 42, character generator data (CG data) showing character (character, symbol, etc.) patterns such as Japanese and English fonts, etc. are stored and the character generator 98 for converting the character codes into CG data is built up. The character generator 98 reads the CG data required to specify the dot configuration (character dot pattern) of various characters when the character code is assigned to the designated address. The CG data are vector data. Here, the vector data are the data indication a profile of the character and the figure as the object of the drawing. In more detail, the vector data are described by parameters containing equations that give the coordinates of major points of the character or the figure and curves (e.g., Bezier curve) connecting the coordinates.

The XHTML data fed to the text-data raster processing portion 75 are first transferred to the interpretation processing portion 90. The XHTML data include the character data as the text in which the personal information are described, and the template tags that describe locations in which a layout of the text of the personal information is designed.

The interpretation processing portion 90 analyzes the description contents of the XHTML data, and correlates the character data corresponding to the characters of the body of the text with the layout data (coordinate data in an address space) interpreted from the template tags, which describe the locations in which the layout of the character string is designed, individually. The character data include the character codes (e.g., ASCII code, or the like) for specifying the type of the character and the symbol and modifier information such as the font, etc. The interpretation processing portion 90 transfers the character data decomposed and converted from the XHTML data and the layout data together with individual correlation information to the memory controller 93.

The memory controller 93 executes a vector font expanding process to convert the CG data (vector data), which are read by supplying the character data to the character generator 98, into the character dot pattern data in a predetermined character size (character dot data). Also, the memory controller 93 expands the character dot data obtained by the vector font expanding process onto vertical positions and horizontal positions that are designated by the layout data (coordinate data on the address space) in the work memory 44b. Then, the memory controller 93 rearrange the expanded pixel sequence into the raster scan sequence, then stores such sequence in the first buffer 75a, and then transfers such sequence to the print processing portion 46b. Here, a buffer capacity of the first buffer 75a is relatively small (e.g., 30 to 100 kilobyte) since the first buffer 75a is used in the raster process of the XHTML data.

JPEG Image Data Raster Process

Next, a process in the image-data raster processing portion 76 to apply the raster process to the JPEG image data will be explained hereunder. In this case, the image-data raster processing portion 76 is constructed by the JPEG extractor 91, the YcbCr/RGB converter 92, the memory controller 93, the second buffer 76a, and the like.

The JPEG extractor 91 is such a circuit that extracts the JPEG image data to convert such data to the multi-valued image data in the YcbCr color system. The YcbCr/RGB converter 92 is such a circuit that converts the multi-valued image data in the YcbCr color system into the multi-valued image data in the RGB color system. Following transformation expressions are used in this color conversion.
R=Y+1.40200×Cr
G=Y−0.34414×Cb−0.71414×Cr
B=Y+1.77200×Cb

The memory controller 93 is such a circuit that performs the imaging process to expand the RGB multi-valued image data received from the YcbCr/RGB converter 92 on the work memory 44b and also rearrange the expanded pixel sequence into the raster scan sequence. Here, in the JPEG compression process, the original image is divided into 8 pixel×8 pixel block areas, and a predetermined operating process is applied in unit of the block area. Therefore, the pixel data are aligned in the form of the 8 pixel×8 pixel divided block area in the initial RGB multi-valued data that are converted from the JPEG data and then transferred from the YcbCr/RGB converter 92. The memory controller 93 converts the alignment of the pixel data, which are partitioned in the form of the 8 pixel×8 pixel block area, into the alignment of the raster scan (i.e., which repeats the horizontal scanning from the left end to the right end of the image in the row direction line by line downward from the uppermost line, for example) sequence that is suitable for the printing process.

The memory controller 93 expands each image data of the RGB multi-valued image received from the YcbCr/RGB converter 92 and then rearranges the data by writing such data on the second buffer 76a in compliance with the raster scan sequence. Therefore, the RGB multi-valued image data in which the pixels are aligned in the raster scan sequence are stored on the second buffer 76a. The memory controller 93 transfers the RGB multi-valued image data in which the pixels are aligned in the raster scan sequence to the image processing portion 46a. Here, a buffer capacity of the second buffer 76a is relatively larger (e.g., 3 to 10 megabyte) than that of the first buffer 75a because the second buffer 76a is used in the raster process of the JPEG image data.

The RGB multi-valued image data transferred to the image processing portion 46a is first sent to the color-conversion processing portion 94, and then sent to the binary processing portion 95. The color-conversion processing portion 94 is such a circuit that color-converts the RGB multi-valued image data into the CMYK multi-valued image data. Also, the binary processing portion 95 is such a circuit that converts the CMYK multi-valued image data into CMYK binary image data.

The color-conversion processing portion 94 reads the color converting table 99 that is stored in the EEPROM 43 and used to convert the color from the RGB color system to the CMYK color system, and then converts the RGB multi-valued image data into the CMYK multi-valued image data by looking up this table. This CMYK multi-valued image data are transferred to the binary processing portion 95.

Then, the binary processing portion 95 applies the binarizing process (e.g., error diffusing process, dither process, or the like) to the CMYK multi-valued image data to convert the data into the CMYK binary image data. This CMYK binary image data are transferred to the print processing portion 46b. The data transferred to the image processing portion 46a are transferred to the CPU 41 upon applying a predetermined process such as expansion, compression, rotation, or the like, and the predetermined process is carried out by the software process.

The character dot data rearranged in the raster scan sequence or the CMYK binary image data are transferred to the print processing portion 46b. Such data are transferred to the command encoder 96.

The command encoder 96 sets up the print data by combining the character dot data or the CMYK binary image data together with the command header of the printer print command from the CPU 41, and then sends such data to the engine controller 97. The engine controller 97 outputs the command signal, which drives/controls the piezoelectric elements PZ based on the print data, to the driver 47d.

Cutter Unit

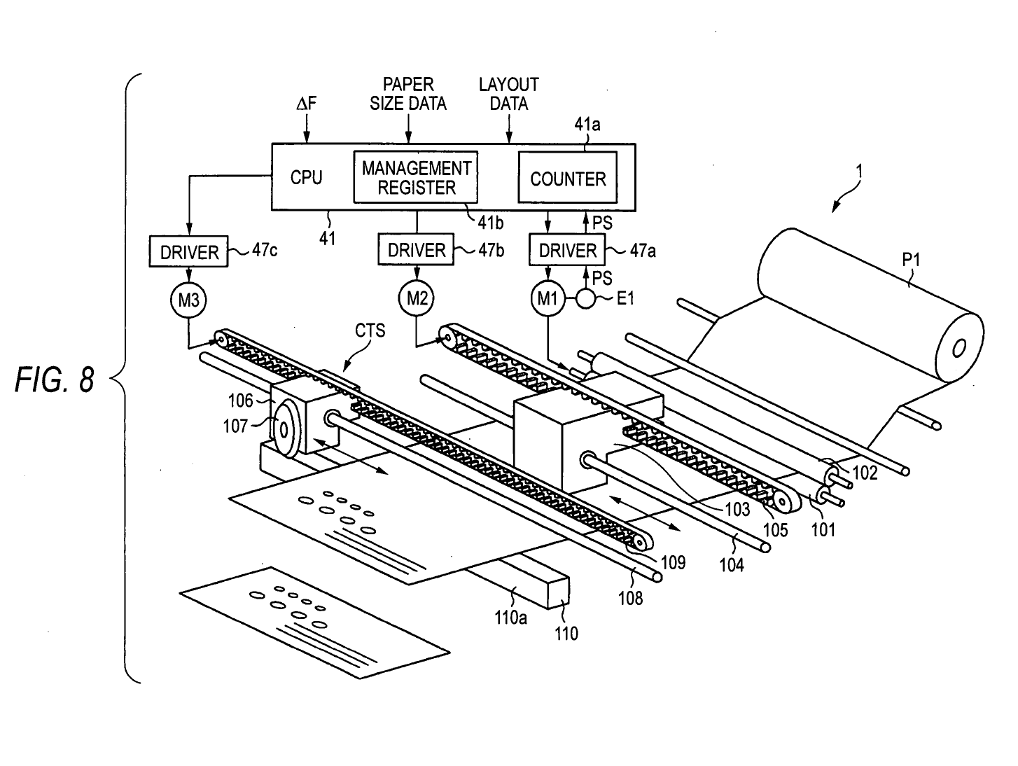

FIG. 8 is a perspective view showing a printing mechanism of the printer 1. As shown in FIG. 8, the printer 1 is equipped with a cutter unit (auto cutter unit) CTS that cuts the roll paper P1 into a predetermined size at a position after the printing. A configuration of the printing mechanism, mainly the cutter unit CTS, will be explained hereunder.

The roll paper P1 being set in the roll paper supporting portion 5 (shown in FIG. 1) is fed along a predetermined carrying route and then discharged from the paper discharge port 7 (shown in FIG. 1) provided on the front lower portion of the printer 1. The roll paper P1 is carried to a printing start position of a carriage 103 by a paper feed roller 101 driven by the paper feed motor M1 and a paper feed idler roller 102. A recording head (not shown) having a plurality of injection nozzles is mounted on the carriage 103. The carriage 103 is guided movably in the main scanning direction by a guiding shaft 104. The carriage 103 is moved reciprocally in the main scanning direction when a timing belt 105 fixed to the carriage 103 is rotated/driven forward and backward by the carriage motor M2. The printing is applied to the roll paper P1 by repeating alternately the conveyance of the roll paper P1 and the movement of the carriage 103 in the main scanning direction and injecting the ink from the injection nozzles provided onto the recording head (not shown) in the course of movement of the carriage 103 in the main scanning direction.

The cutter unit CTS has a cutter head 106 that is positioned on the downstream side in the paper feed direction rather than the carriage 103 and moved reciprocally in the main scanning direction. The cutter head 106 has a rotary blade 107, and is guided movably in the main scanning direction by a guiding shaft 108. The cutter head 106 as well as the rotary blade 107 is moved in the main scanning direction when a timing belt 109 fixed to the cutter head 106 is rotated/driven forward and backward by the cutter motor M3. A fixed blade 110 is arranged under the rotary blade 107 along a moving route of the rotary blade 107 to extend in the main scanning direction. When the cutter head 106 is moved in the main scanning direction, the rotary blade 107 is moved reciprocally while being pushed against a blade portion 110a of the fixed blade 110 to cut the roll paper P1.

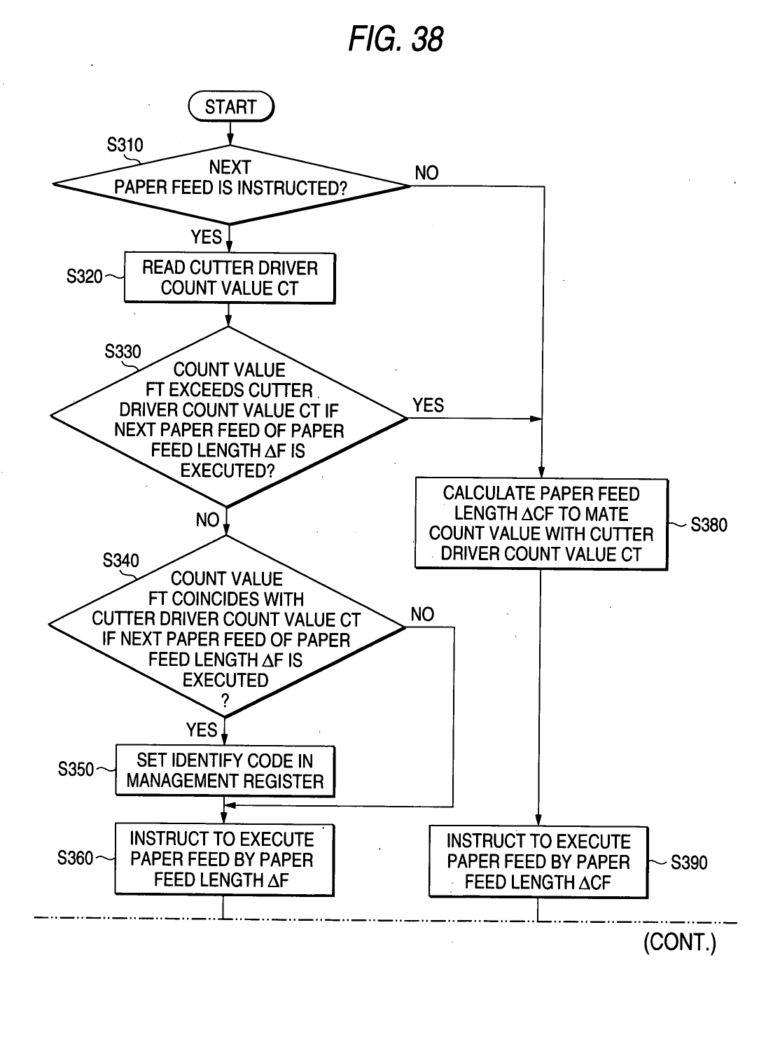

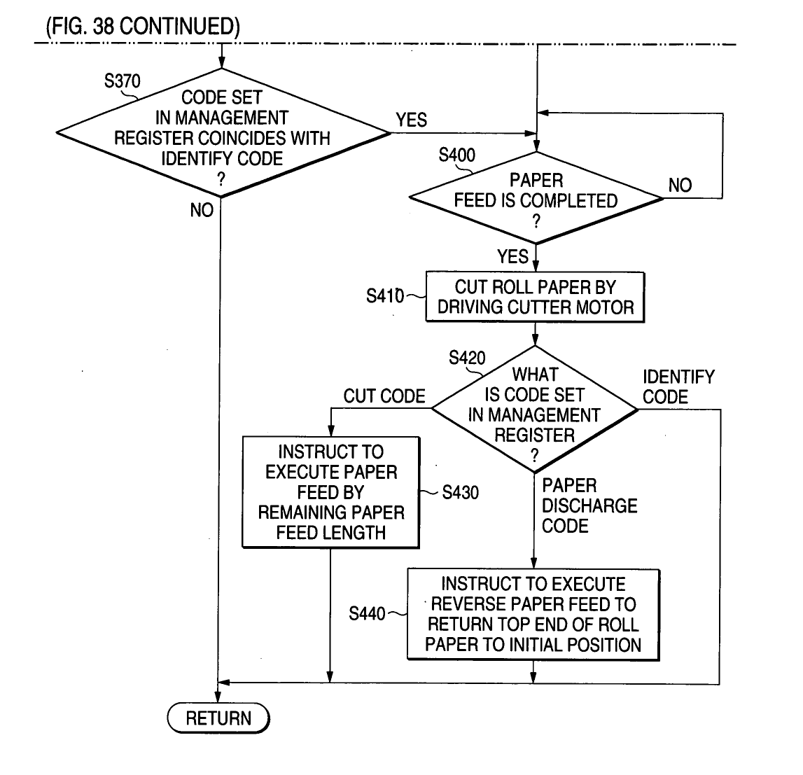

Next, a drive control of the cutter unit CTS will be explained hereunder. The CPU 41 outputs the command signal to the driver 47c by executing a program shown by a flowchart in FIG. 38 to drive/control the cutter motor M3.

The CPU 41 calculates a cutting width of the roll paper P1 based on the layout data designated previously and the paper size data. For example, in the case where the roll paper P1 is set to 90 mm, its cutting width is calculated as 55 mm if the name card layout is designated. Of course, even though the name card layout is designated, its cutting width is calculated as 90 mm if the roll paper P1 is set to 55 mm.

This cutting width data is converted into a count value used in the paper feed control by the paper feed motor M1. An encoder E1 for sensing an amount of drive (i.e., an amount of paper feed) to output a pulse signal PS, which has the number of pulses in proportion to the amount of drive, is provided to the paper feed motor M1. The pulse signal PS of the encoder E1 is output to the CPU 41 via the motor driver 47a. The CPU 41 increments a counter 41a by the number that corresponds to the number of pulses of the pulse signal PS being input from the encoder E1. The counter 41a is reset to “0” when the power supply of the printer 1 is turned ON, and then counts a value corresponding to an accumulated value of the subsequent amount of paper feed. The count value is continued to increase until the power supply is turned OFF. The CPU 41 sets a predetermined position of the recording head in the paper carrying direction as a head reference position, and manages a position of the paper P1 by a count value of the counter 41a in the head reference position.

When it is sensed by a paper sensor (not shown) that a top end of the paper P1 comes up to the head reference position upon the top end control of the paper, the CPU 41 recognizes a count value (e.g., “10000”) of the counter 41a at that time as a paper top position. Then, the count value is being increased with the paper feed. When the count value reaches the count value that corresponds to the final printing position of the paper (value obtained by adding a value, which is obtained by subtracting a bottom margin from a paper length, to the count value of the top end), e.g., “12000”, the CPU 41 recognizes that the paper comes up to the paper discharge position. In this manner, the CPU 41 executes the paper feed control by the count value. Also, the CPU 41 executes the paper feed control, which pauses the roll paper P1 at a cutting position to cut it by the cutter unit CTS in the middle of printing, by the count value.

The CPU 41 executes a calculating operation to control the paper feed prior to the issue of the next paper feed command. The control contents are shown in a flowchart shown in FIG. 38 and executed by the CPU 41.

An amount of next paper feed (counter conversion value) ΔF enters into the CPU 41 as data. Also, the CPU 41 causes a memory to store a cutting width calculated previously based on the layout data. When the top end of the paper is set and a counter value CT (e.g., “10000”) at that time is decided, the CPU 41 calculates a cutter-driving count value CT (“13000” in this example) by adding a counter conversion value (e.g., “3000”) of the cutting width (e.g., “55 mm”) to this value “10000”. This cutter-driving count value CT is set as a position of a virtual cutting line on the roll paper 1. The CPU 41 adds ΔF to a present count value FTo as soon as it accepts an amount of next paper feed (counter conversion value) ΔF, and then decides whether or not a resultant value exceeds the cutter-driving count value CT. If the resultant value exceeds the value CT, the CPU 41 changes an amount of paper feed to stop once the roll paper P1 at a position corresponding to the cutter-driving count value CT. In contrast, if the paper feed motor M1 is driven, the CPU 41 causes the roll paper P1 to stop once at a point of time when a count value FT coincides with the cutter-driving count value CT, and then drives the cutter motor M3 to cut the roll paper P1. Thus, the roll paper P1 is cut along the virtual cutting line. Then, the roll paper P1 is carried by a remaining amount of paper feed (ΔF−(CT−FTo)).

The CPU 41 has a management register 41b and causes the management register 41b to manage the codes that are used to store the next but one operation that should be taken after the next paper feed is ended. As the managed codes, there are three types, i.e., a paper discharge code (e.g., “01”), a cut code (e.g., “10”), and a coincidence code (e.g., “11”). The paper discharge code (e.g., “01”) is such a code that is applied to execute next the paper discharging process without the next paper feeding operation after the paper feed. The cut code (e.g., “10”) is such a code that is applied to execute the cutting process and the subsequent paper feeding process by a remaining amount of paper feed after the paper feed when an amount of paper feed in the next paper feed is changed to a smaller amount of paper feed that is suited for the cutting. The coincidence code (e.g., “11”) is such a code that is applied to execute the cutting operation after the paper feed when the roll paper P1 just comes up to the cutting position by the next paper feed.

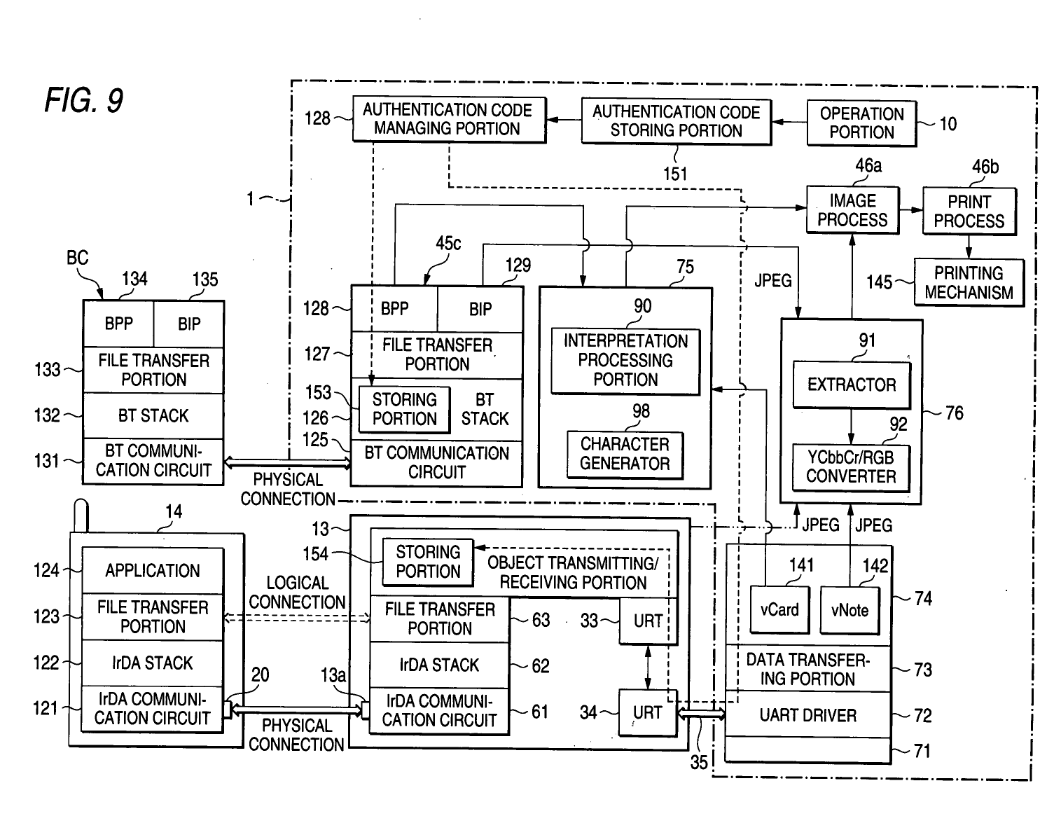

FIG. 9 is a block diagram explaining a flow of a data processing executed until the data that the printer received in a plurality of communication systems are converted into the print data and then printed. As the communication system, only the memory card reading system, the Bluetooth communication system, and the infrared communication (IrDA) system are listed. The data received in these communication systems have different applicable file formats according to the type of the device as the sender, but the printer 1 can accommodate respective printings independently of the difference of the applicable file format in respective communication systems. In the memory card reading system, since the application in which the image data picked up by the digital camera is read from the memory card to print is supposed as the premise, the read data are the JPEG data employed normally in the digital camera. The data received in the Bluetooth communication system are the XHTML data, which has a high frequency in the use of the Bluetooth-applicable mobile terminal BC such as PDA, or the like, and the JPEG data. The data received in the infrared communication (IrDA) system are the vCard format data and the vNote format data employed in the cellular phone 14. When the file format of the received data is different respectively in this manner, different data processes are needed every file format until the data are converted into the print data to print.

The printer 1 of this embodiment has a printing process function of handling the print data received from the printer driver in the host computer, a printing process function of processing the image data (JPEG) read from the memory card, and a printing process function of processing the XHTML data received in the Bluetooth communication system. Then, in the present embodiment, the IrDA communication module is provided in the form of the CF-type communication card 13 by utilizing the card slot 12 originally provided to use the memory card, and is installed as the card in employing the infrared communication system. Therefore, a change of design in the shape of the casing (main body case) of the printer 1 is not needed, and the casing of the printer 1 can be used commonly before and after the introduction of the infrared communication system. As a result, a change of design or a change of manufacturing mold is not needed. Also, merely softwares such as the IrDA communication protocol, the application, and the like are added/varied in the inside of the printer 1. Therefore, the IrDA communication function can be added by using the existing circuits, etc. as they are without their modifications.

Next, a characterizing configuration of the printer that can be constructed only by adding a simple structure because the existing structure is shared upon introducing the infrared communication system will be explained with reference to FIG. 9 hereunder.

In introducing the infrared communication system, the CF-type communication card 13 inserted into the card slot 12 in use, and an IrDA communication processing portion 120 consisting of an IrDA communication chip, a communication protocol, an application, etc. provided to the main body 2 are added.

As already explained, the CF-type communication card 13 has the infrared-ray receiving/emitting portion 13a, the IrDA communication circuit 61, the IrDA stack 62, the file transfer portion (IrOBEX) 63, the object transmitting/receiving portion 64, and the UARTs 33, 34. Also, the cellular phone 14 that transmits the data to the CF-type communication card 13 in the infrared communication system has a substantially similar communication layer structure. The cellular phone 14 has the infrared-ray emitting/receiving portion 20, an IrDA communication circuit 121, an IrDA stack 122, a file transfer portion (IrOBEX) 123, and an application 124. Also, the IrDA communication processing portion 120 has the drivers 71, 72, the data transferring portion 73, and the IrDA profile processing portion 74. The IrDA profile processing portion 74 is constructed by a software that converts the data handled in the cellular phone 14 into the file format, the data, or the like handled in other communication system.

Meanwhile, constituent portions to implement the memory card reading system are the first slot communication portion 45e, the image-data raster processing portion 76, an image selection processing portion (not shown) containing UIs (user interfaces) used to select the image data stored in the memory card MC, and others. The image-data raster processing portion 76 has a function of executing the raster process of the JPEG image data and, as already explained in FIG. 7, has the extractor 91, the YcbCr/RGB converter 92, and the like.

Also, constituent portions to implement the Bluetooth communication system are the BT communication portion 45c, a Bluetooth communication circuit (referred to as a “BT communication circuit” hereinafter) (physical layer) 125, a Bluetooth communication protocol stack (referred to as a “BT stack” hereinafter) 126, a file transfer portion (OBEX) 127, a BPP 128 and a BIP 129 (both being an application layer respectively). The cellular phone BC that transmits the data to the BT communication portion 45c has a substantially similar communication layer structure, and has a BT communication circuit (physical layer) 131, a BT stack 132, a file transfer portion (OBEX) 133, a BPP 134 and a BIP 135 (both being an application layer respectively). The text-data raster processing portion 75 has a function of executing the raster process of the text data in the XHTML format and, as already explained in FIG. 7, has the interpretation processing portion 90, the character generator 98, and the like. Also, the JPEG image data received by the BT communication portion 45c are transferred to the image-data raster processing portion 76 and are subjected to the raster process. In other words, since the Bluetooth communication system and the memory-card reading system can handle the image data in the same file format, the image-data raster processing portion 76 is used commonly in the raster process.

The XHTML data sent from the BPP 128 in the BT communication portion 45c are interpreted by the interpretation processing portion 90 to extract the character code and the layout data. The character code is converted into character patterns constructed by dots by the character generator 98, and the layout data are used to decide arrangement positions of the character patterns upon expanding the image.

Meanwhile, the IrDA profile processing portion 74 in the IrDA communication processing portion 120 has a text data processing portion (vCard processing portion) 141 for executing mainly a data format converting process from the vCard format to the XHTML format, and an image data processing portion (vNote processing portion) 142 for executing a data format converting process from the vNote format to the JPEG format. The text data processing portion 141 has the number-of-cases deciding portion 82, the Note analyzing portion 83, the division processing portion 84, the text-data format converting portion 85, and the template storing portion 86. While, the image data processing portion 142 has the image data decoding portion 87.

The text data processing portion 141 converts the vCard text data into the XHTML text data in the template built-in description format. That is, the text data processing portion 141 can utilize the text-data raster processing portion 75, which is prepared for the data processing in the bluetooth applicable format, by converting the vCard text data as the cellular-phone applicable format into the XHTML text data as the bluetooth applicable format. Also, the image data processing portion 142 converts (decodes) the encoded image data in the vNote attached format into the JPEG image data. That is, the image data processing portion 142 can utilize the image-data raster processing portion 76, which is prepared for the data processing in the bluetooth applicable format and the memory-card applicable format, by converting (decoding) the encoded image data in the vNote attached format as the cellular-phone applicable format into the JPEG image data. In this way, the raster processing portions 75, 76 are used commonly in the raster processes of respective data in the bluetooth applicable format and the cellular-phone applicable format.

The image data received in any one of above three communication systems are processed in seriatim by the image processing portion 46a and the print processing portion 46b after the raster process, and thus the print data are generated based on the image data. Also, the text data received in any one of above three communication systems are processed in seriatim by the image processing portion 46a and the print processing portion 46b after the raster process, and thus the print data are generated based on the text data. Then, a printing mechanism 145 is driven/controlled by the print processing portion 46b based on the print data.

Also, as shown in FIG. 9, an authentication code storing portion 151 and an authentication code managing portion 152 are provided to the printer 1. When the user executes the transmission operation to transmit the information with relatively high concealability such as the personal information, or the like, a function of demanding an inputting of the authentication code of the user on the display 18 is provided to the cellular phone BC or the cellular phone 14. At that time, when the user inputs the same authentication code as the registered code in the destination device of the data transmission, the authenticity of the user is verified in establishing the communication link and thus the user can transmit the data. In the printer 1, when an authentication code is input by operating the operation portion 10 in a state that an authentication code registering menu is selected on the operation panel 8, the authentication code is stored in the authentication code storing portion (in this example, a predetermined recording area in the EEPROM 43) 151.

The authentication code managing portion 152 reads the authentication code from the authentication code storing portion 151 and manages it every time when the power supply of the printer 1 is turned ON and the authentication code is input by the operation portion 10 to update, for example, and sends the authentication code to the BT communication portion 45c to store in a storing portion 153 provided to the BT stack 126. Also, the authentication code managing portion 152 sends the authentication code to the object transmitting/receiving portion 64 in the CF-type communication card 13 when the CF-type communication card 13 is detected for the first time after the power supply of the printer 1 is turned ON, and stores the code in a storing portion 154.

OBEX Data Structure

Next, the IrDA communication exchanged between the cellular phone 14 and the CF-type communication card 13 will be explained hereunder.

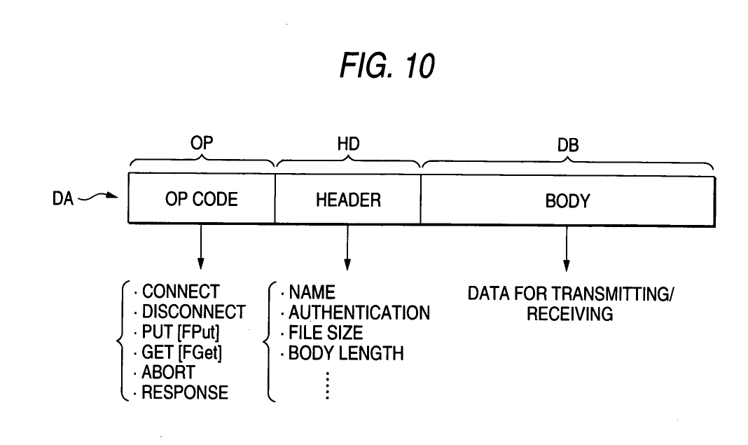

FIG. 10 shows a data structure in the OBEX specification used in transferring the file. The data DA is constructed by an OP code OP, a header HD, and a data body DB. The commands about the communication are described in the OP code OP. As the command, “Connect”, “Disconnect”, “PUT”, “FPUT”, “GET”, “FGET”, “Abort”, “Response”, etc. are prepared.

“Connect” means the connecting request, and “Disconnect” means the disconnecting request. Also, “PUT” means the data receiving request, “FPUT” means the final data receiving request (containing the meaning of the transmitted data end), “GET” means the data fetching request, “FGET” means the final data fetching request (containing the meaning of the received data end). Also, “Abort” means the interruption, “Response” means the response.

Information about the data body DB are described in the header HD. The data body DB signifies the to-be-transmitted/received (transferred) data themselves, and normally is divided into packets (blocks) that are smaller than a predetermined size. In the case in this example, the object data transmitted from the cellular phone 14 to the printer 1 are divided into a plurality of pieces and then transferred when the data size is in excess of a predetermined size. “Name”, “Authentication”, “File size”, “Body length”, etc. are prepared. “Name” means a file name, “Authentication” means to verify a qualification to access the information, “File size” means a file size, and “Body length” means a body data length. Since the file name is described in “Name” in the form of “file name. extension”, the user can acquires the “extension” of the file by looking at the value of “Name”.

Also, the authentication code (pin code) capable of verifying such qualification when the qualification to access the information is set is described in “Authentication”. In the cellular phone 14, inputting of the authentication code is required of the user whenever all cases of the personal information registered in the memo-pad function or all cases of the personal information in the pointed group are to be transmitted. When such the data of all cases are to be transmitted, the authentication code is input into an input box on the display 18 after the send button is operated. The input authentication code is described in “Authentication” in the header HD.

As already explained in FIG. 9, the authentication code registering function is provided to the printer 1. When the user wishes to transmit directly the data of all cases from the cellular phone 14 to the printer 1 and print them, the authentication code must be registered in the printer 1 in advance by operating the operation portion 10 on the operation panel 8.

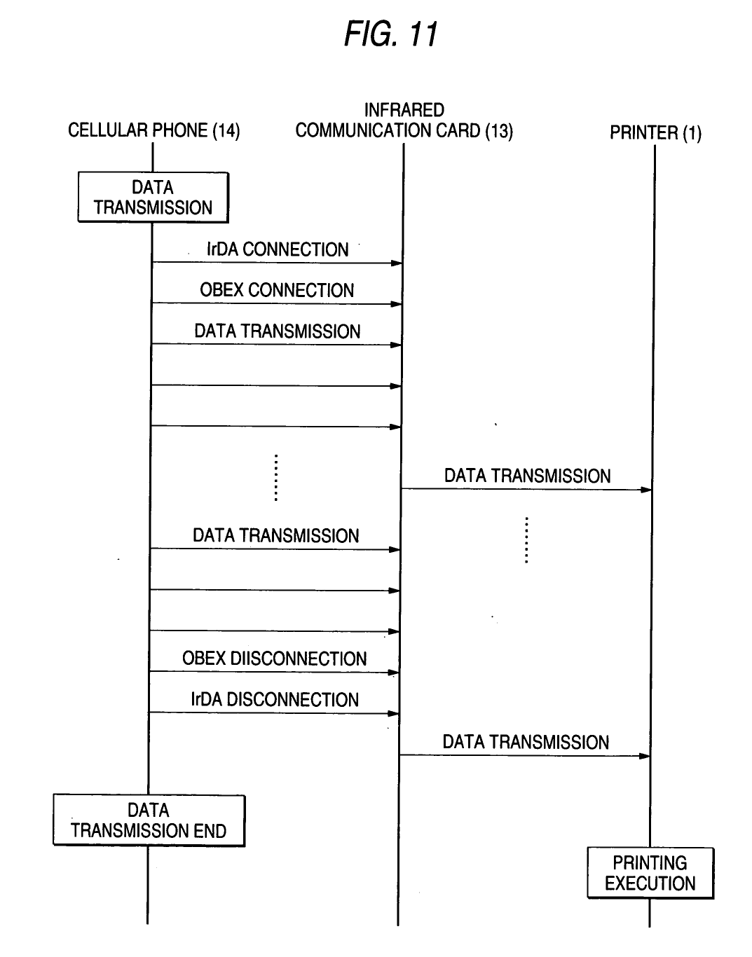

FIG. 11 shows a transferring process sequence applied to transfer the data in a flow of the cellular phone→the infrared communication card (CF-type communication card)→the printer.

When the operation for data transmission is executed by the cellular phone 14, first the IrDA connection (physical connection) between the IrDA communication circuits 61, 121 as the physical layer is established. When the IrDA connecting request is issued from the cellular phone 14 and then the CF-type communication card 13 responds to this request, the IrDA connection is established. Then, the OBEX connection (logical connection) is established. When the OBEX connection (logical connection) is requested by transmitting the data containing “Connect” as the OP code OP from the cellular phone 14 and then the CF-type communication card 13 responds to this request by the data containing “Response” as the OP code OP, the OBEX connection (logical connection) is established.

When the logical connection is established, the file transfer portion 123 divides the file data into data lengths within a maximum allowable data length of the body DB, and transfers plural times the file data in unit of split blocks (frames). At this time, the file transfer portion 123 constructs the data DA having “PUT” in the OP code OP and the blocks in the body BD and transmits such data. Subsequently, the file transfer portion 123 waits for the reception of the data containing “Response” as the OP code OP and then transmits the next data DA having “PUT” in the OP code OP.

The file transfer portion (IrOBEX) 63 on the CF-type communication card 13 side restores the data by assembling the blocks being received sequentially. The restored data are transferred to the object transmitting/receiving portion 64. The object transmitting/receiving portion 64 transmits the data to the printer 1 in compliance with the transmission control procedures (basic procedures) in unit of blocks (frames) within a predetermined data size. At that time, the object transmitting/receiving portion 64 transmits “name.extension” acquired from “Name” in the header HD together with the data.

In this fashion, the data transferring process proceeds. When the final block (data) are transferred from the cellular phone 14, “FPUT” is described in the OP code OP. The file transferring portion 63 recognizes the last block, i.e., the notification of the data reception completion when the OP code OP of the received data is “FPUT”. When the disconnecting request having “Disconnect” in the OP code OP is sent out from the cellular phone 14 at this opportunity, the OBEX connection (logical connection) is disconnected. Then, when the IrDA connection (physical connection) is disconnected, the communication link is cut off. Then, the print data are generated from the received data in the printer 1 and then the printing is carried out based on the print data.

In this case, the data having “Abort” in the OP code OP are transmitted to the CF-type communication card 13 when the user operates the cellular phone 14 to interrupt the data transmission. In this case, the communication link is cut off via the IrDA disconnection and the OBEX disconnection in compliance with the similar procedures.

Also, in this example, the function of transferring the file from the printer 1 to the cellular phone 14 is not provided. In this case, a transfer function of transferring the file stored in the memory in the printer 1 to the cellular phone 14 may be provided to the printer 1 when the data having “GET” in the OP code OP are sent from the cellular phone 14 to the CF-type communication card 13.

Sharing Operation of the Authentication Code

In this manner, in the IrDA communication, the IrDA connection (physical connection) and the OBEX connection (logical connection) are established at the beginning of the communication, but the former authentication code is required at the time of the OBEX connection. Meanwhile, in the Bluetooth-applicable cellular phone BC, the physical connection and the logical connection are established at the beginning of the communication, but the former authentication code is required at the time of the physical connection. As the authentication code required for two communication systems, the authentication code registered previously by using an authentication code registering function in the printer 1 is used in common in the CF-type communication card 13 and the BT communication portion 45c.

Next, an authentication code registering function shared with two communication systems will be explained in detail hereunder. First, upon registering the authentication code, the user chooses “authentication code registration” from the menu displayed on the screen 9a. The CPU 41, when recognized that the authentication code is chosen, demands the inputting of the authentication code of the user by display an input box on the screen 9a. When the user inputs the authentication code by operating the operation portion 10, the CPU 41 stores the authentication code in a predetermined storing area of the EEPROM 43 (the authentication code storing portion 151 in FIG. 9).

The authentication code managing portion 152 shown in FIG. 9 is started when the CPU 41 executes an authentication code managing program stored in the ROM 42 in the initializing process at the time when the power-supply of the printer is turned ON. The authentication code managing portion 152 reads the authentication code from the authentication code storing portion 151, and stores the authentication code in a register, for example, to manage it. The authentication code managing portion 152, when accepts a code request from any one of the BT communication portion 45c and the CF-type communication card 13, transmits the authentication code to the requester. The BT communication portion 45c outputs the code request when the printer 1 is subjected to the initializing process. Also, the CF-type communication card 13 outputs the code request when the card is connected electrically for the first time after the power supply of the printer 1 is turned ON. Also, the authentication code managing portion 152 reads the updated authentication code from the authentication code storing portion 151 and transmits such code to the BT communication portion 45c and the CF-type communication card 13 every time when such managing portion 152 accepts a notice to the effect that the operation portion 10 is operated to add/erase, or the like the authentication code.

The authentication code storing portions 153, 154 are provided to the BT communication portion 45c and the CF-type communication card 13 in the same layer as the communication layer, which needs the authentication code in the communication, or its upper layer. In the BT communication portion 45c that needs the authentication code at the time of physical connection, the storing portion 153 is provided to the BT stack layer 126, for example. Also, in the CF-type communication card 13 that needs the authentication code at the time of logical connection, the storing portion 154 is provided to the object transmitting/receiving portion 64, for example.

The BT communication circuit 125 issues the request for the authentication code to the BT stack in the physical connection and receives the authentication code from the BT stack, and then collates the authentication code received from the BT stack with the authentication code registered already in the storing portion 153 and read therefrom. Meanwhile, when the authentication code is attached to “Authentication” in the header HD of the data that are received at the time of logical connection, the IrDA communication circuit 61 reads the authentication code from the storing portion 154 and collates the attached authentication code with the read authentication code. As the result of this collation, the data reception is allowed if both authentication codes coincide with each other, and the data reception is rejected if both authentication codes do not coincide with each other. In this manner, both the BT communication portion 45c and the CF-type communication card 13 acquire the authentication code from the authentication code managing portion 152. Thus, the Bluetooth communication and the IrDA communication share also the authentication code registering function.

Displaying Portion Lightening Control of the CF-type Communication Card

Next, lightening control of the displaying portion 13b informing the user of a data receiving state will be explained in detail hereunder. The displaying portion 13b of the CF-type communication card 13 informs the user of a receiving state of the data transmitted from the cellular phone 14.

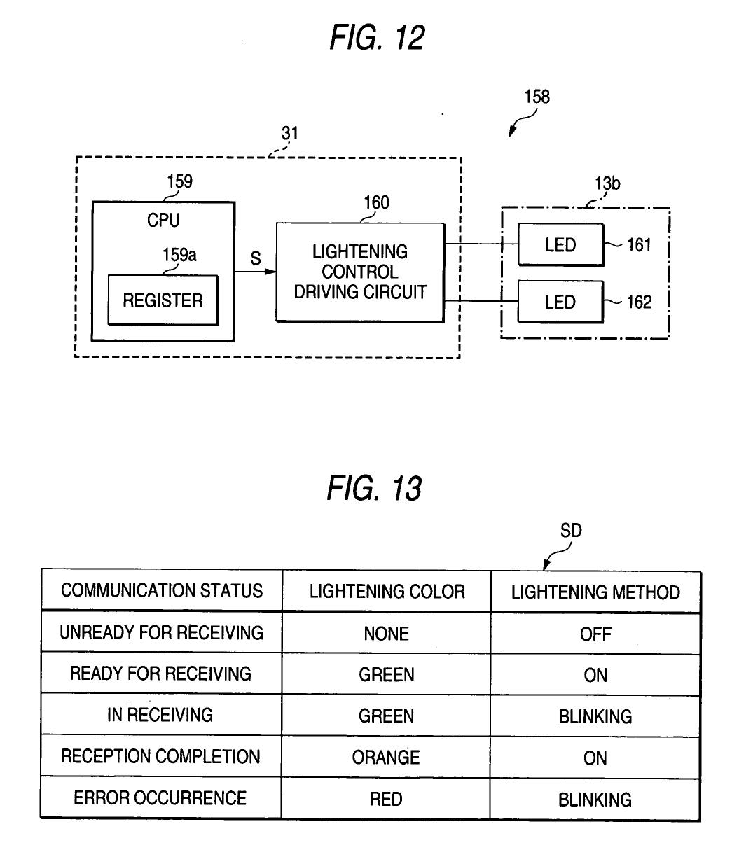

FIG. 12 shows a display control device in the displaying portion, and FIG. 13 shows a relationship between communication statuses and lightening modes (lightening modes).

As shown in FIG. 12, a display control device 158 has a CPU 159 and a lightening control driving circuit 160 both built in the card control portion 31, and two LEDs 161, 162a lightening (display) of which is controlled by the CPU 159 via the lightening control driving circuit 160. Two LEDs 161, 162 have a different lightening color (display color) respectively. In this example, the LED 161 can be lightened in green color and the LED 162 can be lightened in red color.

The CPU 159 in the card control portion 31 performs the lightening control of the displaying portion 13b. The CPU 159 grasps in which receiving condition the communication status exists at present, based on the communication command transmitted/received between the cellular phone 14 and the card 13, results of the data check decided by the CF-type communication card 13 itself, the signal informing of the data receiving state decided by the printer 1 side, etc. The CPU 159 loads the grasped communication status (bit data) in a register 159a. The lightening control driving circuit 160, when received a signal S from the CPU 159 in response to the communication status, controls the lightening of two LEDs 161, 162 based on this signal S.

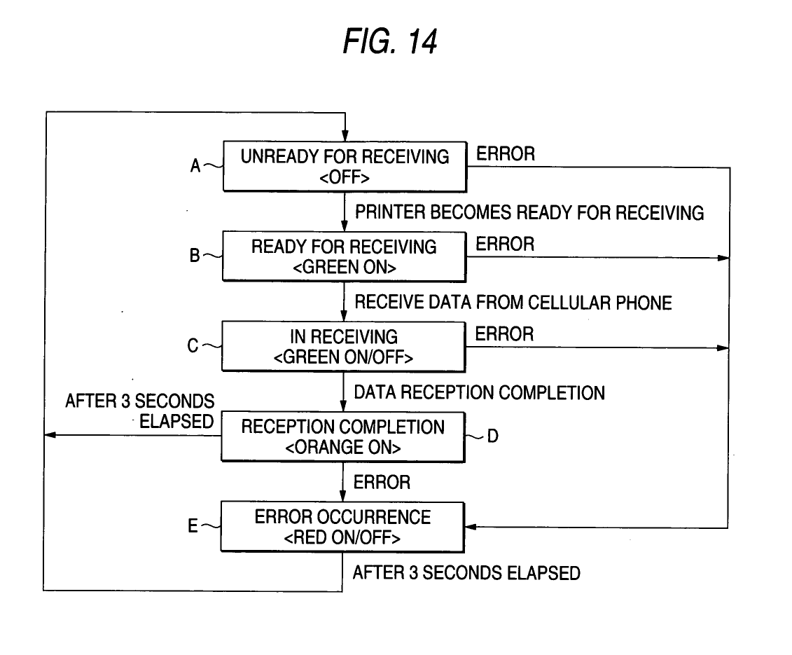

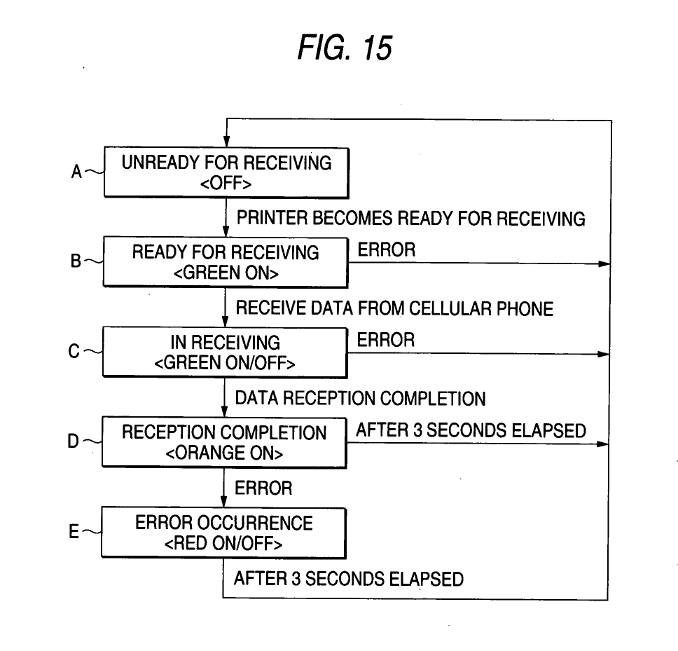

As shown in FIG. 13, as the communication status, there are five types of “unready for receiving”, “ready for receiving”, “in receiving”, “reception completion”, and “error occurrence”. Set data SD indicating relationships between the communication statuses and lightening control contents are stored in a predetermined storing area of the memory 32. The CPU 159 controls the lightening states of two LEDs 161, 162 into any one of five types of lightening modes respectively, based on the present communication status written into the register 159a while looking up the set data SD. In this example, as the lightening mode responding to five types of lightening modes, five modes of “OFF”, “green ON”, “green ON/OFF”, “orange ON”, and “red ON/OFF” are set. The orange color light is emitted by lightening simultaneously two LEDs 161, 162 in green and red colors respectively. In this case, a time period of 3 second in “after 3 second elapsed” in FIGS. 14, 15 is a criterion that the user can perceive, and the time period is not always set to 3 second.

As with the relationship between the communication status and the lightening mode, the lightening control contents are set in such a way that “OFF” is displayed in the “unready for receiving” state, “green ON” is lightened in the “ready for receiving” state, “green ON/OFF” is lightened in the “in receiving” state, “orange ON” is lightened in the “reception completion” state, and “red ON/OFF” is lightened in the “error occurrence” state.

FIG. 14 and FIG. 15 explain transition processes of the communication status respectively and show transition examples. A difference between FIG. 14 and FIG. 15 resides only in that the transition destination status is different at the time of “reception completion” and “error occurrence”, and the transition processes of “unready for receiving”→“ready for receiving”→“in receiving”→“reception completion”→“error occurrence” are similar in both cases. FIG. 14 shows an example in which the process is always transferred to the “error occurrence” status when the error occurs, and the displaying portion 13b is caused to flash in red color (error display). In contrast, FIG. 15 shows another example in which the error is not displayed on the displaying portion 13b when the error is displayed on the displaying 18 of the cellular phone 14, but the error is displayed on the displaying portion 13b only when the error is not displayed on the displaying 18 of the cellular phone 14. The display mode (lightening mode) of the displaying portion 13b (LEDs 161, 162) is changed when the transition of the communication status is executed as shown in FIG. 14 and FIG. 15.

First, the communication status transition from the “unready for receiving” state to the “reception completion” state, which are common in FIG. 14 and FIG. 15, will be explained hereunder. In the case where the CPU 159 in the card controlling portion 31 does not receive a Ready command being output from the UART driver 72 when the printer 1 is now in the initializing process state or when the interlock is now applied to the infrared communication, such CPU 159 sets the communication status of “unready for receiving”. That is, the CPU 159 writes the bit data of “unready for receiving” in the register 159a. Here, the case where the Ready command is not output corresponds to the case where the CPU 41 is executing the initializing process immediately after the power supply of the printer 1 is turned ON or the case where the data reception in the infrared communication system is inhibited, i.e., in the interlocking state because the data reception is executed precedingly via other communication system. When the communication card 13 is in the communication status of “unready for receiving”, all the LEDs 161, 162 are turned OFF and also the displaying portion 13b is brought into the “OFF” state.

Then, in the case where the power supply of the printer 1 is turned ON in such a condition that the CF-type communication card 13 is set in the card slot 12, the card driver 71 sets the extension data in the CF-type communication card 13 that is detected in the initializing process of the printer 1. In contrast, in the case where the CF-type communication card 13 is inserted into the card slot 12 after the power supply of the printer 1 is turned ON, the card driver 71 sets the extension data in the CF-type communication card 13 when the CF-type communication card 13 can be detected for the first time after the power supply is turned ON by such setting. The CPU 41 does not start the first interlocking process until both the initializing process and the setup process are ended. When the CPU 41 allows the UART driver 72 to release the interlock as the result of the interlocking process, the UART driver 72 outputs the Ready command to the card controlling portion 31.

When the CPU 159 in the card controlling portion 31 accepts the Ready command from the UART driver 72 after the receiving preparation on the printer 1 side is completed in this manner, such CPU 159 rewrites the value of the register 159a from the “unready for receiving” bit data to the “ready for receiving” bit data. The communication status goes from the “unready for receiving” to the “ready for receiving” when either the initializing process of the printer 1 is ended or the interlock is released. When the communication status is in the “ready for receiving”, only the green LED 161 is turned ON and the displaying portion 13b is brought into the “green ON” state. The “green ON” state of the displaying portion 13b informs the user of the fact that the CF-type communication card 13 is now ready for receiving.

The CPU 159 holds the communication status of “ready for receiving” while such CPU 159 receives the Ready command. Then, when the CPU 159 receives the PUT request from the cellular phone 14 during when the displaying portion 13b is in the “green uN” state, such CPU 159 establishes the logical connection (OBEX connection). Then, the CPU 159 rewrites the value of the register 159a from the “ready for receiving” bit data to the “in receiving” bit data as soon as the CF-type communication card 13 starts to receive the data. The CPU 159 holds the communication status of “in receiving” while such CPU 159 executes the receiving and transmitting processes of the object data.

As the timing at which the communication status is switched into the “in receiving” state, any one of timings at which the physical connection (IrDA connection) is established, the logical connection (OBEX Connect) is established, and the data transmission (PUT in OBEX) is started may be listed. In the communication status of “in receiving”, only the LED 61 is ON/OFFed (flashed) in green color and also the displaying portion 13b is brought into the “green ON/OFF” state.

The CPU 159 rewrites the value of the register 159a from the “in receiving” bit data to the “reception completion” bit data as soon as the reception of the object data from the cellular phone 14 is completed. When the CF-type communication card 13 ends to receive the data, the communication status shifts to this “ready for receiving” state. As the shifting timing, any one of timings at which the final PUT (FPUT) is received from the cellular phone 14, the Response to the final PUT (FPUT) is transmitted, the data of the OBEX Disconnect (disconnection of the logical connection) is received, and the IrDA disconnection (disconnection of the physical connection) is received may be listed. In the communication status of “reception completion”, two LEDs 162, 163 are ON/OFFed simultaneously in green and red colors respectively and also the displaying portion 13b is brought into the “orange ON” state.

The CPU 159 rewrites the value of the register 159a into the “error occurrence” bit data as soon as it is detected that the error occurs in the communication state through which the data are received from the cellular phone 14. In the communication status of “error occurrence”, the LED 163 is ON/OFFed and thus the displaying portion 13b is brought into the “red ON/OFF” state.

As the method of informing the user of the error occurrence by the ON/OFF of the displaying portion 13b, two cases shown in FIG. 14 and FIG. 15 are considered.

Next, state transition of the communication status in respective cases will be explained hereunder.

As shown in FIG. 14, for example, the initializing process is started as soon as the CF-type communication card 13 is inserted into the card slot 12 after the power supply of the printer 1 is turned ON. In the state of the initializing process, the card 13 takes the communication status A of “unready for receiving”. When this initializing process is ended, the printer becomes ready for receiving and then the Ready command is output to the CF-type communication card 13. Thus, the card 13 takes the communication status B of “ready for receiving”. Then, when the data are transmitted from the cellular phone 14, the command issued at the time when the data transmission is started is checked. Thus, the card 13 takes the communication status C of “in receiving”. Then, when the data transmission is completed, the command issued at the time when the data transmission is completed is checked. Thus, the card 13 takes the communication status D of “reception completion”. Then, the card 13 goes back to the communication status A when a predetermined time (e.g., 3 second) elapsed after the card 13 took the communication status D. Therefore, at the time of completion of the data transmission, the displaying portion 13b is set to the “orange ON” state only for 3 second and then turned OFF.

Here, error contents caused when the status is shifted to the “error occurrence” communication status E from the communication statuses A, B, C, D respectively will be explained hereunder.

First, in case the CF-type communication card 13 is shifted from the communication status A to the communication status E, the case where the CF-type communication card 13 fails to initialize and the case where the transmission of the initialization command to the CF-type communication card 13 is failed may be considered. As the initialization command, “Configuration”, “Setup”, and “Ready” are listed.

Then, in case the CF-type communication card 13 is shifted from the communication status B to the communication status E, the case where the physical connection or the logical connection is failed, the case where an inapplicable file is received (extension check error), and the Case where the Setup command is failed are listed.

Then, in case the CF-type communication card 13 is shifted from the communication status C to the communication status E, the case where the file transfer from the cellular phone 14 to the CF-type communication card 13 (IrDA communication) is failed, and the case where the transfer of the object data from the CF-type communication card 13 to the printer 1 (transmission control procedures) is failed are listed. In addition, the case where the data in the applicable file are abnormal (file data check error), and the case where the data received from other communication portion are now in the printing process (the interlock is released, but other data still remain in the printing process) are listed. For example, when time has run out without reception of the FPUT, the CPU 159 (object transmitting/receiving portion 64) cuts off the connection to the cellular phone 14. When the printer 1 side did not receive the next packet but time has run out, the error is issued and the connection to the cellular phone 14 is disconnected. Since no measure of informing the cellular phone 14 side of the error is given after this connection is disconnected, the “red ON/OFF” of the displaying portion 13b of the CF-type communication card 13 informs the user of the failure of the data transmission.

Then, in case the CF-type communication card 13 is shifted from the communication status D to the communication status E, the case where the data transmission from the CF-type communication card 13 to the printer 1 (transmission control procedures) is failed, and the case where the data in the applicable file are abnormal (file data check error) are listed. When a predetermined time (e.g., 3 second) elapsed after the card 13 is sifted to the communication status E, the CF-type communication card 13 goes to the communication status A. Thus, when the error occurs, the displaying portion 13b displays “red ON/OFF” for 3 second and then is turned OFF. In this case, when the communication status goes from B to E, C to E, D to E, the error occurs at the time when the cellular phone 14 and the CF-type communication card 13 are establishing the communication. Therefore, the cellular phone 14 is informed of the effect that the error occurs, and then the error is displayed on the display 18.

Next, in the case shown in FIG. 15, the transition of the communication status A→B→C→D→E is similar to the case in FIG. 14. In the case where the error occurs in respective communication statuses B, C, D, the CF-type communication card 13 goes not to the communication status E but to the communication status A as it is if the error is of the type the error contents can be displayed on the display 18 of the cellular phone 14. Therefore, on the premise that there is no necessity for informing the error by the displaying portion 13b in vain when the error can be displayed on the display 18 of the cellular phone 14, the CF-type communication card 13 goes to the communication status A and the displaying portion 13b is turned OFF. However, in the case where the error is caused in the communication status D of “reception completion”, the effect of the error occurrence is not displayed on the display 18 of the cellular phone 14 whose communication link has already been cut off. In this case, the CF-type communication card 13 goes from the communication status D to the communication status E, and the “red ON/OFF” of the displaying portion 13b informs the user of the error occurrence.

In this case, when a predetermined time (e.g., 3 second) elapsed after the card 13 goes to the communication status E, the CF-type communication card 13 also goes to the communication status A. Therefore, when the error occurs, the displaying portion 13b displays “red ON/OFF” for 3 second and then is turned OFF. In the statuses A, B in FIG. 15, “red ON/OFF” is displayed for 3 second in the communication status E of “error occurrence”. However, such an application may be employed that a hold time of “red ON/OFF” is not particularly set, then the interlocking process is executed during the communication status E in which “red ON/OFF” is displayed, and then the card 13 goes from the status E to the status B and the display is changed from “red ON/OFF” to “green ON” when the interlock is released.

When the stop is selected/operated on the cellular phone 14, “Abort (interruption)” is transmitted to the CF-type communication card 13. Then, since the card 13 stops to receive the data at a point of time when such card 13 receives “Abort”, only the incomplete data are accumulated in such card 13 and thus the exact printing can be not executed. Therefore, the data that the card 13 received up to now are canceled. The CF-type communication card 13, when received this interruption, may change the displaying portion 13b from “green ON/OFF” to “OFF” or cause the displaying portion 13b to display “red ON/OFF” as the error.

Interlock Function

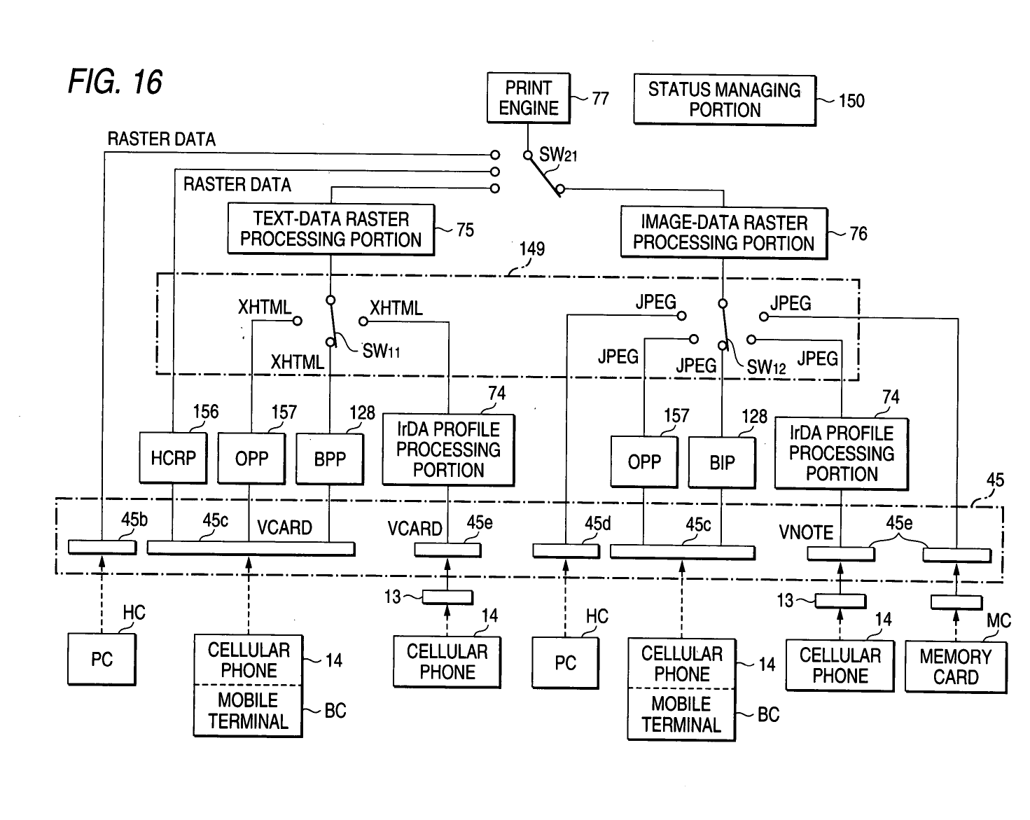

FIG. 16 is a block diagram showing a securing process and an interlocking process of the data transfer route by conception models.

FIG. 16 is a block diagram showing schematically how the transfer routes along which the data, which are received from the host equipment (the cellular phone 14, the mobile terminal BC, the host computer HC) via respective communication portions 45b to 45e in the communication interface portion 45, are transferred subsequently in seriatim through respective processing portions until the data arrive finally at the print engine 77 should be decided. In FIG. 16, a stream pipe 149 is a module that is prepared to realize a switching function by which the CPU 41 selects exclusively one transfer route. A status managing portion 150 for managing states of respective processing portions 74 to 76, etc. through which the data received via respective communication portions 45b to 45e are transferred sequentially until such data finally comes up to the print engine 77, e.g., current states of respective processing portions 74 to 76, etc. such as running state (RUN), standby state (WAIT), ready state (READY), etc. is prepared.

The stream pipe 149 has two switches SW11, SW12 that decide whether or not the transfer route can be secured based on the states of respective processing portions 75, 76 and the print engine 77, which are positioned on the downstream side (transfer destination side) and managed by the status managing portion 150, when such stream pipe 149 accepts the transfer request from any one of respective processing portions containing the IrDA profile processing portion 74 located on the upstream side (receiving portion side), and then connect/disconnect the transfer route in response to the decision result. The switch SW11 selects one transfer route, which first accepts the transfer request, among a plurality of transfer routes that are prepared to send the XHTML data to the text-data raster processing portion 75. In contrast, switch SW12 selects one transfer route, which first accepts the transfer request, among a plurality of transfer routes that are prepared to send the JPEG data to the image-data raster processing portion 76. In this event, in the case where these switches get the information to the effect that the raster processing portions 75, 76 as the transfer destination and the print engine 77 positioned on the downstream side are in their running states (RUN) of the data processing (i.e., in the data processing) when such switches look up management contents in the status managing portion 150, these switches do not connect the transfer route and maintain their standby state. Then, these switches connect the transfer route at a point of time when such switches get the information to the effect that their running states (RUN) of the data processing are ended.

In other words, in the present embodiment, it is set as a rule that the reception and the transfer of subsequent data are not allowed until preceding data is completely processes and ended by the print engine 77. Therefore, when the stream pipe 149 accepts the transfer request of the XHTML data, not only the text-data raster processing portion 75 as the transfer destination but also the print engine 77 is checked as the decision object. As a rule, the connection of the switch SW11 is allowed to secure the transfer route of the subsequent data inasmuch as the status managing portion 150 can get the information to the effect that the print engine 77 has finished all processes of the preceding data. When the stream pipe 149 accepts similarly the transfer request of the JPEG data, not only the image-data raster processing portion 76 as the transfer destination but also the print engine 77 is checked as the decision object. As a rule, the connection of the switch SW12 is allowed to secure the transfer route of the subsequent data inasmuch as the status managing portion 150 can get the information to the effect that the print engine 77 has finished all processes of the preceding data. In this event, an exception handing of allowing the connection of the switch SW11 or SW12 exceptionally even though the print engine 77 is executing the process is prepared. This exception handling will be described later.

Also, a module shown by a switch SW21 in FIG. 16 is prepared. The switch SW21 performs the selection (connection) of the transfer route upon transferring the raster data obtained as the result of processing in respective raster processing portions 75, 76 or received from the external device to the print engine 77. The switch SW21 is started cooperatively when either one of two switches SW11, SW12 in the stream pipe 149 is connected. The switch SW21 executes a switching process (connection process) to secure the transfer route such that the data whose transfer route to the raster processing portion 75 or 76 can be secured by the connection of the switch SW11 or SW12 can be further transferred to the print engine 77. Also, the switch SW21 is constructed to decide a validity of the transfer route connection and execute the connecting processing based on the management contents in the status managing portion 150 when such switch SW21 accepts the transfer request of the raster data from the parallel communication portion 45b or a HCRP 156.

The above exception handling executed by the stream pipe 149 is carried out as follows with regard to the connection state of the switch SW21. In this case, explanation will be made hereunder separately of the case where the stream pipe 149 accepts the transfer request of the JPEG data and the case where the stream pipe 149 accepts the transfer request of the XHTML data. First, the stream pipe 149, when accepts the transfer request of the JPEG data, decides whether or not the second-stage switch SW21 positioned on the downstream side is connected to transfer the raster data from the image-data raster processing portion 76, i.e., whether or not the transfer route from the image-data raster processing portion 76 to the print engine 77 is connected. Then, when the switch SW21 is connected in such a state that the switch can transfer the raster data from the image-data raster processing portion 76, the stream pipe 149 permits the switch SW12 exceptionally to connect the transfer route for the subsequent data if only the image-data raster processing portion 76 has ended the data processing (e.g., in the ready state (Ready)) even though the print engine 77 is in the running state (RUN).

Then, the stream pipe 149, when accepts the transfer request of the XHTML data, decides whether or not the second-stage switch SW21 positioned on the downstream side is connected to transfer the raster data from the text-data raster processing portion 75, i.e., whether or not the transfer route from the text-data raster processing portion 75 to the print engine 77 is connected. Then, when the switch SW21 is connected in such a state that the switch can transfer the raster data from the text-data raster processing portion 75, the stream pipe 149 permits the switch SW11 exceptionally to connect the transfer route for the subsequent data if only the text-data raster processing portion 75 has ended the data processing (e.g., in the ready state (Ready)) even though the print engine 77 is in the running state (RUN).

In this manner, when the stream pipe 149 accepts the transfer request of the XHTML data from any one of the IrDA profile processing portion 74, the BPP 128, the HCRP 156, and an OPP (Object Push Profile) 157, such stream pipe 149 connects the transfer route by the switch SW11 unless respective management contents of the text-data raster processing portion 75 and the print engine 77 are now in the data processing in the status managing portion 150. Also, the stream pipe 149 accepts the transfer request of the JPEG data from any one of the IrDA profile processing portion 74, the BPP 129, and the OPP 157, such stream pipe 149 connects the transfer route by the switch SW12 unless respective management contents of the image-data raster processing portion 76 and the print engine 77 are now in the data processing in the status managing portion 150. At this time, when the stream pipe 149 looks up the connection state of the switch W21 in the status managing portion 150 and then decides that the switch SW21 is connected in such a state that the switch can transfer the raster data from the raster processing portion 75 or 76, such stream pipe 149 permits the switch SW12 exceptionally to connect the transfer route for the subsequent data if only the process in the raster processing portion 75 or 76 has been ended even though the print engine 77 is in the running state.

Here, the “transfer request” is the command that is used to secure the transfer route at the time of receiving the data. In contrast, in order to decide whether or not the stream pipe 149 is in such a state that the stream pipe can periodically receive the data from the communication portion 45e, the “request command” that is used to inquire of the stream pipe 149 whether the stream pipe is in such a state that it can secure the transfer route of the data from the communication portion 45e or not is prepared separately. When the transfer route of the receiving data cannot be secured, this “request command” is used in the interlocking process, described later, which is executed on the printer 1 side to make the CF-type communication card 13 side unready for receiving the data.

The transfer route of the data received by respective communication portions 45b to 45e in the communication interface (I/F) 45 is decided uniquely according to the type (vCard, vnote, XHTML, JPEG, or the like). For example, when the data are received in the IrDA communication, the transfer route passing through respective processing portions 74, 75 and the print engine 77 sequentially is selected for the vCard data, and the transfer route passing through respective processing portions 74, 76 and the print engine 77 sequentially is selected for the vNote data. Also, when the data are received in the Bluetooth communication, the transfer route passing through the BPP 128, the raster processing portion 75 and the print engine 77 sequentially is selected for the XHTML data, and the transfer route passing through the BIP 129, the raster processing portion 76 and the print engine 77 sequentially is selected for the JPEG data.

First, a securing process of securing the data transfer route will be explained hereunder.

In order to proceed smoothly the processing of the data received via the communication portions 45b to 45e without hindrance of other data, the stream pipe 149 secures (reserves) previously the transfer route reaching the printing operation at the time of starting the data reception.

In FIG. 16, this security of the transfer route is represented as connections of the switches SW11, SW12, SW21 that select the route to the raster processing portions 75, 76 and the print engine 77, which are shared with plural types of data. Here, the switches SW11, SW12, SW21 are modules implemented when the CPU 41 executes the program prepared to secure the transfer route. The communication interface portion 45a informs the CPU 41 of that effect when the portion 45a receives the data at any one of respective communication portions 45b to 45e, and then opens a port of that reception from the CPU 41 as the response. Then, any one of the IrDA profile processing portion 74, the BIP 129, the BPP 128, and the HCRP 156, which are the upper layer processing portions of that communication portion, analyzes the data received from that communication portion to identify the type of data (data type) based on the extension, for example, and then informs the stream pipe 149 of the identified data type. The stream pipe 149 secures the transfer route that is suited for the informed data type. The rule for securing the transfer route can be explained as the switching of the switches SW11, SW12, SW21. Here, the switches SW11, SW12, SW21 are connected at the time of starting the data reception to secure the transfer route of that data, and such connection is never disconnected in principle until the printing of the data is ended. As a result, when one transfer route is occupied by the particular data, such occupation of the transfer route is continued until the printing of the data is ended. Thus, if the stream pipe 149 receives other data, the receiving error is issued in principle. In this case, the switches SW11, SW12, SW21 are connected only when the transfer route must be secured, and are disconnected when the transfer route must not be secured. As a result, when both the switches SW11, SW12 are in their cut state, it is possible to decide that the stream pipe 149 can receive the data from the communication portion.

The interlocking process is such a process that does not allow the data reception when it is decided that the transfer route of the subsequent data cannot be secured because the transfer route is occupied by the precedingly received data, and allows the data reception when it is decided that the transfer route of the subsequent data can be secured. This interlocking process is a process of deciding whether or not the printer 1 can receive the data from the cellular phone 14 without error. The IrDA profile processing portion 74 executes periodically this interlocking process. As the result of the interlocking process, when the IrDA profile processing portion 74 decides that the printer cannot receive the data, such portion does not output the Ready command to the CF-type communication card 13 via the UART driver 72. When the IrDA profile processing portion 74 decides that the printer can receive the data, such portion outputs the Ready command to the CF-type communication card 13 via the UART driver 72.

Then, the CF-type communication card 13, when receives the Ready command, goes to the “ready for receiving” state by releasing the interlock state, and informs of the “ready for receiving” effect by displaying “green ON” on the displaying portion 13b. Also, since the input of the Ready command from the IrDA profile processing portion 74 is disconnected at the same time when the transfer of the received data is almost ended after the reception of the data from the cellular phone 14 in the “ready for receiving” state is completed, the CF-type communication card 13 goes to the interlock state and informs of the “unready for receiving” effect by turning OFF the displaying portion 13b. Therefore, since the displaying portion 13b is turned OFF until the printing of the preceding data is ended, for example, the user can understand that he or she cannot transmit the data from the cellular phone 14 and then refrains from transmitting the data. Thus, such a frequency can be reduced that, although the data are transmitted, the receiving error is indicated. In the CF-type communication card 13, the 159 executes the control of transition and release of the interlock state.

Here, following rules are applied to select the transfer route.

(1) Only the CPU 41 (stream pipe 149) secures the transfer route in response to the requested data type. When any one port of the communication portions 45b to 45e is opened, any one of the processing portion 74, the BPP 128, the BIP 129, the HCRP 156, and the OPP 157 as the upper layer identifies the data type based on the extension of the received file, and then demands the transmission of the data to the raster processing portions 75, 76 and the print engine 77 of the stream pipe 149 to apply the necessary process to the data whose data type is identified. The stream pipe 149 secures the transfer route of the data received from the port to transfer the data of the data type whose transmission is demanded from the processing portion as the demandant to the upper layer processing portion. In FIG. 16, the route is selected by the switches SW11, SW12, SW21 every processing step.

(2) Once the CPU 41 secured the transfer route, such CPU 41 occupies the route in principle until the printing of the data is ended. In this case, the connection and the disconnection of the route are executed stepwise. More particularly, when the transfer route is connected, the CPU 41 connects stepwise the transfer route from the upstream side (communication portion side) to the downstream side (print engine side) as the data are transferred. First, the switch SW11 or SW12 at the first stage is connected, and then the switch SW21 at the second stage is connected. In contrast, when the transfer route is disconnected, the switch SW21 at the second stage is not disconnected until the printing by the print engine 77 is ended. The connection of the switch SW11 or SW12 at the first stage is released after the connection of the switch SW21 at the second stage is released.

(3) The switching of the switch SW11 or SW12 at the first stage is accepted under the condition that the process in the processing portion (next processing portion) positioned directly on the downstream side of the switch is ended and the transfer route of the subsequent data can be secured while maintaining the connection of the switch SW21 at the second stage. That is, even though the printing of the preceding data is not ended, the transfer route of the subsequent data can be assured to allow the data reception as far as the above conditions can be satisfied.

Then, the interlocking process is carried out in compliance with following rules.

The decision portion 88 in the IrDA profile processing portion 74 executes periodically the interlocking process at a predetermined time interval (e.g., several tens msec). The decision portion 88 decides whether or not the transfer route is extended up to the upper layer raster processing portion 75 or 76 at the first stage, i.e., to which raster processing portion either one of the switches SW11 and SW12 is connected. In case both the switches SW11 and SW12 are not connected (i.e., both are cut off), the decision portion 88 decides that the interlock should be released. In contrast, in case one of the switches SW11 and SW12 is connected, the decision portion 88 asks both raster processing portions 75, 76 whether they are now in the raster processing. Then, when both the raster processing portions 75, 76 are not in the raster processing as the result of response, the decision portion 88 decides that the interlock should be released. In remaining cases, the decision portion 88 decides that the interlock should be continued. In more detail, the decision portion 88 issues the request command to the stream pipe l49 to get a decision processing portion 74 can be connected therein as a response. When the decision portion 88 accepts the response to the effect that the stream pipe 149 is ready for connecting the transfer route from the stream pipe 149, the IrDA profile processing portion 74 instructs the UART driver 72 to output the Ready command. In contrast, when the decision portion 88 accepts the response to the effect that the stream pipe 149 is unready for connecting the transfer route from the stream pipe l49, the IrDA profile processing portion 74 instructs the UART driver 72 not to output the Ready command. The decision portion 88 sends such decision result to the UART driver 72 via the data transferring portion 73. The UART driver 72 does not output the Ready command when it accepts the notification of the interlock (Ready command stop instruction) from the IrDA profile processing portion 74 (decision portion 88), while the UART driver 72 outputs the Ready command when it accepts the notification of the interlock release (Ready command output instruction).

In this case, since the interlocking process is executed in compliance with above rules, the stream pipe 149 does not monitor the receiving situation of the raster data that are received from the host computer HC, for example, which is out of the monitoring objects of the stream pipe 149, via the communication portion 45b. Therefore, for example, even if the print engine 77 has already received the raster data from the host computer HC and is now in the data processing state, in some cases the interlock is released because such situation is out of the monitoring objects of the stream pipe 149. In this case, even when the user transmits the data from the cellular phone 14 because the “green ON” is displayed on the displaying portion 13b, the printer 1 side exhibits the receiving error. As a result, although it is impossible to say that the above interlocking process is sufficient for an interlocking function, the receiving error can be reduced considerably.

For example, even when both the switches SW11, SW12 at the first stage as the decision object of the decision portion 88 are cut off at a timing after the printing process of the preceding data is ended, in some cases the data received via the communication portion 45b have already occupy the transfer route at this point of time by switching the switch SW21 at the second stage. In this case, the interlock can be released, but the transfer route cannot be secured. Also, if one of the switches SW11, SW12 at the first stage as the decision object of the decision portion 88 is connected, the switch SW21 at the second stage is also connected to the side that can secure the same route, so that the transfer route to the print engine 77 ought to be secured in most cases. However, in the case where the printing process of the print engine 77 has also already ended even after one of the switches SW11, SW12 at the first stage is connected and the raster process in the raster processing portions 75, 76 is ended, in some cases other data has already switched in advance the connection of the switch SW21 at the second stage at that point of time. At this time, the interlock can be released but the transfer route cannot be assured. In these cases, the interlock is released and the “green ON” is displayed on the displaying portion 13b, nevertheless the receiving error is generated when the user transmits the data. This is caused due to the fact that, because the configuration to add the IrDA communication function by making a change in the hardware (circuits) and the software, which are provided originally to the printer 1, to the lowest degree is employed, the interlocking function is constructed by using the existing function to this purpose. Of course, the configuration to realize the interlocking function that can cover all communication systems as the monitoring object without exception may be employed. Inversely the interlocking process may be simplified much more, for example, the interlocking process in which the decision portion 88 decides simply whether or not one of the switches SW11 and SW12 is on the connection side may be employed.

According to the rule of securing the transfer route in the present embodiment, in the case where the transfer route of the subsequent data can be assured only by switching the switches SW11, SW12 at the first stage while maintaining the connection of the switch SW21 at the second stage to secure the transfer route of the preceding data, the subsequent data can be received even before the printing of the preceding data is ended. For instance, suppose that the raster process of the vNote data received previously in the image-data raster processing portion 76 is ended and then all the raster data are stored in the buffer 76a, the interlock is released at that time. When the communication portion 45c receives the JPEG data after the displaying portion 13b is turned ON in green color owing to the release of the interlock, one of the switches SW11, SW12 at the first stage is connected and the raster process is ended at that time and in addition the conditions under which the transfer route of the subsequent data can be secured while maintaining the connection of the switch SW21 at the second stage are satisfied. Therefore, the stream pipe 149 permits the communication portion 45c to receive the JPEG data. In other words, the transfer route of the JPEG data can be secured. As a result, the reception and the processing of the next JPEG data are enabled at the stage that the preceding vNote data are merely buffered in the buffer 76a after the raster process but before the end of the printing. In this manner, combinations of the data types that make it possible to receive and transfer the subsequent data prior to the end of the printing process of the preceding data are not limited to above example. For instance, when first the vcard data are received and then the XHTML data are received, or when both data are received in reverse order, the above situation may be similarly applied. Also, if only the conditions are satisfied, a plurality of subsequent data can be received sequentially before the printing of the preceding data is ended. At this time, the number of the receivable subsequent data depends upon a memory capacity of respective buffers 75a, 76a corresponding to the raster processing portions 75, 76, and thus a plurality of data can be received as far as these data can be buffered within the memory capacity.

Normally it is of course that, when the user wants to print a plurality of data, he or she tries to transmit successively these data. Since a buffer capacity of the print engine 77 in the printer 1 is limited, only the printing of one case can be accepted in principle and thus the CPU 41 does not allow the reception of the subsequent data until the printing of one case is ended. However, sometimes the reception of the subsequent data is allowed exceptionally before the printing of the preceding data is ended. Thus, contents of the interlocking process (i.e., contents set in the stream pipe 149) are set to suit the conditions applied to the case where the reception is allowed exceptionally.

The interlock is not caused to release in the conditions the reception is not allowed without fail, while The interlock is caused to release in the conditions it is possible to allow the reception. Therefore, in the case where, although it is possible that the receiving error is caused even when the “green ON” is displayed on the displaying portion 13b, the reception is allowed prior to the end of the printing of the preceding data, the “green ON” is displayed on the displaying portion 13b. Thus, a chance of reception can be increased as much as possible by avoiding the situation that the displaying portion 13b is turned OFF even in the data receivable condition. When the user understands by the “green ON” of the displaying portion 13b that the printer 1 can receive the data, he or she transmits the subsequent data. At this time, as the combination of the preceding data and the subsequent data the reception of which is allowed even before the printing of the preceding data is ended, there are six types of combination in total, i.e., three combinations derived by selecting two types out of vNote and JPEG formats in combination and three combinations derived by selecting two types out of vCard and XHTML formats in combination.

Normally the user can know that the user can transmit the subsequent data when the printer 1 ends the printing. Also, the user can know by the “green ON” of the displaying portion 13b that the user can transmit the subsequent data even when the data can be received for reasons of the internal process. Therefore, because of the information of the displaying portion 13b, such a situation can be avoided that the user waits the end of the printing operation although the printer has already been in the data receivable condition.

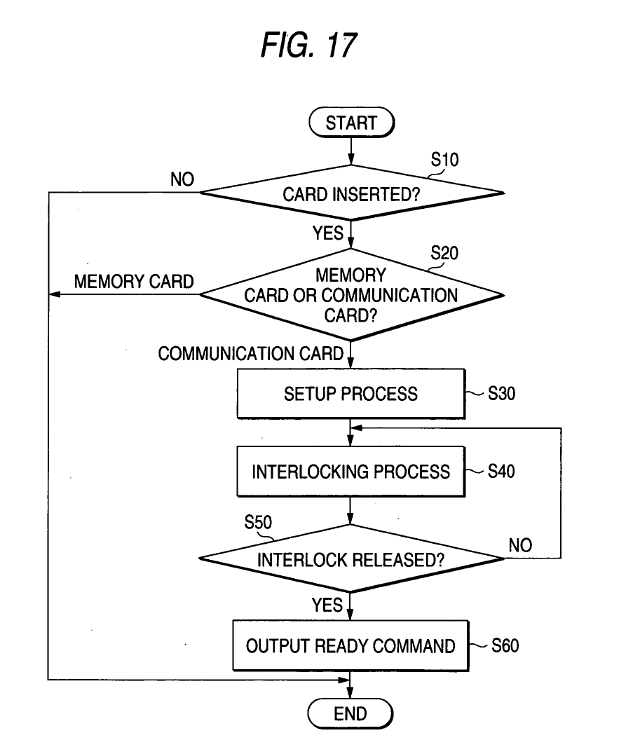

FIG. 17 is a flowchart showing a program that the CPU 41 on the printer 1 side executes when the CF-type communication card is inserted (set) into the card slot. The processing contents that the CPU 41 executed when it detects the CF-type communication card 13 will be explained hereunder.

First, In Step (referred simply to as “S” hereinafter) 10, it is decided whether or not the CF-type communication card 13 is inserted into the card slot 12 (i.e., whether or not the CF-type communication card 13 is detected). If YES, the process goes to S20. In contrast, if NO, the process is ended as it is.

In S20, it is decided whether the card an insertion of which is detected is the CF-type communication card 13 or the memory card MC. If such card is the CF-type communication card 13, the process goes to S30. If such card is the memory card, the CPU 41 recognizes the fact that the detected card is the memory card and then the process is ended.

In S30, a setup process of the CF-type communication card 13 is executed. More particularly, the CPU 41 instructs the card driver 71 to read the extension data (reference data) from the setup data storing portion 71a and then transmit the data to the object transmitting/receiving portion 64. As a result, the card driver 71 transmits the extension data to the object transmitting/receiving portion 64, and then the object transmitting/receiving portion 64 stores the extension data in the applicable extension storing portion 64a when accepted the data.

Then, in S40, the interlocking process is executed. That is, the process explained previously with reference to FIG. 16 is executed.

In S50, it is decided whether or not the interlock should be released. If YES, the process goes to S60. If NO, the process goes back to S40 again. When the process goes back to S40, the interlocking process is executed subsequently every predetermined time until the interlock can be released.

In S60, the Ready command is output to release the interlock. The card controlling portion 31 (CPU 159), when accepted the Ready command, sets the communication status A of the “ready for receiving”, and the displaying portion 13b of the CF-type communication card 13 displays the “green ON”. The user can grasp that the CF-type communication card 13 is ready for receiving the data, by looking at the “green ON” on the displaying portion 13b.

Unacceptable data reception inhibiting process in the CF-type Communication Card

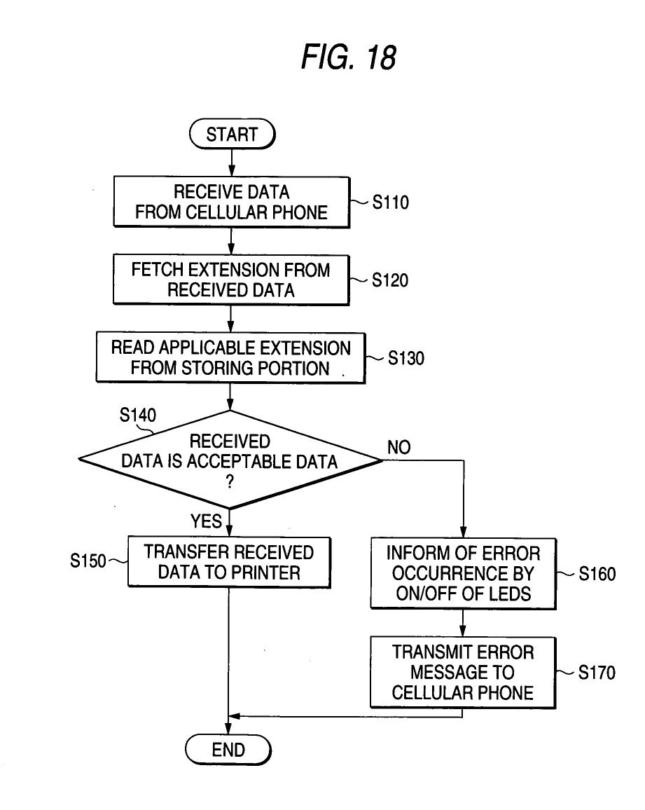

FIG. 18 is a flowchart showing a program for an unacceptable data reception inhibiting process. This function of the object transmitting/receiving portion 64 is realized when the CPU 159 in the card controlling portion 31 executes the program shown by this flowchart.

In S10, the CF-type communication card 13 receives the data from the cellular phone 14.

In S120, the extension is picked up from the received data. In other words, the extension is picked up from the file name in “Name” in the header HD of the received data DA (see FIG. 10).

In S130, an applicable extension (extension data) stored (set) in the storing portion 64a (shown in FIG. 6) is read out. The “applicable extension” signifies an extension attached to the data (acceptable data) that the printer 1 can handle to print.

In S140, it is decided whether or not the received data are the acceptable data. More particularly, the extension picked up from the received data in S120 is compared with the applicable extension read from the storing portion 64a in S130 to decide the data. In the present embodiment, the extension picked up from the received data is compared with “vcf” “vnt” “jpg” “jpeg” set as the applicable extension. Then, the received data are decided as the acceptable data if both extensions are consistent with each other, while the received data are decided as the unacceptable data if both extensions are inconsistent with each other. As a result of the decision, the process goes to S150 if the received data are the acceptable data (if the extension coincides with the applicable extension) whereas the process goes to S160 if the received data are as the unacceptable data (unless the extension coincides with the applicable extension).

In S150, the infrared communication card 13 transfers the received data to the printer 1. In S160, the infrared communication card 13 informs the user of the error occurrence by ON/OFF-controlling the LED 162 of the displaying portion 13b (shown in FIG. 12). That is, the displaying portion 13b is ON/OFF-ed in red color.

In S170, the infrared communication card 13 transmits an error message to the effect that the received data cannot be handled, to the cellular phone 14. As a result, the reception error message is displayed on the display 18 of the cellular phone 14.

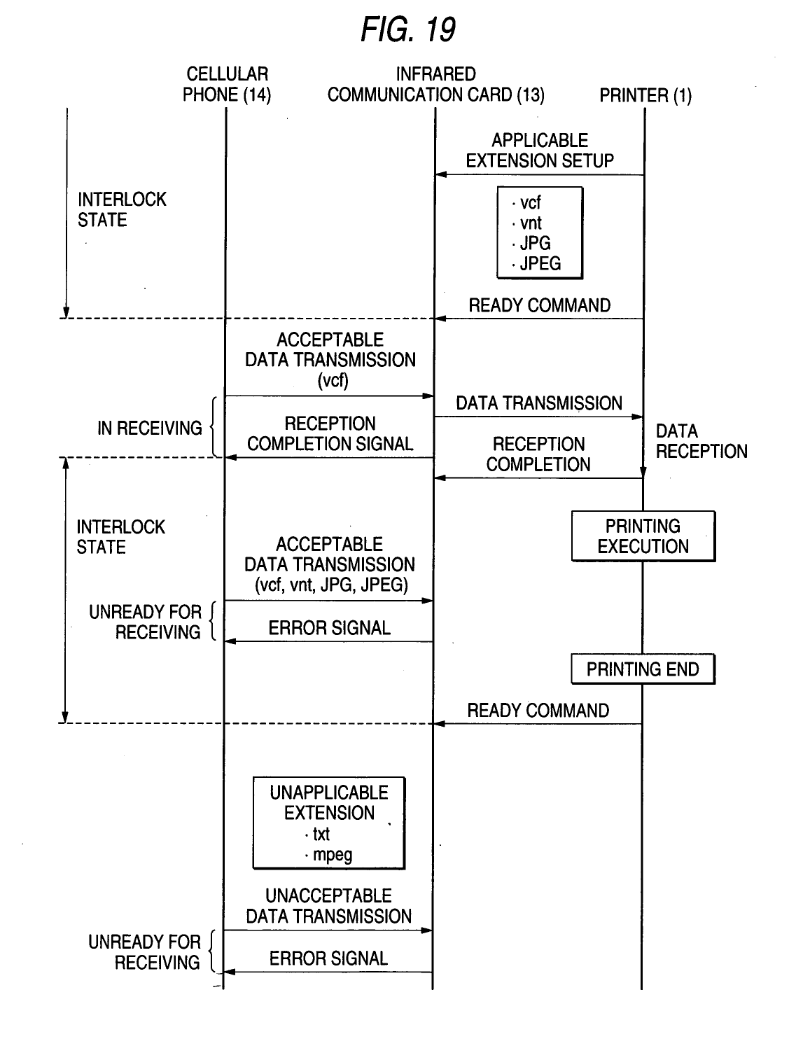

FIG. 19 to FIG. 23 shows an example of a sequence of the interlocking process respectively. Here, the unacceptable data reception inhibiting process in the CF-type communication card is also explained in FIG. 19 to FIG. 21. In this case, in the following explanation of the interlocking process, such an example is mentioned that the exception handling explained in FIG. 16, i.e., the exception handling by which reception of the subsequent data is permitted even before the print engine 77 finishes the process of the preceding data is not applied to the switch SW11 side that is started when the transfer request of the XHTM data is issued, but is applied only to the switch SW12 side that is started when the transfer request of the JPEG data is issued.

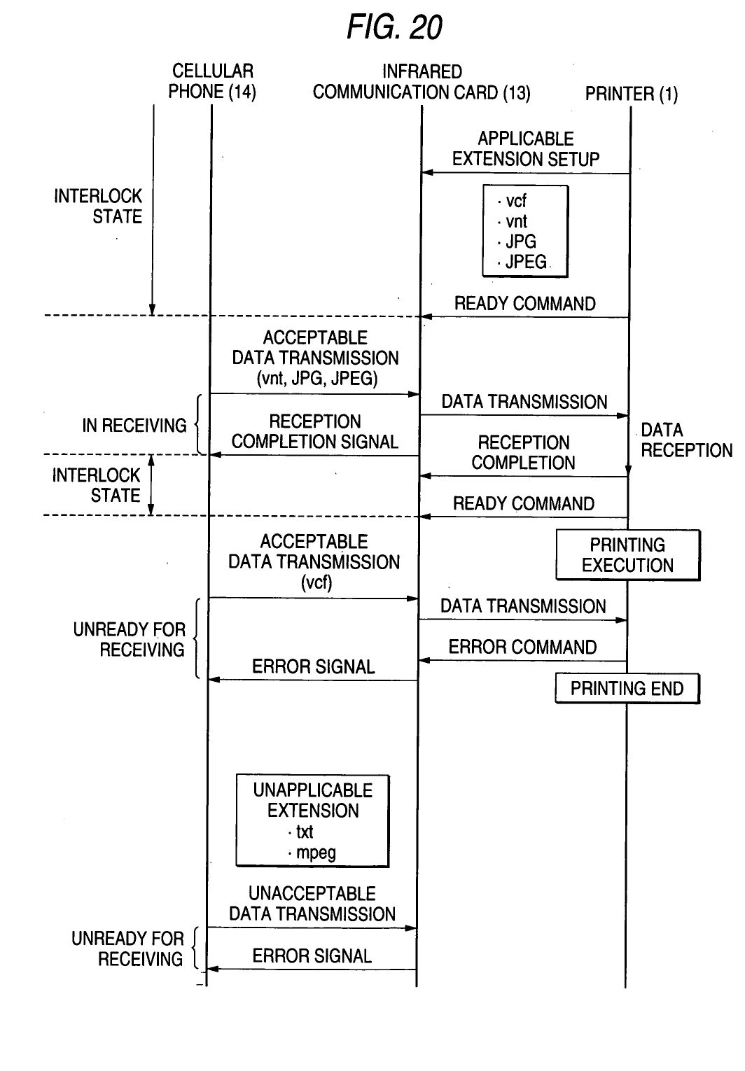

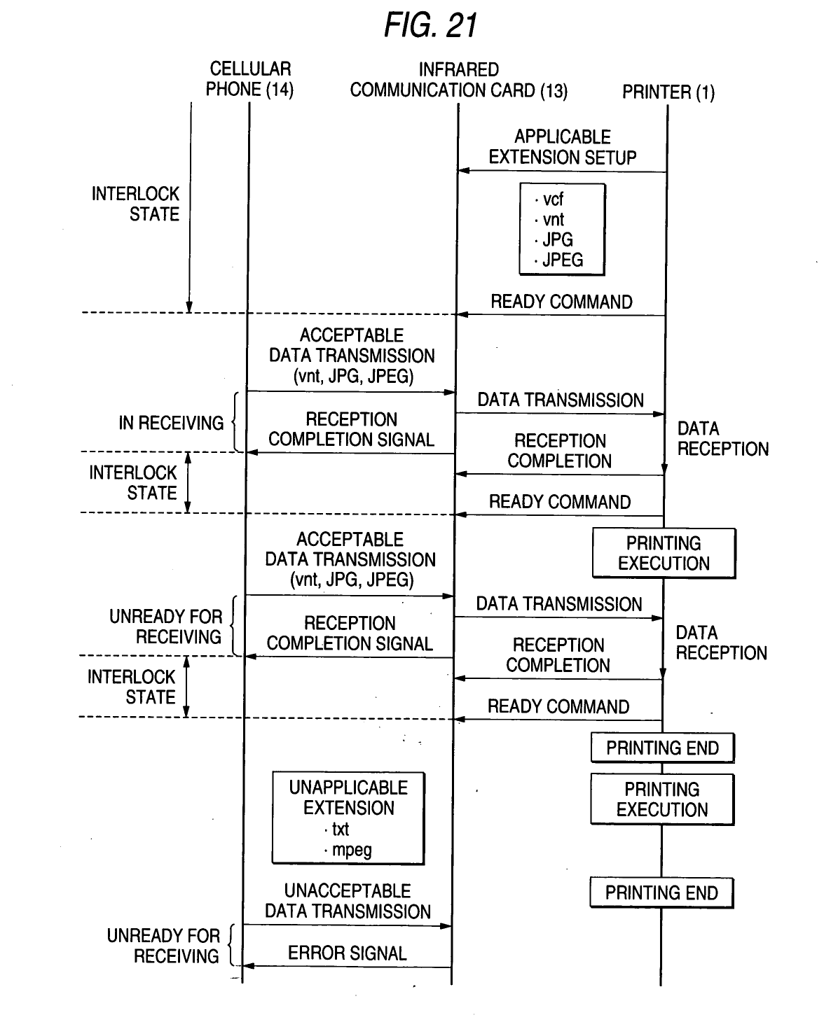

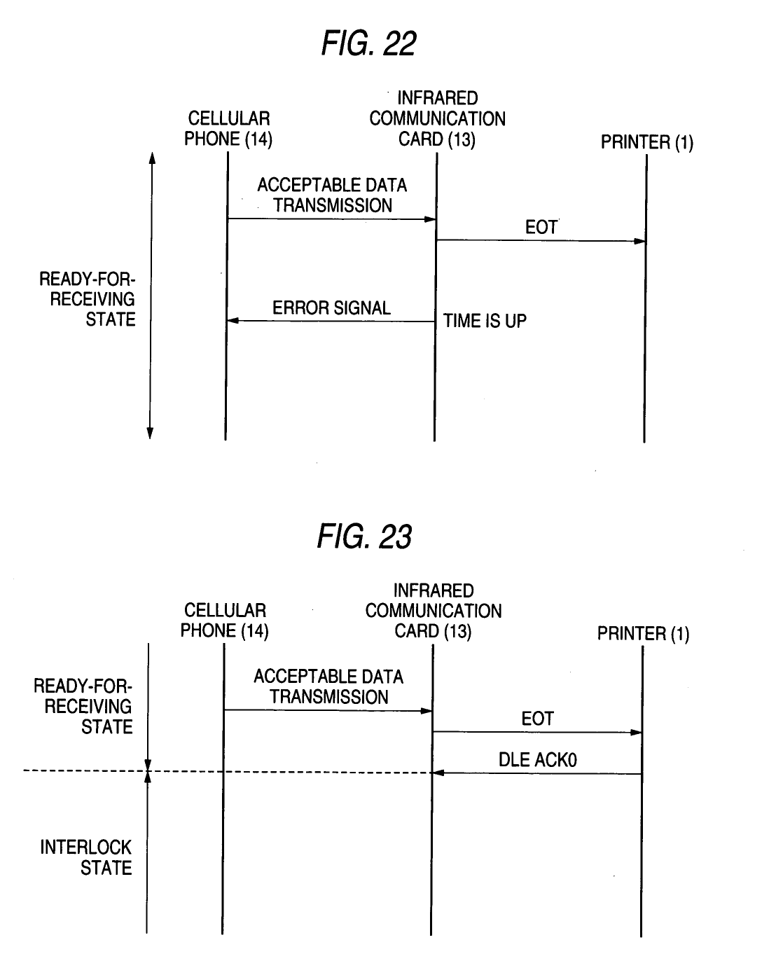

For this reason, an interlock releasing process of permitting the reception of the next data is different in the case where the data that the printer 1 receives earlier are the vCard data and the case where the data that the printer 1 receives earlier are the vNote data or the JPEG data. FIG. 19 shows an example in which the vCard data are transmitted earlier, and FIG. 20 and FIG. 21 show an example in which the vNote data or the JPEG data are transmitted earlier. FIG. 21 shows an example in which, even through the preceding data are now being printed, the transmitted data can be received if the next data are the vNote data or the JPEG data. FIG. 22 and FIG. 23 illustrate other interlocking process respectively.

First, the interlocking process applied when the vCard data are received earlier and the unacceptable data reception inhibiting process will be explained with reference to FIG. 19 hereunder.

When first the power supply of the printer 1 is turned ON, the applicable extension (extension data) “vcf” “vnt” “jpg” “jpeg” are set into the CF-type communication card (infrared communication card) 13 from the printer 1. Then, a process of deciding whether or not the reception of data from the CF-type communication card 13 should be allowed (referred to as an “interlock releasing process” hereinafter) is executed in the printer 1. If it is decided that the reception should be allowed (i.e., the interlock state can be released), the Ready command is output from the printer 1 to the CF-type communication card 13. The CF-type communication card 13, when receives the Ready command, releases the interlock state and then enters into its ready-for-receiving state. Since the interlock state is released, the displaying portion 13b that is tuned OFF until now is turned ON in green color.

Then, suppose that the cellular phone 14 transmits the vCard data with the extension “vcf” as the acceptable data. Then, the CF-type communication card 13 when received the data compares the extension “vcf” of the data with the setup extension data “vcf” “vnt” “jpg” “jpeg”. Because a consistent combination is present between both extensions, the CF-type communication card 13 receives the concerned data and the transfers such data to the printer 1. The displaying portion 13b is turned ON/OFF in green color during this data receiving operation. When the data reception is completed after several tens second to one minute elapsed, the displaying portion 13b is turned ON in orange color to inform the cellular phone 14 of the effect that the CF-type communication card 13 has completed the data reception (reception completion signal), and also the CF-type communication card 13 enters into its interlock state. In this example, since the communication between the cellular phone 14 and the CF-type communication card 13 and the communication between the CF-type communication card 13 and the printer 1 are carried out asynchronously, the printer 1 informs the CF-type communication card 13 of the effect that the printer 1 has completed the data reception, after a while. Then, the printing is executed in the printer 1.

In case the printer 1 received the vCard data, such printer outputs the Ready command after it completes the printing. Therefore, since the CF-type communication card 13 stays in the interlock state during when the printer 1 is in printing operation, an error signal is transmitted from the CF-type communication card 13 to the cellular phone 14 even when the acceptable data are transmitted from the cellular phone 14.

Then, when the Ready command is output from the printer 1 to the CF-type communication card 13 after the printing is ended, the interlock state of the CF-type communication card 13 is released. Then, in case the cellular phone 14 transmits the unacceptable data with the extension except “vcf” “vnt” “jpg” “jpeg”, the CF-type communication card 13 compares the extension of the received data with the extension data. For example, when the unacceptable data with the unapplicable extension such as “txt” “mpeg” or the like are transmitted, all combinations between both extensions are inconsistent as the result of comparison. Therefore, the unacceptable data are not received and are canceled in the CF-type communication card 13, and also the error signal is transmitted to the cellular phone 14. At this time, the displaying portion 13b flickers in red color. In this manner, the unacceptable data are abandoned in the CF-type communication card 13 and thus such unacceptable data are never transferred to the printer 1. As a result, since the communication port of the slot communication portion 45e used to transfer the data to the printer 1 is never occupied by the unacceptable data, such a situation can be avoided that the data reception at the communication port in other communication system is disturbed.

Then, the interlocking process applied when the vNote data or the JPEG data are received earlier and the unacceptable data reception inhibiting process will be explained with reference to FIG. 20 hereunder.

When the CF-type communication card (infrared communication card) 13 receives the Ready command from the printer 1 after the applicable extensions (extension data) of “vcf” “vnt” “jpg” “jpeg” are set in the CF-type communication card 13 from the printer 1, such CF-type communication card 13 releases the interlock state and enters Into the ready-for-receiving state. As a result, the displaying portion 13b that is tuned OFF until now is turned ON in green color.

Then, suppose that the cellular phone 14 transmits the vNote or JPEG data with the extension “vnt” “jpg” “jpeg” as the acceptable data. Then, the CF-type communication card 13 when received the data compares the extension “vnt” (or “jpg” “jpeg”) of the data with the setup extension data “vcf” “vnt” “jpg” “jpeg”. Because a consistent combination exists between both extensions, the CF-type communication card 13 receives the concerned data and the transfers such data to the printer 1.

The displaying portion 13b is turned ON/OFF in green color during this data receiving operation. When the data reception is completed after several tens second to one minute elapsed, the displaying portion 13b is turned ON in orange color to inform the cellular phone 14 of the effect that the CF-type communication card 13 has completed the data reception (reception completion signal), and also the CF-type communication card 13 enters into its interlock state. Then, the printer 1 informs after a while the CF-type communication card 13 of the effect that the printer 1 has completed the data reception. When the printer 1 receives the vNote or JPEG data having any of the extensions “vnt” “jpg” and “jpeg” after it informs of the effect that the data reception is completed, such printer 1 outputs the Ready command to the CF-type communication card 13 at a point of time when the raster process of the acceptable data is ended. In other words, the Ready command is output after the end of printing in the vCard data transmission explained in FIG. 19, while the Ready command is output at a point of time when the raster process is ended in the vNote or JPEG data transmission. Then, the printing is executed in the printer 1.

Therefore, the interlock state is released and the CF-type communication card 13 is in its communicable state when the printer 1 is in the printing execution. In this case, the data the reception of which is permitted during the printing are limited to the vNote or JPEG data. For example, when the vCard data are transmitted from the cellular phone 14, the CF-type communication card 13 compares the extension “vcf” of the received data with the extension data. As a result of comparison, because a coincident combination between both extensions exists, the vCard data are received and then transmitted to the printer 1. Then, if the printer 1 when received the vCard data recognizes the vCard data based on the extension “vcf”, such printer outputs the error signal to the CF-type communication card 13 because the received data are of the unacceptable data type.

In contrast, as shown in FIG. 21, when the printer 1 received the vNote or JPEG data having any one of the extensions “vnt” “jpg” “jpeg” in the middle of the printing, it accepts this data and forwards the process in response to the data type. The printer 1, when completed the reception of the vNote or JPEG data, transmits the effect that the reception has been completed to the CF-type communication card 13, and then outputs the Ready command to the CF-type communication card 13 after the raster process of the received data is ended. In this case, since the profile processing portion 74 for executing the interlocking process in the printer 1 can manage merely a part of communication portions that receive the data that are to be processed in the raster processing portions 75, 76, in some cases the printer 1 cannot accept such vNote or JPEG data when other data received via other communication portion are present.

When the communication is established between the CF-type communication card 13 and the printer 1, the CF-type communication card 13 enters automatically into its interlock state if the data reception is completed. In this case, when the CF-type communication card 13 fails to execute the connecting process between the CF-type communication card 13 and the printer 1, such card does not enters into its interlock state. An example of this type will be explained with reference to FIG. 22 hereunder.

As shown in FIG. 22, in the case where the acceptable data are transmitted from the cellular phone 14, the CF-type communication card 13 transmits a control code “EOT” indicating the end of transfer to the printer 1 as soon as such card finishes the transmission of the whole data to the printer 1. The CF-type communication card 13 opens the data link when it received the acknowledge “DLE ACKO” from the printer 1 in response to this “EOT”. As shown in FIG. 22, when the time is up in a situation that the CF-type communication card 13 does not yet receive the acknowledge “DLE ACKO” from the printer 1 in response to the “EOT”, such card 13 transmits the error signal to the cellular phone 14. In this manner, the CF-type communication card 13 does not go to the interlock state and keeps its communicable state only when the data link is not opened correctly since the time is up. Therefore, the CF-type communication card 13, when failed in receiving the data because the time is up, can receive the data if the cellular phone 14 transmits subsequently the data once again.

In contrast, as shown in FIG. 23, when the CF-type communication card 13 received the acknowledge “DLE ACKO” from the printer 1 in response to the control code “EOT” indicating the end of transfer, such card goes to its interlock state after the communication is ended (the data link is ended).

Contention Avoiding Process between IrDA and Bluetooth Communications

Next, a contention avoiding process of avoiding the communication contention between the infrared communication system using the CF-type communication card 13 and other communication system will be explained hereunder.

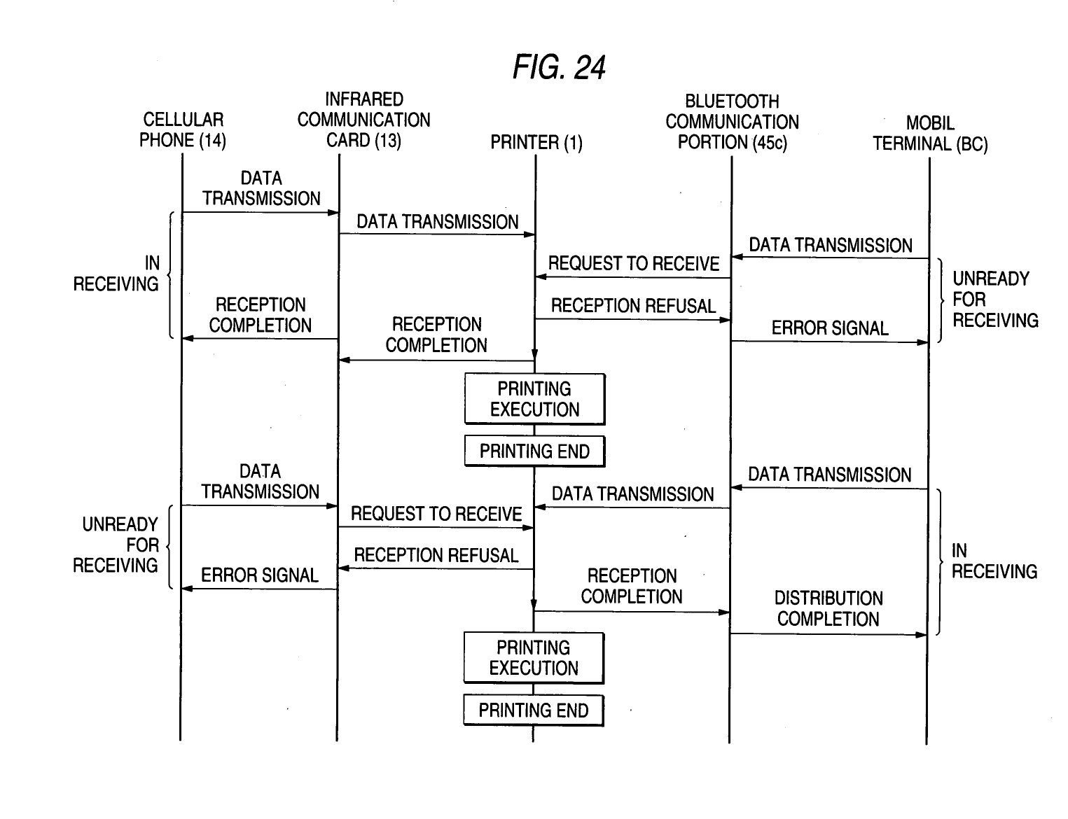

FIG. 24 is a sequence diagram showing an example of a contention avoiding process between the infrared communication and other communication. In FIG. 24, there is shown an example in which a contention between the data reception by the infrared communication and the Bluetooth communication should be avoided, but the same explanation can be applied basically to the case where the contention the infrared communication and other communication system should be avoided.

Meanwhile, the card slot 12 has an opening shape into which any memory card having other type (e.g., SD™ type), which has different size and shape from the CF-type memory card, can be inserted simultaneously. Therefore, the memory card of the type other than the CF type can be inserted simultaneously into the card slot 12 in a situation that the CF-type communication card 13 is set in the card slot 12. In this case, the data reception of the CF-type communication card 13 is made available even though the memory card is set in the card slot. That is, when the CPU 41 detects both the CF-type communication card 13 and the memory card, such CPU makes the data reception from the CF-type communication card 13 effective. However, the CPU 41 makes the data reception from the CF-type communication card 13 ineffective while printer 1 reads the data from the memory card. The basic process is similar in this respect when the contention of the data reception is caused between the card slot in the infrared communication system and the communication portion in other communication system.

As an example of the contention avoiding process between the infrared communication system and other communication system, a process of avoiding the contention of the data reception between the infrared communication system and the Bluetooth communication system will be explained hereunder.

In FIG. 24, suppose that first the data are transmitted from the cellular phone 14 to the infrared communication card (CF-type communication card) 13. Then, the CF-type communication card 13 transfers the received data to the printer 1. The printer 1 receives the data within a predetermined necessary time (e.g., about several tens second to one minute), and then informs the CF-type communication card 13 of the completion of the reception when the data reception is completed. Then, the CF-type communication card 13 informs the cellular phone 14 of the completion of the reception. The effect that the data reception has been completed is displayed on the cellular phone 14, and thus the user can check that the data have been transmitted to the printer 1.

The printer 1 converts the data received from the cellular phone 14 into the printing data and then executes the printing. The printing is started after all the received data are converted into the printing data, and then the printing is ended after all the received data are printed.

Meanwhile, the data are transmitted from the mobile terminal BC, which is illustrated on the right side and has the Bluetooth (abbreviated as “BT” hereinafter) communication function, to the BT communication portion 45c after the cellular phone 14. In this case, the IrDA communication port on the printer 1 side is opened, but the BT communication portion 45c, the USB communication portion 45d, and the parallel communication portion 45b are brought into a busy state not to accept the data. At this time, the notice of reception refusal is transmitted from the BT communication portion 45c to the mobile terminal BC. The effect of reception refusal is displayed on the mobile terminal BC, and thus the user can check the failure of the data transmission.

After the printing of the data received from the cellular phone 14 is ended, the data are transmitted once again from the mobile terminal BC to the BT communication portion 45c. Then, the communication interface portion 45a in the printer 1 opens the port of the BT communication portion 45c and sets remaining communication ports to the busy state. As a result, even though the data are transmitted from the cellular phone 14 to the printer 1, which is now receiving the data from the mobile terminal BC, in the infrared communication, the cellular phone 14 is informed of the effect of reception refusal. The data received from the mobile terminal BC are processed in the printer 1 and then the contents of the data are printed.

In this case, even when the contention between the data reception via the parallel communication portion 45b, the USB communication portion 45d, and the serial communication portion (not shown) in other communication system and the data reading from the memory card via the slot communication portion 45e is caused, the data are processed basically in the similar sequence.

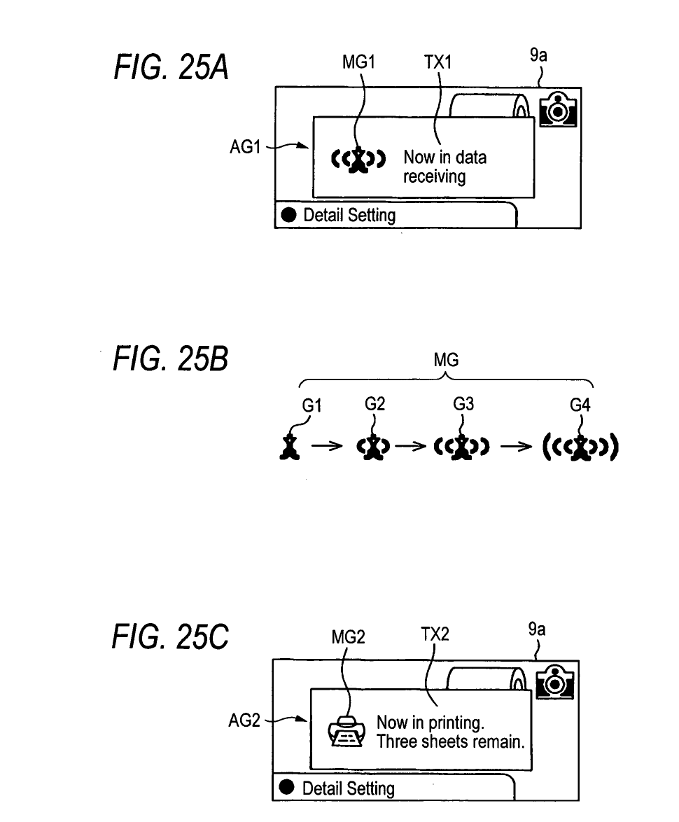

FIG. 25A shows an informing image that displays the communication state on the screen 9a of the operation panel 8 in the printer 1. Also, FIG. 25B shows an image consisting of four frames constituting a moving picture. The data reception condition is displayed not only on the displaying portion 13b of the CF-type communication card 13 but also on the screen of the operation panel 8.

The CPU 41 manages the communication status, and such communication status is displayed on the screen 9a of the operation panel 8. Five types of communication statuses, i.e., “unready for receiving”, “ready for receiving”, “in reception”, “reception end”, and “reception error”, are informed by the lightening control of the displaying portion 13b, while the reception error can be informed distinguishably so far as the (error cause associated) error content on the screen 9a, on which the characters can be displayed, in addition to these character string displays.

As shown on the screen 9a in FIG. 25A, a moving picture image MG1 and a text TX1 indicating the effect of “now in data receiving” are displayed when the printer is now receiving the data. These data of the moving picture image MG1 and the text TX1 are stored in the EEPROM 43. As the text TX1, for example, “Now in data receiving.” is displayed.

As shown in FIG. 25B, the moving picture image MG consists of four-frame images G1 to G4. The CPU 41 produces the moving picture image MG by displaying these images G1 to G4 sequentially at a predetermined time interval.

The CPU 41 can detect the data reception at a point of time when the data arrive at the IrDA profile processing portion 74. The CPU 41, when detects the data reception, informs the user of the data receiving state by displaying the moving picture image MG1 and the text TX1 in FIG. 25A on the screen 9a. The user can check the data receiving state by either the displaying portion 13b of the CF-type communication card 13 or the screen 9a of the printer 1.

Also, when the communication status is the reception error, the error signal to identify so far as the type of error such as “the data with this extension cannot be handled”, “the extension does not coincide with the data”, “the communication is disconnected”, or the like, for example, can be informed instead of “Now in data receiving.” on the screen 9a shown in FIG. 25C.

Also, the information of the communication status may be transferred to the CPU 41 on the printer 1 side from the CPU 159 on the CF-type communication card 13 side, and thus the informing image may be displayed on the screen 9a in answer to the communication state. Of course, the CPU 41 may manage the communication status and may display the moving picture image MG and the text TX on the screen 9a to inform. In this case, the moving picture image MG1 and the text TX1 indicating the data receiving state are displayed.

Also, the CPU 41, when starts the execution of printing, displays an informing image AG2 shown on the screen 9a in FIG. 25C. As the informing image AG2, a moving picture image MG2 and a text TX2 are displayed.

Data Processing on the Printer Side

Next, processing of the data that are transferred from the CF-type communication card 13 to the main body 2 side of the printer 1 will be explained hereunder. As the processes on the printer side, there are mainly (A) a process of classifying the data in response to the type, (B) a process of deciding whether or not the personal information data are the single case or all cases, (C) a process of dividing/sending the data in all cases of the personal information, (D) a process of printing the personal information data in a name card layout, and (E) a process of printing the personal information data in a phone book layout.

First, a process of converting the received data into the file format that the processing circuits in ASIC, etc. can handle and then generating the data with a pointed layout will be explained hereunder. At first, a data structure of the vCard file will be explained hereunder.

vCard Data in Single Case

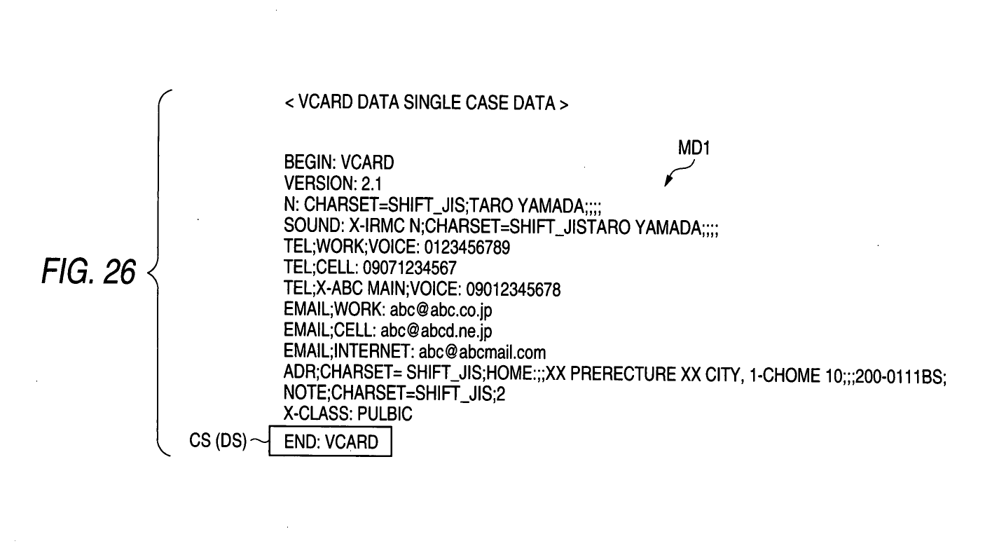

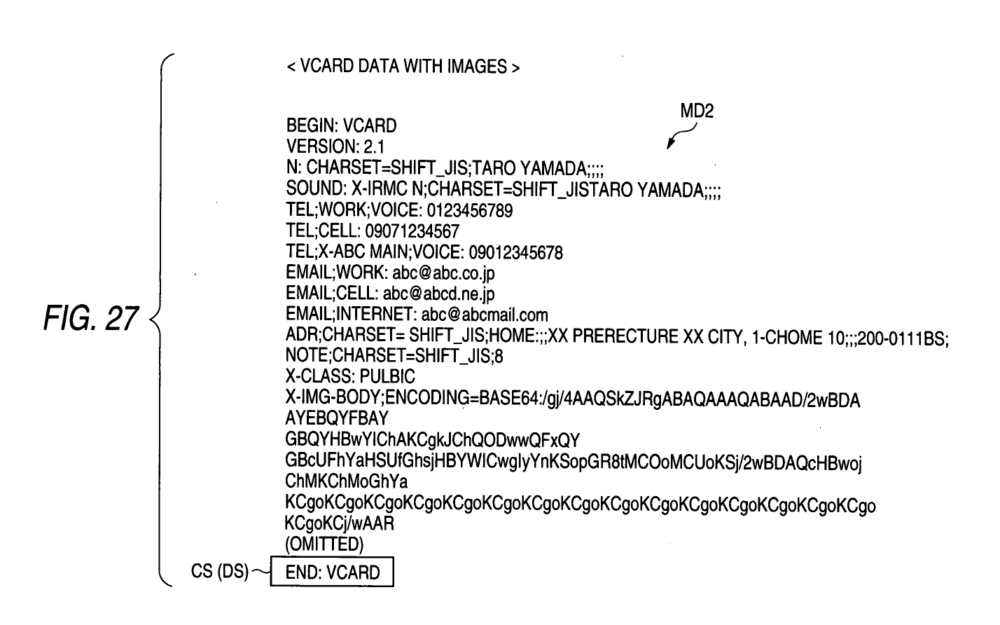

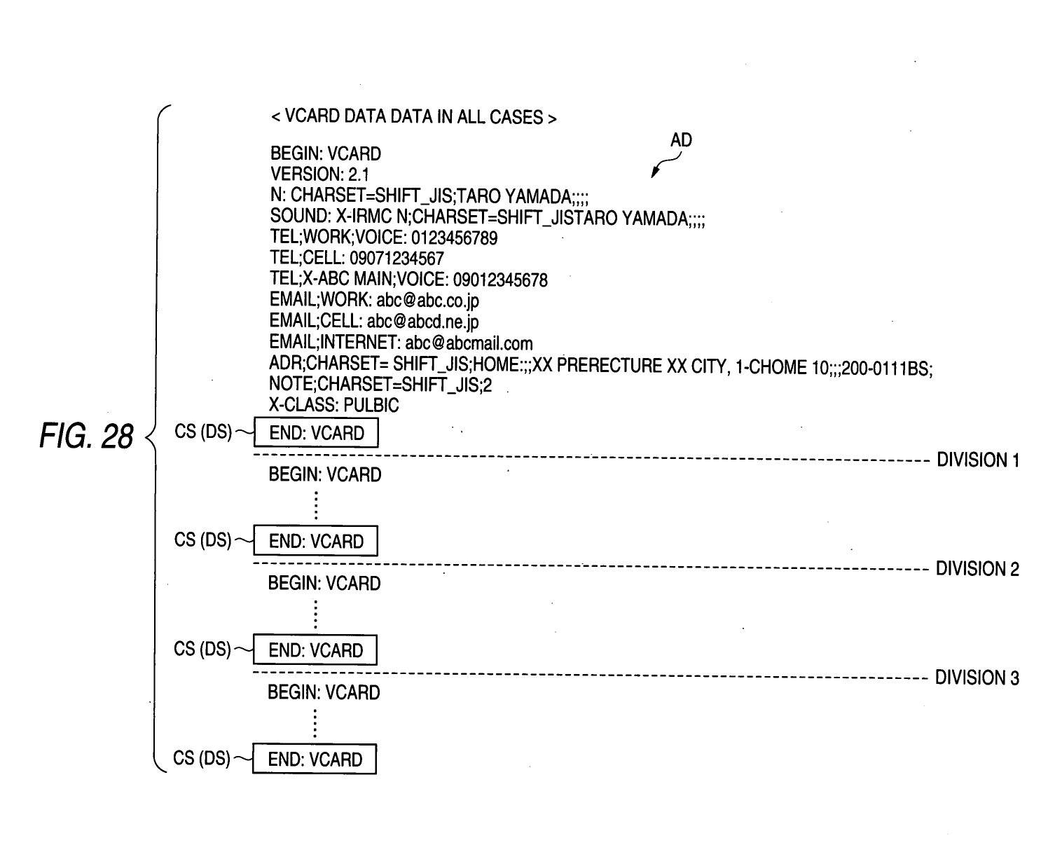

FIG. 26, FIG. 27 and FIG. 28 show an example of the personal information data in the vCard file format respectively. Where FIG. 26 and FIG. 27 show the vCard data in the single case respectively, and FIG. 26 shows the data of the personal information (text) only and FIG. 27 shows the data with an image. FIG. 28 shows the vCard data in all cases.

As shown in FIG. 26, the single case data in the vCard format MD1 first starts with “BEGIN: VCARD” and ends with “END: VCARD”. Respective items of personal information, as given in the following, are described between the “BEGIN: VCARD” and the “END: VCARD” in a “property: value” format using a property and a value. The property denotes the item and the value denotes the particular contents to be input in the item. As the property, “N (name)”, “SOUND (phonetic transcription in kana)”, “TEL (phone number)”, “EMAIL (electronic mail address)”, “ADS (residence)”, “NOTE (memo)”, etc. are prepared (where a word put in parentheses is the explanation of the property).

First, a full name of other person is described in the value of the property “N”. For example, when “Taro Yamada” is input into the input box of the name displayed on the screen when the phone book application (new entry) to which the vCard is applicable is started, “N: Taro Yamada” is described. Similarly, the phonetic transcription in kana is described in the value of the property “SOUND”.

The phone number is described in the property “TEL”, and following items can be designated by adding the command further (referred to as “TYPE designation” hereinafter). The phone number of the place of employment is described in the value of “TEL;WORK;VOICE:”, and the FAX number of the place of employment is described in the value of “TEL;WORK;FAX:”. The phone number of the home is described by substituting “HOME” for the portion “WORK”. The cellular phone number is described in the value of “TEL;CELL:”. Also, various TYPE designations can be applied by selecting the registered icon of the cellular phone number, and thus various phone numbers can be designated. The “key” phone number is described in the value of “TEL;X-ABC-MAIN; VOICE:” in the seventh line in FIG. 26. Also, the property in which the “school” phone number is described is provided. In addition, various identification TYPE commands are prepared.

The electronic mail address is described in the value of the property “EMAIL”. If the TYPE designation is applied after “EMAIL” like the “TEL” command, a plurality of electronic mail addresses can be designated by the “EMAIL” command. In the example in FIG. 26, the electronic mail address of the company is described in the value of “EMAIL;WORK:”, the electronic mail address of the cellular phone is described in the value of “EMAIL;CELL:”, and the electronic mail address of the Internet is described in the value of “EMAIL;INTERNET:”.

The residence is described in the value of the property “ADR”. If the TYPE designation such as “WORK”, “HOME”, or the like is applied after “ADR”, the company address, the home address, etc. can be designated by the “ADR” command.

The contents of memo are described in the value of the property “NOTE”. In the present embodiment, a function of setting a print layout to the printer 1 by inputting the designated character in the memo and describing the designated character in the value of “NOTE” is provided.

vCard Data in All Cases

As shown in FIG. 28, the vCard data in all cases AD contains plural pieces of personal information, and each personal information starts with “BEGIN:VCARD” and ends with “END:VCARD”. Respective items constituting the personal information of a single case are described between BEGIN:VCARD” and “END:VCARD” in a “property: value” format.

Therefore, as can be seen from FIG. 28, “END:VCARD” is described every time when the data in a single case is ended. The user can select either “single case” or “all cases” upon transmitting the personal information data from the cellular phone 14. The printer 1 decides the applied print layout based on the “single case” or the “all cases” of the received vCard file. In the present embodiment, in order to identify whether the vCard file is in the “single case” or in the “all cases”, the command or property that is always described in the personal information data and described individually every case is employed as a number-of-cases identifier CS. Of course, the command or property that is described in predetermined numbers ever, case may be employed. For example, since the “VCARD” is described twice per case, a method of deciding the case as the “single case” if the counted value is “2” and the case as the “all cases” if the counted value is “4 or more” may be employed.

In the case of the present embodiment, the “END:VCARD” is employed as the number-of-cases identifier CS. The number-of-cases deciding portion 82 of the IrDA profile processing portion 74 decides whether the personal information data are the signal case or all cases (containing all cases in the group if the group is designated). In more detail, the CPU 41 counts the number-of-cases identifier “END:VCARD” contained in the data by a counter, and then decides based on the counted value whether the received vCard file belongs to the “signal case” or the “all cases”. In other words, a decision value (e.g., flag) N is reset to “N=0” if the counted value is “1”, and the decision value N is set to “N=1” if the counted value is “2 or more”.

Also, the file corresponds to the file in all cases, the IrDA profile processing portion 74 does not send the data to the text-data format converting portion 85 after it received all the data, but sends the data to the text-data format converting portion 85 in the next processing portion every predetermined number of cases every time when the predetermined number of cases out of all cases is buffered. The division processing portion 84 executes this process. The division of respective cases in the data is decided by checking a division identifier DS. In this example, the “END:VCARD” is employed as the division identifier DS.

In more detail, after the data transferring portion 73 checked in the transfer control procedure 73a whether or not the data have been received validly, the CPU 41 counts the “END:VCARD” (which is identical to the number-of-cases identifier CS in this example) of the data as the division identifier DS by a counter and then counts the number of cases of the received personal information based on the counted value. Then, the CPU 41 sends the data in the reception buffer 44a to the text-data format converting portion 85 every time when the personal information in predetermined numbers is buffered in the reception buffer 44a of the RAM 44. More particularly, the CPU 41 executes the next text-data format converting process every time when the data are buffered in predetermined numbers. In this case, the last property of each case may be employed as the division identifier DS.

Name Card Printing Template

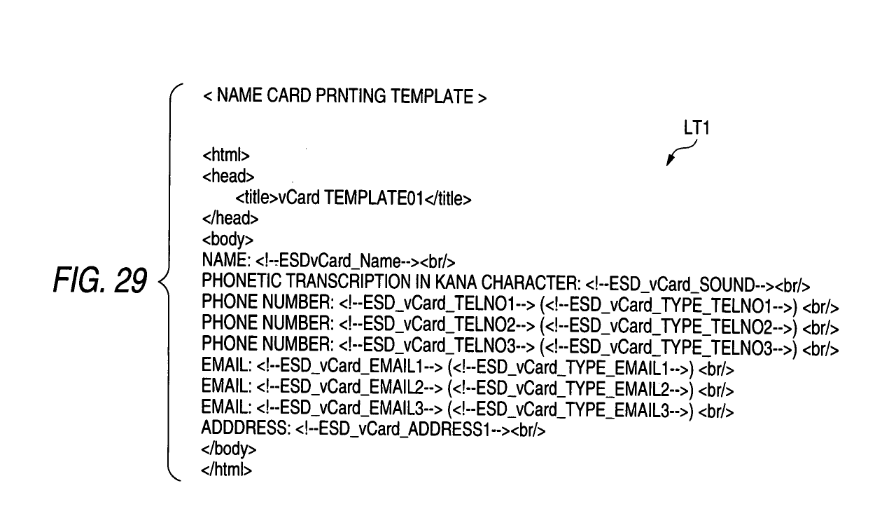

FIG. 29 shows an example a template format data LT1 in a print layout applied upon printing the personal information data.

The print layout (printing format) of the vCard file depends on template format data stored in the EEPROM 43 in the printer 1. The template format data are the print layout data that are described in the XHTML format. The XHTML data are separated into three areas of a field, a comment tag, and a property between <body> and </body> every one item (every line in FIG. 29).

In FIG. 29, the field is a data area for character strings that are printed as the title such as “Name”, “Phone Number”, and the like in the name card, etc. The prescribed titles such as “Name”, “Phone Number”, etc. necessary for the name card are described previously in the fields of the template format data LT1.

The comment tag is a command to instruct printing positions, fonts, character sizes, etc. of the values of respective properties (e.g., the value “Taro Yamada” in the case of the property “N”) in the vCard format file. The value is incorporated immediately after the comment tag “<!-- -->”. Also, there is the method of substituting the value for the comment tag “< >”.

The property is a command to instruct printing positions, fonts, character sizes, etc. of the TYPE-designated data in the data in the vCard format. The TYPE-designated data, e.g., character strings such as “WORK”, “CELL”, or the like are incorporated immediately after the property “< >”. Therefore, as shown in FIG. 26, only the comment tag is given in the data such as the name, the phonetic transcription in kana, or the like, which is described solely in one piece of personal information and is out of the TYPE designation. In contrast, the property is attached to the comment tag in the area in which the TYPE-designated data such as the phone number, the electronic mail, etc. are described. Here, fonts, character sizes, etc. are not designated in the comment tag and the property in FIG. 28.

Format Change to Template Format

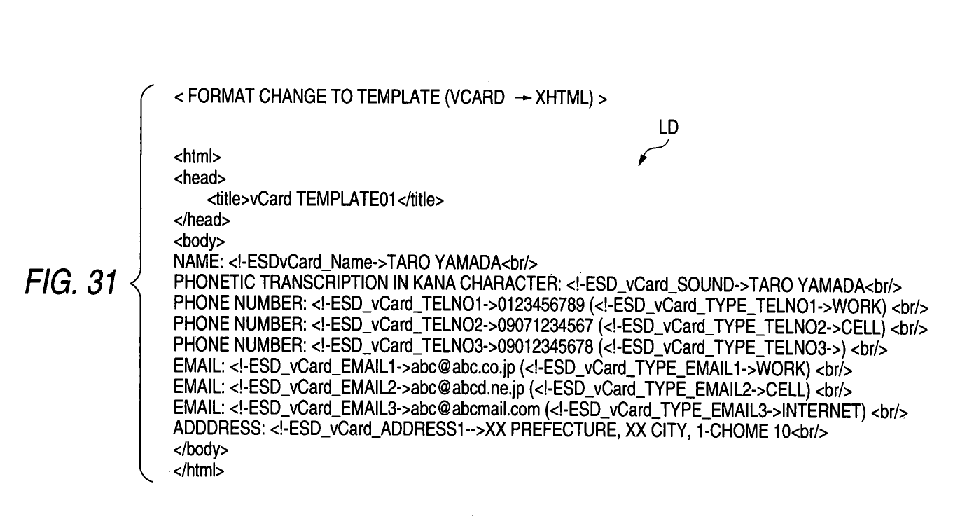

FIG. 31 shows a XHTML-described template format data LD obtained after the personal information data in FIG. 26 are applied to the name-card printing template format data LT1 in FIG. 29. The pointed values (and properties) of the personal information data (personal information displayed as shown in FIG. 4B on the display of the cellular phone) in FIG. 26 are incorporated into the name-card printing template format data LT1 in FIG. 29, whereby the template format data LD consisting of the XHTML data shown in FIG. 31 are given. The text-data format converting portion 85 executes the converting process of the personal information data into the template format data LD. The template format data LD converted by the text-data format converting portion 85 are transmitted to the text-data raster processing portion 75. The CPU 41 executes the text-data format converting process as follows. The CPU 41, when reads the template data LT without the property, picks up the value of the property (“Taro Yamada”, or the like) from the vCard file based on the property (“Name”, or the like) described in the comment tag and then incorporates the picked-up value into the position just after the comment tag in the template data LT. Also, the CPU 41 picks up the TYPE (“WORK”, or the like) of the property from the vCard file based on the property (“TELNO1”, or the like) immediately after “TYPE” in the property, and then inserts the picked-up TYPE into the position just after the property in the template data LT. An incorporating process executed in compliance with this rule is carried out when the CPU 41 executes a program for the text-data format converting process. In this way, the template format data LD shown in FIG. 31 are formed.

### EXAMPLE OF PRINTING TEMPLATE

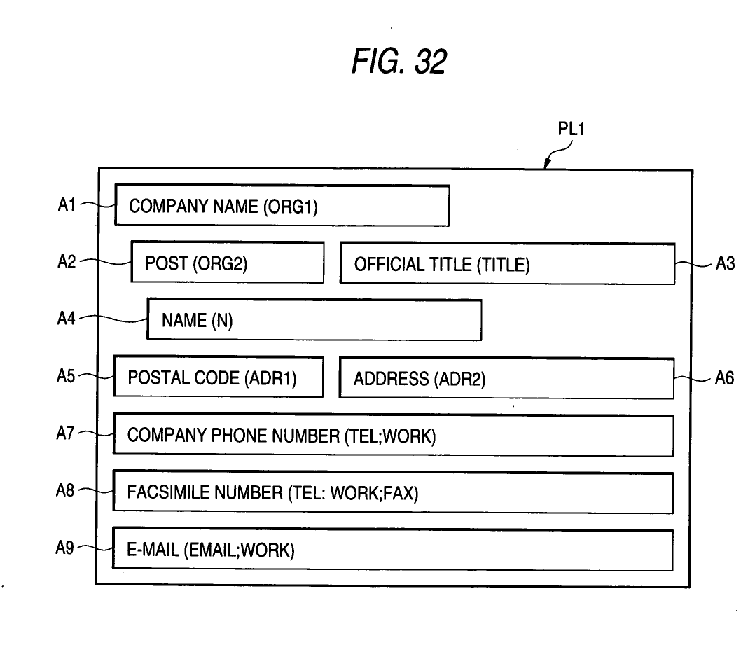

FIG. 32 shows an example of a print layout in a name-card format. FIG. 32 shows a print layout template PL1 designated by the template format data LT1. In FIG. 32, arrangement areas A1 to A9 enclosed with a square frame respectively are locations in which values of respective items of the personal information are arranged and this location is designated by the comment tag in the template format data LT1 respectively. Then, values whose positions are pointed by the comment tags are arranged in the arrangement areas A1 to A9 designated by the comment tags. The titles attached to the inside of the arrangement areas A1 to A9 are described in advance in the template format data LT1, and the values are arranged on the right side of respective titles. In FIG. 32, items put into parentheses in respective arrangement areas A1 to A9 (e.g., “ORG1”, or the like) are properties in the vCard data, and signify that the value of the property is arranged in the arrangement area. For example, the value “Taro Yamada” of the property “N” in FIG. 26 is arranged on the right side of the “Name” in the arrangement area A4 in FIG. 32. In this case, there is a difference between the name-card printing template format data LT1 in FIG. 29 and the example of the print layout template PL1 in FIG. 32, but the template format data LT1 in FIG. 29 shows a simple template example. In this example, the XHTML data that can designate the print layout template PL1 for the name card printing shown in FIG. 32 are stored in the EEPROM 43 as one of the template data LT. In this case, necessary data such as company name, post, official title, company phone number, company FAX number, company E-mail, etc. are input as the personal information to use.

The XHTML format data are inserted into respective items in FIG. 32 in accordance with the template data LT, and converted into the printed data by predetermined font type, font size, font style, etc. For example, in the case of the company name, in the vcard format, the particular company name is described as the value in the property “ORG” and, as shown above, first the vCard is converted into the XHTML format. Then, the data are converted into the template format, and finally the value of the property “ORG” is inserted as shown in FIG. 32.

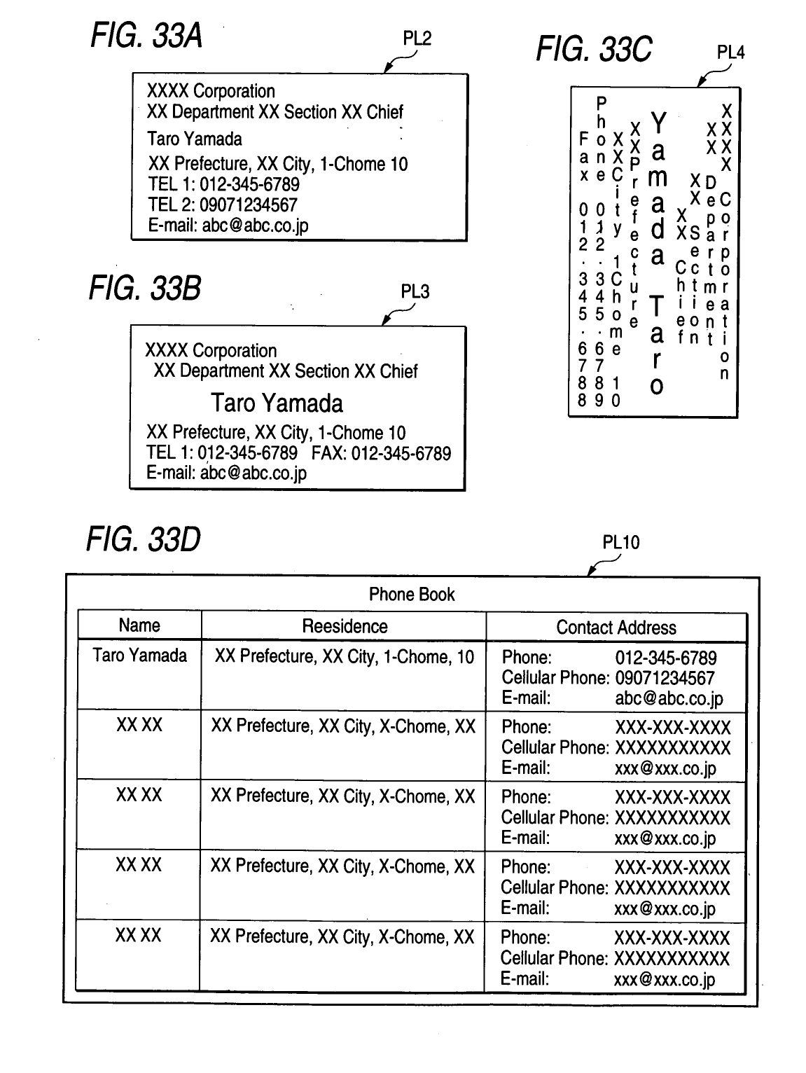

FIG. 33 shows print layout templates, and FIGS. 33A to 33C show examples of the print layout template used to print the name card, and FIG. 33D shows an example of a print layout template used to print the phone book. In this case, FIG. 33 shows respective templates PL2 to PL4, PL10 as the print layout template into which values (texts) of the properties in the vCard file are incorporated. The templates PL2 to PL4, PL10 consist of the XHTML data in which the tags to point the layout position, into which the value (text) is incorporated every property, and the area size (layout area) are described. The print layout templates (XHTML data) to print plural types of name cards containing the name cards shown in FIG. 32 and FIGS. 33A to 33C are stored in the EEPROM 43.

Here, the type of the print layout to print the name card will be simply explained hereunder. FIG. 33A shows a print layout template PL2 for the laterally written name card in which all the character sizes are identical. FIG. 33B shows a print layout template PL3 to print the laterally written name card in which the character size of the name is printed larger than other portions, and FIG. 33C shows a print layout template PL4 to print the vertically written name card in which the character size of the name is printed larger than other portions. Also, FIG. 33D shows a phone-book print layout template PL10 used to print the personal information in all cases. This print layout template data (XHTML data) to print the phone book is also stored in the EEPROM 43.

In the present embodiment, the personal information are printed in the print layout to print the name card if such information are given as the single case, while the personal information the personal information are printed in the print layout to print the phone book if such information are given as all cases (plural cases). If the vCard file is given as the “all cases” containing plural pieces of personal information, the CPU 41 designates uniquely the print layout template PL10 to print the phone book in FIG. 33D. In contrast, if the vCard file is given as the “single case” containing only one piece of personal information, the user can select/point the print layout to print the name card via the cellular phone 14.

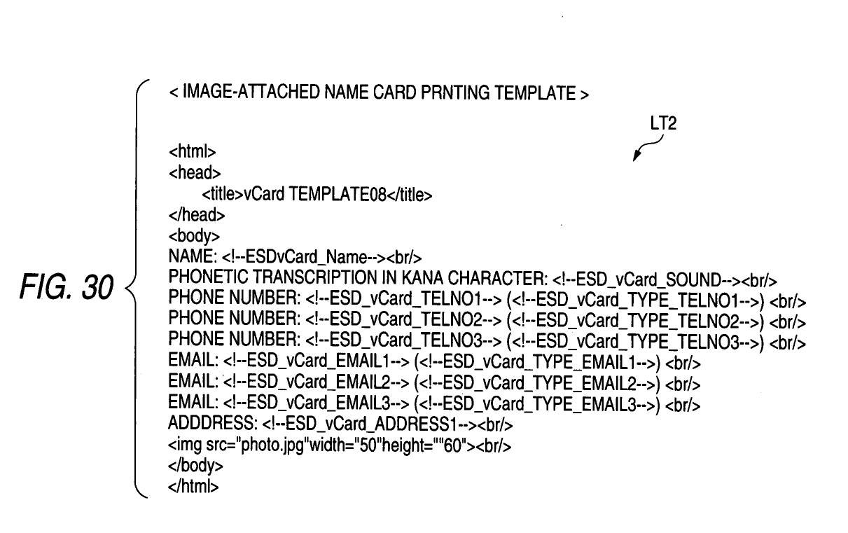

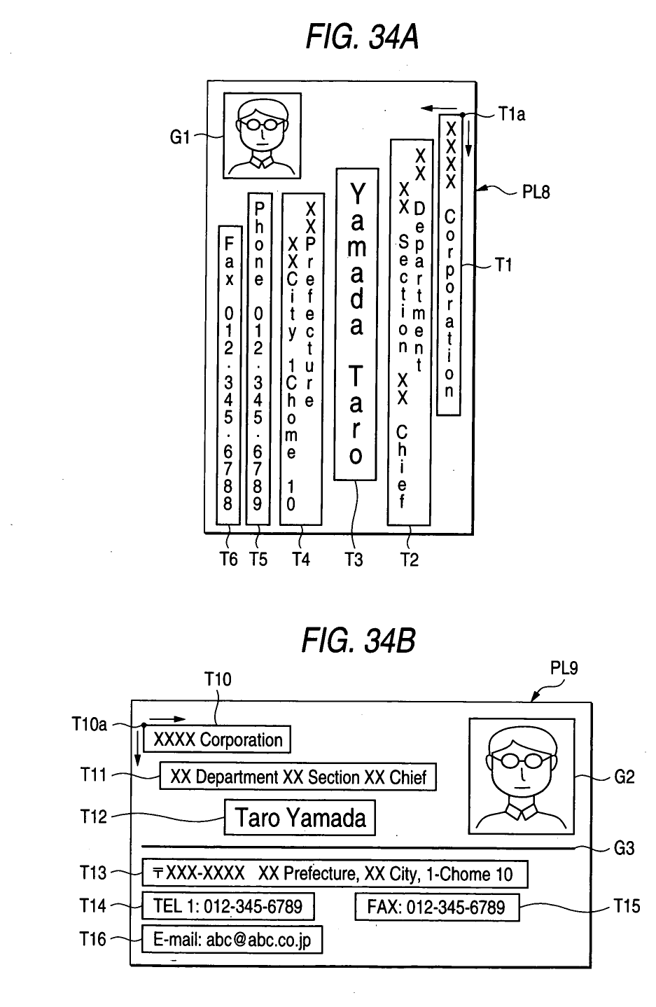

FIGS. 34A and 34B show a print layout to print an image-attached name card in which the image is attached the name card. The CPU 41 uses an image-attached name card printing template LT2 shown in FIG. 30 when it detects the vCard file (see FIG. 23) in the format to which the image data can be attached as shown in FIG. 27. For example, the name card with a photograph of face can be printed by attaching the image of the photograph of face to the vCard file.

FIG. 34A shows an example of a printing template in which the image (photograph of face) is arranged near the upper left corner of the vertically oriented name card and respective texts of personal information are designed in the vertically written layout. Positions and sizes to which the value (text) of each property or the image is assigned in the name card are designated by layout frames (layout areas) in which layout positions and area sizes are described and specified by the tags in the XHTML format. In the template PL8 in FIG. 34A, a layout frame (layout area) G1 of the image is set to a predetermined position near the upper left corner of the name card. Layout frames T1 to T6 into which the texts required for the name card every property are poured are set in positions that are suitable for respective items of the name card. Also, font, font size, and character color of the texts to be poured are appointed to the text layout frames T1 to T6. Lengths and widths of the layout frames T1 to T6 are adjusted automatically in size from an upper right corner T1a of the layout frame as a reference point along arrowed directions in response to the number of characters of the text (character string length).

FIG. 34B shows an example of a printing template in which the image (photograph of face) is arranged near the upper right corner of the laterally oriented name card, a horizontal bar is drawn in design around the center area in the vertical direction, and respective texts are designed in the laterally written layout. The template PL9 in FIG. 34B consists of the XHTML data in which an image layout frame G2 and text layout frames T10 to T16 are set, like the template PL8 to print the vertically written name card, and in addition a horizontal line layout frame G3 is set near the center area. Lengths and widths of the text layout frames T10 to T16 are adjusted automatically in size from an upper left corner T10a of the layout frame as a reference point along arrowed directions in response to the number of characters of the text (character string length). Respective data of these print layout templates PL8, PL9 to print the name card being described in the XHTML format are correlated with the numbers, for example, and stored in the EEPROM 43 (see FIG. 5).

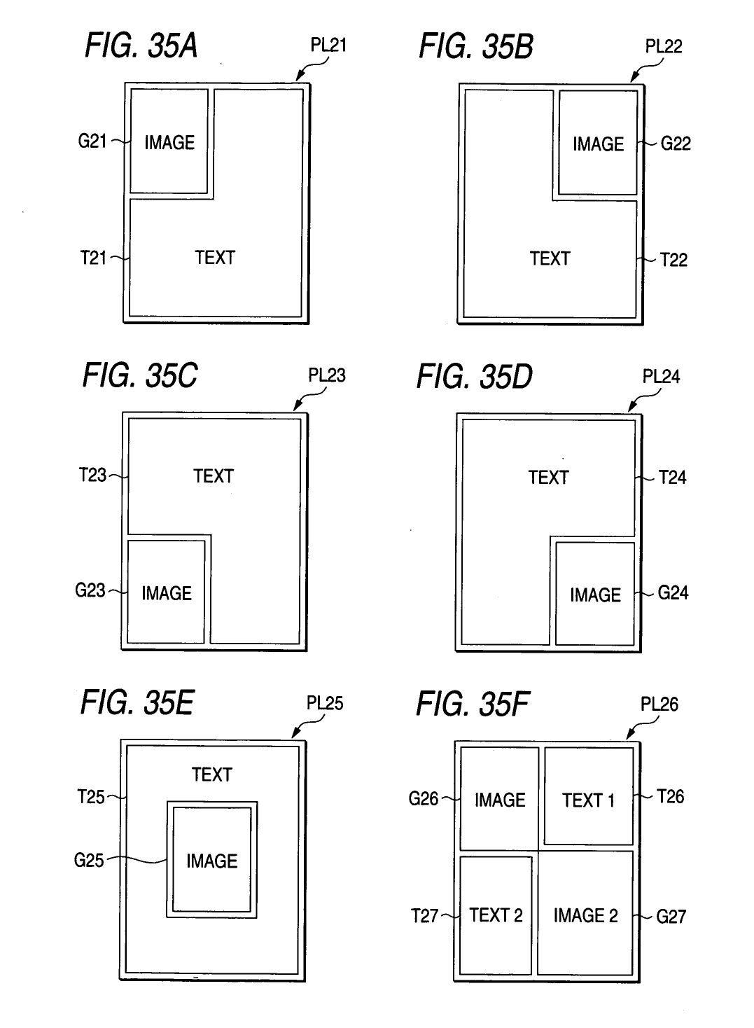

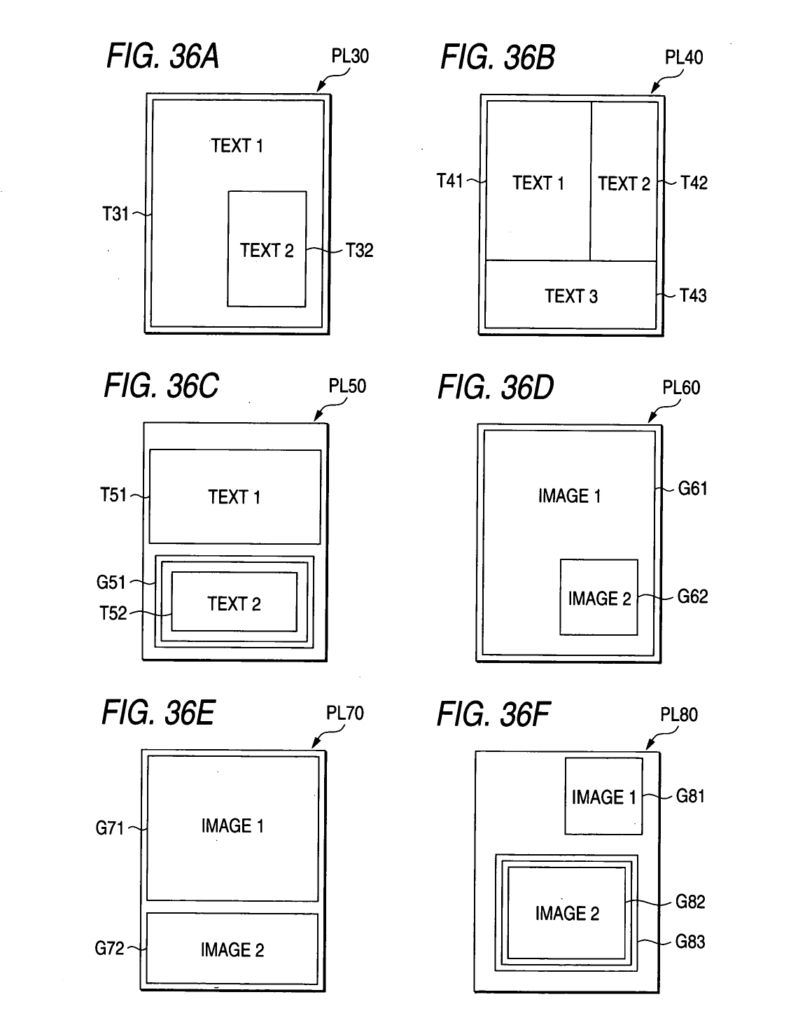

FIGS. 35A to 35F and FIGS. 36A to 36F show an example of a print layout template respectively other than the print layout to print the name card. FIGS. 35A to 35F are print layout templates to print the image data and the text data with layout frames.

In templates PL21 to PL25 in FIGS. 35A to 35E, one of image layout frames G21 to G25 is arranged at an upper left corner, an upper right corner, a lower left corner, a lower right corner, and a center area respectively, and one of text layout frames T21 to T25 is arranged in remaining area respectively. In FIG. 35F, two image layout frames G26, G27 and two text layout frames T26, T27 are positioned in such a manner that both images and both texts are arranged on the diagonal respectively.

Then, FIGS. 36A to 36F show other print layout template respectively. FIG. 36A shows an example in which a layout frame of a text 2 is arranged in a layout frame of a text 1. FIG. 36B shows an example in which a layout frame of a text 1, a layout frame of a text 2, and a layout frame of a text 3 are arranged in combination. FIG. 36C shows an example in which a layout frame of a text 1 and a bordered layout frame of a text 2 are arranged vertically. FIG. 36D shows an example in which a layout frame of an image 2 is arranged in a layout frame of an image 1. FIG. 36E shows an example in which a layout frame of an image 1 and a layout frame of an image 2 are arranged vertically. FIG. 36F shows an example in which a layout frame of an image 1 and a bordered layout frame of an imaged 2 are arranged.

Next, a method of inserting the image into the layout frame will be explained hereunder.

A size (dimension) of the image and a picture quality (rough and smooth) are different according to the used cellular phone 14. Also, there are several types of paper sizes to be printed.

Therefore, suppose that the whole area in FIG. 34A is set as a paper size and a width A1 of the paper is set as 100%, and a lateral width of the layout frame L1 is set to any value from 0 (zero) % to 100% as the print layout. Also, suppose that a length Cl of the paper is set as 100%, and a length Dl of the layout frame L1 is set to any value from 0 (zero) % to 100%. When the image is inserted into the set layout frame L1, either a longer side out of vertical and lateral sides of the image from the cellular phone 14 or one side of the image if the image from the cellular phone 14 is a square is selected, and then a size of the image is changed by the memory controller 93 so as to mate the selected side with a vertical or lateral size of the layout frame L1. The data obtained up to now are stored in the work memory 44b.

Next, a method of inserting the text into the layout frame L2 will be explained hereunder. The character generator 98 having character generator data (CG data), which indicate patterns of characters (texts, symbols, etc.) such as Japanese and English fonts, etc., and converting character codes in the CG data is stored in the ROM 42.

When the text code is given to the designated address, the character generator 98 reads the data of the text dot patterns indicating dot configurations of various texts. The dot patterns are bit data, and output in serial by the circuit such as the shift register, or the like. That is, the character generator 98 fulfills a role to provide the data of text and symbol consisting of various fonts, sizes, and colors to the memory controller 93.

Also, positional information of the font and the text, color information of text, and others can be designated by the display device 9 on operation panel 8 shown in FIG. 2 and the operation portion 10 consisting of a plurality of operation switches. Unless they are designated, default values being previously set are set.

The XHTML data contain the text information and the template information, and the interpretation processing portion 90 extracts only the text information by analyzing the XHTML data and also picks up the layout information by analyzing the template information. The layout information are derived as addresses in a memory space in which the image is expanded in the work memory 44b. Respective layout frames are specified as addresses in a memory space in which the image is expanded, and then the dot pattern data read from the character generator 98 are poured into the layout frame designated by the address based on the layout information.

Then, a process of rearranging the expanded image data (dot data) and the text data (dot pattern data) into the dot forming sequence in the printing is applied. Then, the generated printing images are stored in the work memory 44b.

The print processing portion 46b cuts out the print image expanded in the work memory 44b every image band and generates the print data by attaching the command. The images are printed in seriatim on a predetermined paper by the print engine 77 based on the print data.

The layout can be designated by both the cellular phone 14 and the operation panel 8 on the printer 1 side, but the designation made by the cellular phone 14 side is accepted preferentially. When no description to appoint the layout is given in the memo area, the layout designated by the printer 1 side becomes available.

The paper size, the number of printed sheets, etc. are selected from a menu displayed on the screen 9a of the operation panel 8 shown in FIG. 2 and decided by the upper switch 10f and the lower switch 10g. Then, the layout is selected and the decision switch 10h is pressed. Then, template formats corresponding to FIGS. 32 to 36 are displayed on the screen 9a. The desired layout is decided by pressing the upper switch 10f and the lower switch 10g, and by pressing the decision switch 10h. Then, the effect that the designated layout is made available in printing the data from the cellular phone 14 is registered on the printer 1 by operating the operation portion 10.

Print layout Designation in Memo Area

The user causes the display 18 of the cellular phone 14 to display the personal information column, and inputs the print layout designation information into the memo box thereof. For example, digits (numbers) such as “1”, “2”, “3”, etc. are input into the memo box. The digits described as the print layout designation information are described as the value of the property “NOTE” in the vCard data. The digits described in the memo box are handled as the print layout designation number upon printing the personal information in the single case. For example, the name card layout templates PL1 to PL4, etc. in FIG. 32 and FIGS. 33A to 33C and the designation numbers assigned to the name card layout templates PL1 to PL4, etc. are set forth in the instructions manual of the printer 1 to correlate with each other. Thus, the user appoints the name card layout by inputting the designation number in the instructions manual into the memo box.

For example, when the digit “2” is input into the memo box like the personal information box in FIG. 4B, “2” is described in the property “NOTE” in the vCard file in FIG. 26. When the vCard file is received from the cellular phone 14, the character string described as the value of the property “NOTE” is read and then the designation number is identified by analyzing the character string. This analyzing process is executed by the Note analyzing portion 83, and in detail the CPU 41 analyzes the value of “NOTE” in the vCard file to execute the analyzing process.

When the CPU 41 could identify the designation number, it reads the name card layout template (XHTML format) corresponding to the designation number from the EEPROM 43. The CPU 41 executes the above text-data format converting process, and generates the template format data LD, in which the value of the property in the vCard file (also the property in this example) is fitted in the XHTML description template format as shown in FIG. 31, based on the vCard file shown in FIG. 26 and the template format data LT1 shown in FIG. 29. The template format data LD are the XHTML data.

Here, it is normal that not the designation number of the print layout but the character string or the sentence as the essential memo is input into the memo box. When the CPU 41 is going to analyze the value of the property “NOTE”, it is possible that the numerical value is misunderstood as the designation number if the numerical value is contained in the character string or the sentence described as the essential memo. The program that the CPU 41 executes in the analyzing process is set such that the description data are decided as the essential memo if the character, the character string, or the like except the designation number is described, and that the digit is not specified as the designation number even if the digit that can be used as the designation number is contained therein. Then, it is decided that the designation number is not designated in either the case where the designation number is decided as the essential memo or the case where the memo box is blank. For example, the name card layout template PL2 that is set as the default one is pointed.

In the present embodiment, the designation number (digit) is used to designate the print layout. But such designation is not limited to the digit, and alphabet, katakana, symbolic character, character, character string, or the like, for example, may be used to designate the print layout. In this case, in order to designate the print layout as simple as possible, it is preferable that either the number of one figure or one character should be used to designate one piece of information. Also, the digit (number) or the alphabet having the order relation

Process in the IrDA Profile Portion

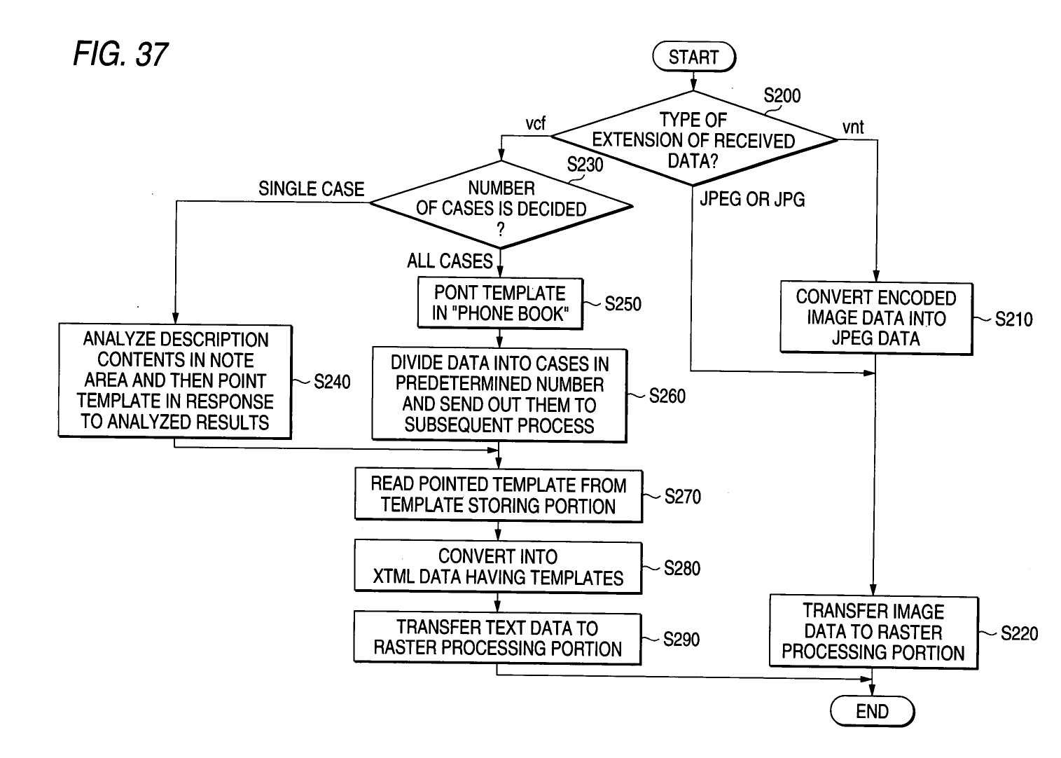

FIG. 37 is a flowchart showing a process executed in the IrDA profile portion 74. When the data can be received correctly in the data transferring portion 73, the CPU 41 executes the program shown in the flowchart in FIG. 37. Respective functions of the extension identifying portion 81, the number-of-cases deciding portion 82, the Note analyzing portion 83, the division processing portion 84, the text-data format converting portion 85, and the image data decoding portion 87 in FIG. 6 are executed when the CPU 41 executes the program. Then, this program executed by the CPU 41 will be explained hereunder. In this case, the extension and the object data are transferred from the CF-type communication card 13 to the printer 1, and the extension is sent at the head of the data.

In S200, it is decided what is the type of the extension of the received data. If the extension of the received data is “jpeg” or “jpg”, the data are decided as the image data in the JPEG format and then the process goes to S220. Also, if the extension of the received data is “vct”, the data are decided as the image data in the vNote format (referred to as a “vNote file” hereinafter) and then the process goes to S210. In addition, if the extension of the received data is “vcf”, the data are decided as the text data in the vCard format (referred to as a “vCard file” hereinafter) and then the process goes to S130.

In S210, the encoded image data attached to the vNote file are decoded (expanded) into the image data in the JPEG format by the encode/decode converter called Base64.

In S220, the image data in the JPEG format are transferred to the image-data raster processing portion 76.

In S230, the number of cases of the personal information data transmitted from the cellular phone 14 is decided. That is, it is decided whether the vCard file is “single case” or “all cases”. In the present example, the number of cases of the personal information is decided by counting the identifier “END:VCARD” in the vCard file. The data are decided as the single case data if the counted result C is C=1, and the data are decided as the all case data if the counted result C is C≧2. For example, if the vCard file is the single case data as shown in FIG. 26, the counted result C is C=1 because the identifier “END:VCARD” is only one, and thus the data are decided as the “single case”. In contrast, if the vCard file is the all case data as shown in FIG. 26, the counted result C satisfies C≧2 because “END:VCARD” exists in plural, and thus the data are decided as the “all cases”. If the data are decided as the “single case” containing only one piece of personal information, the process goes to S240. Also, if the data are decided as the “all cases” containing plural pieces of personal information, the process goes to S250. As another deciding method, the number of cases of the personal information may be decided by the file name of the data.

In S240, contents described in the Note area are analyzed, and the template is pointed in response to analyzed results. The values (description contents) of the property “NOTE” in the vCard file data are analyzed, and then the designation information (the number in this example) of the template is searched from the values. For example, if “2” is described in the memo as shown in FIG. 4B, “2” is described in the value of the property “NOTE” in the vCard file data, and therefore this number “2” is extracted as the analyzed result. Then, this number “2” is stored in the RAM 44 as the information to designate the template.

In S250, the “phone book” template is pointed. That is, if the data are the “all cases”, the “phone book” template is designated.

In S260, the vCard file data in all case are divided into the personal information every predetermined numbers, and the data are sent out to the subsequent process in predetermined numbers.

In S270, the designated template is read from the template storing portion 86. That is, in the case of the “single case”, the template (the layout of the name card format) decided from the analyzed result of the description contents in the note area designated in S240 is read and, in the case of the “all cases”, the “phone book” template (the layout of the phone book format) designated in S250 is read.

In S280, the personal information in the vCard file are converted into the XHTML data having templates. In other words, the personal information are converted into the XHTML data having templates by applying the content (value) of the item (property) of the personal information into locations into which the items to be fitted to the template are assigned. For example, in the case of the vCard file in the single case shown in FIG. 26, the personal information are converted into the XHTML format data shown in FIG. 31. Also, in the case of the vCard file with the image shown in FIG. 27, the personal information are converted into the XHTML format data into which the personal information constituting the vCard data are incorporated into the template with image LT in the XHTML format, as shown in FIG. 30.

In S290, the XHTML data having the template are transferred to the text-data raster processing portion 75.

In this case, the extension identifying portion 81, the number-of-cases deciding portion 82, the Note analyzing portion 83, and the division processing portion 84 in the IrDA profile processing portion 74 are realized by S200, S230, S230, S240, S260 respectively. Also, the text-data format converting portion 85 is realized by S250, S270, S280, and S290.

In this manner, various processes are then applied to the data being transferred to the text-data raster processing portion 75 to generate the print data. Also, various processes are then applied to the data being transferred to the image-data raster processing portion 76 to generate the print data. Then, the print engine 77 drives/controls the printing mechanism based on the print data, so that either the personal information transmitted in the vCard file are printed on the roll paper P1 in the designated print layout or the image transmitted in the vNote file are printed. For instance, when the vCard file containing the personal information in the single case is transmitted to the printer 1, the personal information are printed in the name card layout that corresponds to the designation number being input into the memo box of the cellular phone 14.

Cutter Control

Next, drive control of the cutter unit will be explained hereunder.

The CPU 41 drives/controls the cutter motor M3 by executing a program given by a flowchart in FIG. 38 to output the command signal to the driver.

The cutter control that the CPU41 executes will be explained with reference to the flowchart shown in FIG. 38 hereunder. This process is executed in a preparation period of the paper feed control until the drive of the carriage motor M2 is ended after the preceding paper fed is completed.

First, in S310, it is decided whether or not the next paper feed is instructed. If the next paper feed is not instructed, a paper discharge process is executed and then the process goes to S380. In contrast, if the next paper feed is instructed, the process goes to S320. Here, if it is decided that the process should go to the paper discharge process, a paper discharge code (e.g., “01”) is set in the management register 41b.

In S320, a cutter-driver count value CT is read.

In S330, when the next paper feed is executed by a paper feed length ΔF, it is decided whether or not a count value FT exceeds the cutter-driver count value CT. That is, it is decided whether or not a new count value FT (=FT+ΔF) obtained by adding ΔF to the current count value FT exceeds the cutter-driver count value CT (FT+ΔF> CT). If this condition FT+ΔF> CT is not satisfied, the process goes to S340. If this condition is satisfied, the process goes to S350. Here, if this condition is satisfied, a cut code (e.g., “10”) is set in the management register 41b.

In S340, when the next paper feed is executed by the paper feed length ΔF, it is decided whether or not the count value FT coincides with the cutter-driver count value CT. That is, it is decided whether or not FT+ΔF=CT is satisfied. If this condition FT+ΔF=CT is not satisfied, the process goes to S360. If this condition is satisfied, the process goes to S350.

In S350, an identity code (e.g., “11”) is set in the management register 41b.

In S360, the paper feed is instructed by a paper feed length ΔF.

In S370, it is decided whether or not the identity code has been set in the management register 41b. If the identity code has been set, the process goes to S400. Unless the identity code has been set, this process is ended.

In S380, a paper feed length ΔCF that can make the count value FT coincide with the cutter-driver count value CT is calculated. That is, ΔCF is calculated based in Equation ΔCF=CT−FT. When the paper is fed from the current paper position by this ΔCF, a virtual cutting line on the roll paper P1 coincides with a virtual cutting line of the cutter (rotary blade) 107.

In S390, the paper feed is instructed by a paper feed length ΔCF.

In S400, it is decided whether or not the paper feed is completed. Other processes are carried out until the paper feed is completed. If an interrupt signal is input after the paper feed is completed, the process goes to S410.

In S410, the roll paper P1 is cut by driving the cutter motor M3.

In S420, it is decided what is the type of the code being set in the management register 41b. If the identity code is sensed, the present process is ended. Also, if the cut code is sensed, the process goes to S430. Also, if the paper discharge code is sensed, the process goes to S440.

In S430, the paper feed is instructed by a remaining paper feed length. That is, ΔF−ΔCF is calculated to get the result ΔFR (=ΔF−ΔCF), and then the paper feed is instructed by this ΔFR.

In S440, a reverse paper feed is instructed to return a top end of the roll paper P1 to the initial set position.

Next, characterizing points of the infrared radio communication interface in the IrDA system in the present embodiment will be set forth hereunder.

The IrDA communication interface portion is arranged separately in the CF-type communication card 13 and the main body 2 respectively. Then, the check of the received data is allotted to a first check to decide whether or not the received data are the acceptable data in the CF-type communication card 13 and a second check to decide whether or not the data have been correctly transferred to the main body 2 side. The printer 1 includes a plurality of communication portions 45b to 45d, which have the different communication system from the CF-type communication card 13, in the main body 2, and is constructed such that the data can be transmitted/received to/from the CF-type communication card 13 via only any one port of other communication portions 45b to 45d. In this case, the object transmitting/receiving portion 64 (CPU 159) in the CF-type communication card 13 decides whether the received data are the acceptable data or the unacceptable data and then the received data are canceled in the CF-type communication card 13 if the data are the unacceptable data. Therefore, the unacceptable data to be canceled are never transferred to the main body 2 side of the printer 1. Suppose that the data to be canceled are transferred in vain to the main body 2 side from the CF-type communication card 13 to occupy the port, the data reception via other communication portions 45b to 45d is stagnated for this while. However, in this embodiment, since the unacceptable data are canceled in the CF-type communication card 13 not to be transferred to the main body 2 side, the effective communication that does not unnecessarily disturb the data reception of other communication portions 45b to 45d can be realized.

Also, the unacceptable data are detected in the CF-type communication card 13 on the upstream side of the reception upon starting the data reception, and then the error is immediately displayed on the displaying portion 13b. Therefore, the user who starts the data transmission from the cellular phone 14 can be informed quickly of the receiving error.

Also, the extension data (reference data) used to decide whether the received data are the acceptable data or the unacceptable data is set in the CF-type communication card 13 from the main body 2 side of the printer 1. Accordingly, the data registered on the main body 2 side can be used as the reference data. In other words, in some cases the acceptable data are different when the type of the printer 1 is different, and in such case the reference data can be set in answer to the type of device. Therefore, the CF-type communication card 13 can be used commonly between a plurality of types of the device or new and old types of the device.

Then, advantages of the first embodiment will be in detail described hereunder.

(1-1) When the data transmission is executed from the cellular phone 14 by using the infrared ray having a sharp directivity, the user can transmit the data by directing the infrared-ray emitting/receiving portion (communication port) 20 of the cellular phone 14 to the infrared-ray receiving/emitting portion (communication port) 13a on the printer 1 side while looking at the infrared-ray receiving/emitting portion 13a positioned at the transmission destination. At this time, since the displaying portion 13b positioned near the infrared-ray receiving/emitting portion 13a that the user observes can inform the user of the communication state, the user can check easily the receiving state with his or her eye during the data transmission.

(1-2) Since the CF-type communication card 13 is set in the card slot 12 provided on the front surface of the main body 2, the displaying portion 13b is positioned on the front surface of the main body 2 and the user (operator) is ready to see the portion. Since the screen 9a of the operation panel 8 is provided upward on the top surface of the main body 2 of the printer 1, it is difficult for the user, who stretches his or her hand on the front side of the printer 1 to put the cellular phone 14 in a communicable range and to transmit the data, for example, to look at the screen 9a of the operation panel 8. However, because the displaying portion 13b is arranged on the same front surface of the main body 2 as the infrared-ray receiving/emitting portion 13a as the communication port, the user even if makes the data transmission in such a posture can observe well the displaying portion 13b and can check easily the data receiving state.

(1-3) When the printer 1 is put on a relatively high place, the screen 9a of the operation panel 8 is directed upward and thus the user cannot check the screen 9a. In this case, since the displaying portion 13b is lightened on the front surface of the main body 2, the user (operator) who makes the data transmission can observe well the portion. Here, the similar advantage can be achieved by the configuration in which the card slot 12 is provided to the side surface of the main body 2, for example.

(1-4) Normally it takes several tens second to one minute to transmit the data from the cellular phone 14 to the printer 1. Therefore, if the user holds the cellular phone 14 during the transmission as it is, sometimes the movement of the hands in the middle of transmission causes the reception error. In the present embodiment, a height of the communication port is within 10 cm, especially in a range of 2 to 5 cm, from the bottom surface of the printer 1. Thus, the data transmission can be made while putting the cellular phone 14 on the table or the desk, on which the printer 1 is put, to direct its communication port 20 toward the printer 1 side. In addition, because the communication port is arranged at the lower position of the front surface of the printer 1 at a height within 10 cm on both sides of the paper discharge port 7, the data transmission can be executed while still putting the cellular phone 14 on the same table or desk as the printer 1. Further, the paper that is discharged from the paper discharge port 7, or the like in no way interrupts the communication.

(1-5) Sometimes the user directs unconsciously the target of the data transmission toward the displaying portion 13b side during when the user makes the data transmission while turning the user's eye upon the displaying portion 13b. In the present embodiment, when the user makes the data transmission toward the displaying portion 13b from the position that is separated at a maximum communicable range, the user has a positional relationship with the printer 1 at that time such that the infrared-ray receiving/emitting portion (communication port) 13a is positioned in the effective range. Therefore, even though the infrared-ray emitting/receiving portion (communication port) 20 of the cellular phone 14 is naturally deviated toward the displaying portion 13b side in a wait time during the data transmission, the failure of the data transmission hardly occurs. In particular, since normally the user transmits the data while putting the cellular phone 14 closer than the maximum communicable range, a probability of failure is lowered further.

(1-6) The portion for checking the received data (data validity decision) is provided separately to the CF-type communication card 13 and the main body 2 side of the printer 1. Therefore, even if the unacceptable data are transmitted, such data are canceled immediately when such data are decided as the unacceptable data by the object transmitting/receiving portion 64 in the CF-type communication card 13. Thus, the unacceptable data are not transmitted to the main body 2 of the printer 1 at all. As a result, such a situation can be avoided that the port used to transfer the data from the CF-type communication card 13 to the main body 2 side is occupied uselessly by the data that are to be canceled, and also the effective communication that does not unnecessarily disturb the data reception of other communication portions 45b to 45d can be realized.

(1-7) The portion for checking the received data (validity decision) is separated into two parts in the CF-type communication card 13 and the main body 2 side of the printer 1. In contrast, such a configuration may be considered that many decision checks applied to the received data are provided collectively to the CF-type communication card 13. In this case, if such configuration is employed, a buffer for accumulating temporarily the received data is needed. However, in the configuration in the present embodiment in which the checking process is shared with the main body 2 side to check the validity of the received data, there is no necessity to provide a deciding portion having a high performance and a buffer with a relatively large capacity to the CF-type communication card 13.

(1-8) Since the process to decide whether or not the received data are the unacceptable data is executed in the CF-type communication card 13 on the upstream side of data flow at an early stage after the data reception is started, the user can be informed quickly of the reception error to the effect that the unacceptable data were received. For example, such a configuration may be considered that, after the printer 1 receives the entire data, the data are However, if this configuration is employed, the user can know the error after he or she spent several tens second to one minute to finish the data transmission, and thus the transmitting operation executed up to that time is wasted. In contrast, according to the configuration in the present embodiment, such disadvantageous situation can be avoided.

(1-9) Also, for example, if the displaying portion 13b is provided to the main body 2 side of the printer 1, the data must be transferred once to the main body 2 side and then the detection result must be returned again to the CF-type communication card 13 side when the unacceptable data are detected. Thus, a turnaround time is required to transmit/receive the data until the user is informed of the error. However, in the present embodiment, since the displaying portion 13b is provided on the CF-type communication card 13 side to which the unacceptable data deciding portion is provided, the communication path to reach the error information can be completed shortly in the CF-type communication card 13 to avoid waste.

(1-10) The extension data (reference data) used to decide whether the received data correspond to the acceptable data or the unacceptable data are set into the CF-type communication card 13 from the main body 2 side of the printer 1. Therefore, the data that are set on the main body 2 side can be always be used as the extension data. In other words, in some cases the type of the acceptable data becomes different when the type of the printer 1 is different, and even in such case the reference data can be set in answer to the type of device. Therefore, the CF-type communication card 13 can be used commonly between a plurality of types of the device or new and old types of the device.

(1-11) Since the user is informed of the data reception state by the display color of the displaying portion 13b, such user is ready to decide the receiving condition. Also, since the same color (green) is turned ON in both the “ready for receiving” state and the “in reception” state when the data receiving state is good and also the red color is turned ON in the “error” state, the user can also decide based on the lightened color whether or not the receiving state is good. In addition, since the data receiving state is also displayed on the screen 9a of the operation panel 8, the user is informed of the receiving state by using at least one of characters and images on the screen and can understand straightforwardly such receiving state.

(1-12) The printer 1 can make the data reception in plural communication systems, but can receive the data only one port out of them. Therefore, the printer 1 decides based on the interlocking process whether or not the printer 1 can receive the data from the CF-type communication card 13. Then, the displaying portion 13b is turned ON in green color to inform of the effect that the data can be received only when it is decided by the interlocking process that the data reception is available, and the displaying portion 13b is turned OFF when it is decided that the data reception is unavailable. As a result, such a situation can be avoided that the user cannot know the fact that the printer 1 side is unready for receiving the data and thus the error message is displayed every time when the user makes the data transmission.

(1-13) The CF-type communication card 13 can inform the user of its data receiving state by turning ON/OFF the displaying portion 13b in green color. For example, such a situation can be avoided that, although the printer is now in data reception, the user who is convinced that he or she failed to transmit the data tries many times to transmit the data.

(1-14) When the communication is disconnected in a moment in the middle of data transmission and the data transmission is failed, the user can know the failure by the red ON/OFF of the displaying portion 13b. Therefore, the user who holds the cellular phone 14 while looking at the infrared-ray receiving/emitting portion (communication port) 13a as the transmission target can know quickly the failure. Such a situation can be avoided that, since the user who gazes steadily at the infrared-ray receiving/emitting portion 13a is seldom aware that the error message is displayed on the display 18 of the cellular phone 14, such user is not aware the failure o the data transmission for a while and keeps the data transmitting state as it is although the communication was interrupted in the middle and the data transmission was failed.

(1-15) When the data transmission is completed, the displaying portion 13b is turned ON in orange color to inform the user of the effect. Therefore, such a situation can be avoided that, although the data transmission has been completed, the user is not aware the completion of data reception until the user checks the display of the cellular phone 14 after a while and the user still continues to execute the transmitting operation as it is after the data transmission is completed.

(1-16) When the error occurs on the printer 1 side after the communication link between the cellular phone 14 and the CF-type communication card 13 is disconnected, no measure for informing the cellular phone 14 of the error is provided. In this event, the displaying portion 13b of the CF-type communication card 13 that communicates with the printer 1 can be turned ON/OFF in red color to inform the user of the effect of the error occurrence. Therefore, the user can also know the error generated after the communication between the cellular phone 14 and the CF-type communication card 13 is cut. As a result, such a situation can be avoided that, because the error is generated after the communication link is disconnected, the user who is convinced that the data transmission has succeeded feels irritation about the event that the printing is not started immediately after the data transmission.

(1-17) Since the lightened color (display color) of the displaying portion 13b is changed in response to the informed content, the user can decide easily the communication state based on the lightened color. For example, the user can grasp readily the communication state from the lightened color in such a manner that the ready-for-receiving state is indicated by the green ON, the reception completion state is indicated by the orange ON, the error state is indicated by the red ON/OFF, and the like. Also, since the user is informed of the communication state by the sound from the speaker 50, the user can know the communication state of the printer 1 side (also containing the CF-type communication card 13) even when the user is at a position remote from the printer 1, the user is at a position where he or she cannot view the printer 1, or the like. Also, in the case where the user is informed only by turning ON the displaying portion 13b in different color, flickering the displaying portion 13b, etc., the user must know in advance which communication state is indicated by such display mode. However, since not a simple sound such as a chime sound, a buzzer sound, or the like but a mechanical synthetic sound of the language to explain the communication state by the human voice is employed as the sound that is emitted to inform of the communication state by the speaker 50, the user can be informed exactly of the communication state.

(1-18) The data reception state is also displayed on the screen 9a that is provided upward to the top surface of the main body 2 of the printer 1. Therefore, the user can know the communication state when he or she transmits the data from the position corresponding to the user's eye that is positioned higher than the printer 1.

(1-19) Since the error is informed by character information to give its content when the communication state is displayed on the screen 9a, the user can know with what cause the error is generated. Therefore, such a situation can be avoided that the user cannot know the cause of generating the error and then the user generates repeatedly the transmission error.

(1-20) The CF-type communication card 13 turns ON the displaying portion 13b in orange color when it completes the communication with the cellular phone 14. In this case, once the displaying portion 13b is turned ON in orange color and subsequently is turned ON/OFF in red color, the user can understand that the error occurs on the printer 1 side. Therefore, if the configuration that does not display even the error contents is employed, the cause of error can be specified to some extent based on how the lightened color of the displaying portion 13b is changed. For example, such change in lightened color is useful to specify the cause in the maintenance when the repair is requested by the user.

(1-21) In the present embodiment, upon introducing the infrared communication system, the IrDA profile processing portion 74 for converting the data format is provided to utilize (share) the raster processing portion in other communication system. That is, the image data in the vNote file attached format (encoded image data) are converted into the JPEG image data by Base64 decoder, and the personal information data in the vCard file format (text data) are converted into the XHTML data in the template-inserting description format. Therefore, the data that are subjected to the format conversion can be converted into the print data by passing such data through the data processing path that is shared with other communication system. As a result, upon introducing the infrared communication system into the printer 1, circuits and software to be added can be reduced as simply as possible.

(1-22) Since the infrared communication system can be installed into the printer 1 only by setting the CF-type communication card 13, in which the IrDA communication module is built, in the card slot 12 for the memory card, the printer 1 can be used as it is without a change of its casing. Therefore, since a change of a shape of the casing of the printer 1 is not required, a change of design of the casing and a change of manufacturing mold can be omitted. This can suppress an increase in production cost of the printer 1 caused by introducing the infrared communication system.

(1-23) The authentication code registering function that is implemented by the operation portion 10, the authentication code storing portion 151, and the authentication code managing portion 152 is shared with the BT communication portion 45c and the CF-type communication card 13. Therefore, there is no necessity for preparing the authentication code registering function every different communication system.

(1-24) The device for detecting a combination of the property and the value, which is one of the personal information data formats, as the division identifier is provided. Therefore, it can be automatically recognized whether the personal information data transmitted from the cellular phone are the data in the single case or the data in all cases.

(1-25) Since the personal information data of the cellular phone 14 are the vCard format file data, such data cannot be printed directly. But such data can be converted into the printable data by providing the device that converts the vCard format file data into the XHTML format data.

(1-26) The data can be classified into the single case data and all cases data. Therefore, the data can be converted into the data in the name-card template format if the data are the single case data whereas the data can be converted into the data in the phone-book template format if the data are all cases data.

(1-27) Also, the print layout can be automatically decided only by discriminating the single case or all cases of the data.

(1-28) Since the device for searching the division identifier is provided, all cases data can be divided into the case associated data and then processed. Also, since the personal information data in all cases can be processed every case, such data can be divided into the data in the single case and then printed in the name card layout.

(1-29) The name card layout can be changed according to the type of the vCard data. For example, the data can be printed in the company name card layout if only the data regarding the company are contained, while the data can be printed in the personal name card layout if only the private information are contained.

(1-30) The company name card layout, the personal name card layout, or the phone book layout can be selected by choosing the vCard data selectively.

(1-31) The personal information can be printed to have designated contents of the object in response to the information described in the memo area. In other words, the user displays the personal information menu of the cellular phone 14 and then writes the character information such as “a”, “b”, “c”, or the like into the memo box of the menu. The described character information are stored in the memo area of the personal information data. The digit described in the memo area is handled as the character to point the layout. When the personal information data transmitted from the cellular phone 14 are received, the digit stored in the memo area is discriminated and the layout is decided in response to the character. Thus, the personal information can be printed in the layout that is pointed by the memo area.

(1-32) Since the data prepared by the cellular phone 14 are transmitted to the printer 1, the name card printing can be easily executed by the printer solely. In case the name card on hand is out, the name card can be printed easily to the predetermined number of sheets by merely sending the data in the cellular phone 14 to the printer 1. In addition, because the data derived by managing the personal information essentially by the cellular phone 14 are utilized, it does not require a time to input newly the mentioned contents of the name card. Further, since the data in the vCard format in which the layout handled in the cellular phone 14 cannot be defined are converted into the data in the XHTML format in which such layout can be defined, the name card can be printed in the same layout as the normal name card. Moreover, since a plurality of types of name card templates are prepared, the name card can be printed in a desired layout.

(1-33) The printer 1 converts these data appropriately based on the data received from the cellular phone 14, and can print these data directly. Therefore, the data can be printed quickly rather than the case where the data are sent to the personal computer, then the data in the personal computer are stored into the storing medium such as the memory card, or the like, and then the data are loaded onto the printer 1 to print the data.

### Second Embodiment

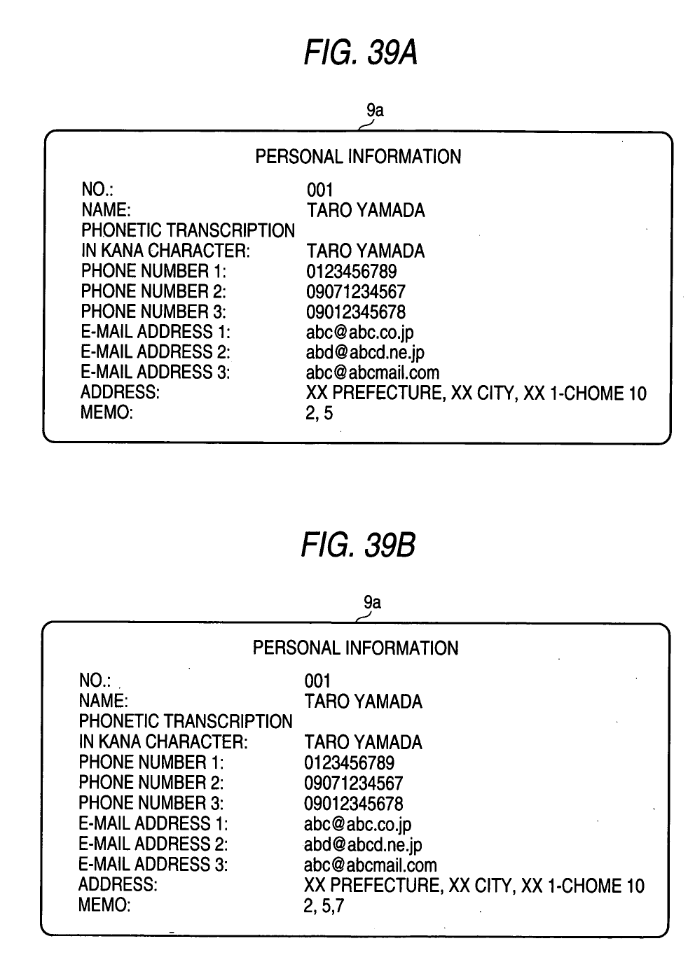

Next, a second embodiment of the present invention will be explained with reference to FIG. 39 hereunder.

This embodiment shows a variation in which a print parameter is designated by the information described in the memo area of the vCard file that is transmitted to the printer 1. The first embodiment shows an example in which the print layout is designated by the information described in the memo area. In contrast, this second embodiment shows an example in which other print parameter such as the designation of the number of printed sheets, or the like can be set by the information described in the memo area instead of the print layout designation. The present embodiment shows an example in which the print conditions are designated by applying other print conditions instead of the layout designation or in addition to the layout designation.

The print layout designation information can be selected in plural. The CPU 41 decides whether or not the description contents in the memo area correspond to the description of the designation of the print parameter.

The CPU 41 analyzes the description contents in the memo area to decide whether or not such description contents are in a predetermined description format or whether or not such description contents contain the character information except the symbols used in the designation, and the like. For example, it is promised that the alphabet of lowercase letters is also used as the character to designate the print layout and the characters are marked off by a comma when a plurality of layout designations are applied. Also, if the number of printed sheets is designated by the Arabic numeral and both the print layout and the number of printed sheets are decided, such an inputting format is employed that at first the information about the print layout designation are input, then a semicolon is inserted, and then the information about the number of printed sheets are input. In this manner, the rules regarding the predetermined print information designating method are stored in the EEPROM 43, and then the CPU 41 analyzes/processes the description contents in the memo area based on the rule information. In case the character information except the designation symbol, and the like are contained, it is possible that the designation symbol is not used for the purpose of designating the print parameter but the designation symbol is contained in the description as the mere memo. Therefore, in such case, it is decided that the designation is not given and then the default print parameters are set.

FIGS. 39A and 39B show an example of the personal information displayed on the display 18 on the cellular phone 14 respectively. The print conditions can be designated by describing the designation character or numeral in the memo area.

FIG. 39A shows an example of the personal information when the print layout and the number of printed sheets are pointed in the memo area. The rules under which the print conditions can be designated by the description contents in the memo area are set previously, and a plurality of print parameters can be designated. In this example, the number of printed sheets can be designated in addition to the print layout. As the rule of the designation, the designation information about the print layout and the designation information about the number of printed sheets are described while dividing them by a semicolon. For example, if the information such as “a;3”, or the like are input, the print layout is designated by “a” and the number of printed sheets is designated by “3 sheets”. When the personal information data designated in the memo area in this manner are transmitted to the printer 1, the CPU 41 picks up the description contents in the Note area of the vCard file, and analyzes the contents to search the description that coincides with the designation, i.e., the description such as “a;3” in which the alphabet and the digit are divided by the semicolon.

If “alphabet; digit” is found, it is searched whether or not other information are further described. If other information are described, it is decided that the description of “alphabet; digit” is not the designation of the print parameter but a combination of “alphabet; digit” is contained by chance in the description contents used as the essential memo. Of course, the rule to execute the designation by invalidating a line to which a special symbol is attached or conversely by validating only the line to which a special symbol is attached may be employed. For instance, the line in which the special symbol is given at its head is made effective as the designation if the description is given over plural lines and also “alphabet; digit” is set forth after the special symbol in a certain line, and then the description is decided as the designation if there is no character string other than the designation information. When doing this, the memo area is shared with the description of the essential memo and the description of the print parameter designation. As a result, it is possible to eliminate such an inconvenience that the memo contents must be erased temporarily when the print conditions are to be designated.

FIG. 39B shows an example of the personal information when three printing parameters can be appointed in the memo area. In the case where a plurality of print layout templates are prepared, the printing can be executed by designating plural layouts for one data. For example, the name card is printed with one personal information data in the single case in three name card layout templates PL2 to PL4, as shown in FIGS. 33A, 33B, 33C, respectively. When a plurality of layouts are designated, a rule of describing the layout designation symbols in the memo area to separate them by a comma “,” is adopted. For example, a plurality of layouts are designated by partitioning the designation symbols by using a comma like “a, b, c”. Of course, the designation to print plural sheets in plural layouts respectively may be applied. For example, such a rule is set down previously that, if the colon is given next to the symbol that is described subsequently to the last comma, the symbol described subsequently to the colon designates the number of sheets. Then, if “a, b, c, 5” is described, the CPU 41 knows that five sheets of name cards should be printed in three types of layout designated by “a, b, c” respectively. When the CPU 41 detects the description except the layout designation information (e.g., symbol), such CPU decides the description unavailable and then designates the “default”.

In the case where only one parameter out of the print parameters can designated in the memo box, the number of printed sheets, for example, may be designated in place of the print layout designation. For instance, if “2” is described in the memo box, two sheets of name cards on which the personal information are described respectively are printed. In this case, the default name card template stored previously in the EEPROM 43 is used as the print layout. Of course, in a situation that several types of printing parameters are set to be designated by operating the operation panel 8, a method of designating remaining one or plural printing parameters by the description in the memo box may be employed. For example, the number of printed sheets is designated by the description in the memo box, while the print layout is selected by using the operation panel 8 and registered directly into the printer 1. Also, it is possible to choose either the cut paper or the roll paper as the paper in the printer 1. In this case, it can be designated by the description information in the memo box whether the printing should be applied to the cut paper or the roll paper. In addition, the font type and the font size can also be designated by the description in the memo area.

The designation contents and the designating way defined by the description in the memo area in the vCard file are decided preciously. The CPU 41 specifies the designation contents by analyzing the description contents (description information) in the memo area in compliance with the defined designating way.

Then, an advantage of the second embodiment will be described hereunder.

(2-1) Since predetermined designation contents are described in advance in the memo area according to the predetermined description format, the printing parameters such as print layout, number of printed sheets, print paper, character information (font, size), etc. can be set. In this method, there is no necessity to add newly a designation input box, or the like because a rule as a memo area inputting method may be decided previously. Also, since simple symbols such as alphabet, numeral, etc. are used, the printing parameters can be designated simply. For example, the alphabet of small letters is used to set the type of the print layout, and Arabic numerals are used to decide the number of printed sheets, and others.

### Third Embodiment

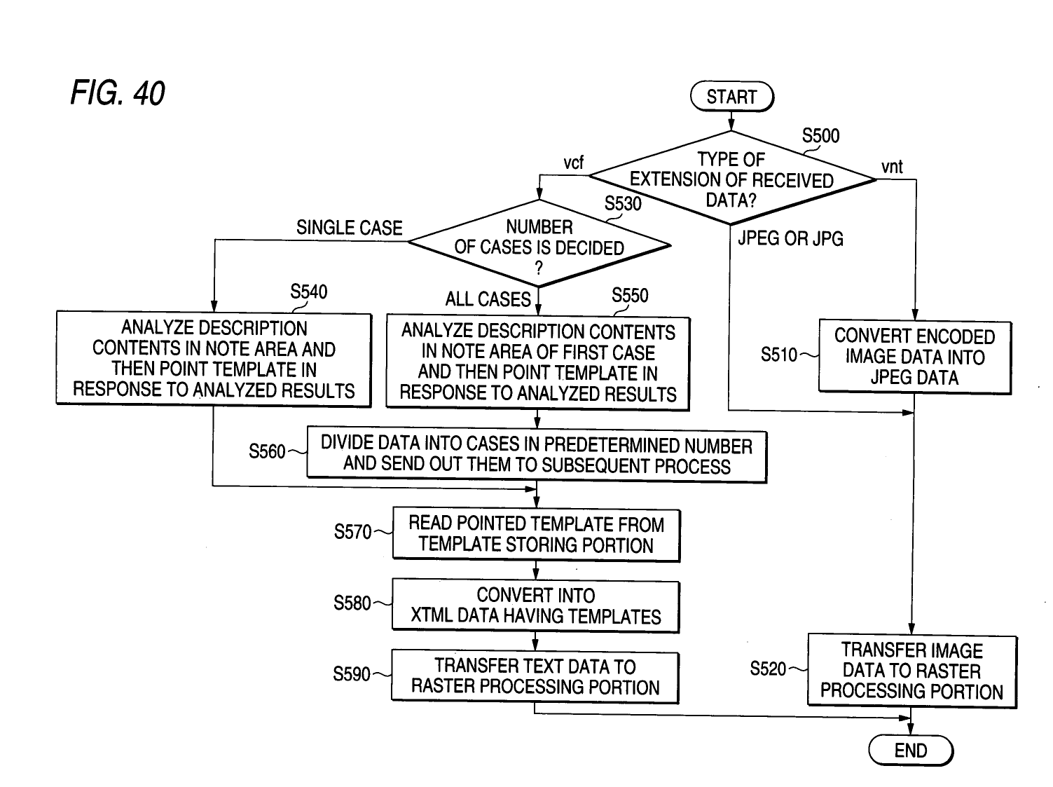

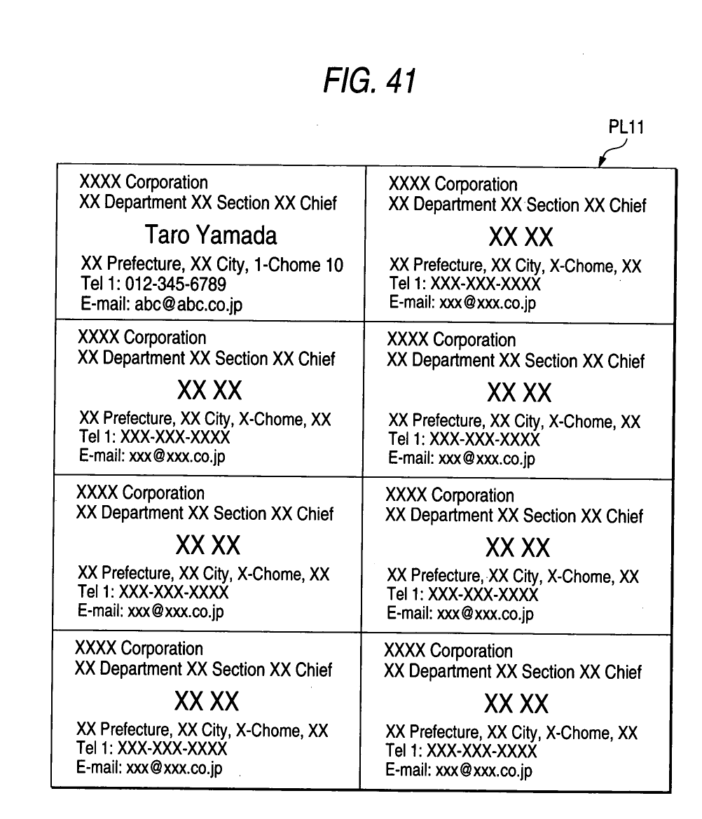

Next, a third embodiment of the present invention will be explained with reference to FIG. 40 and FIG. 41 hereunder.

This embodiment shows an example in which the layout of the data in all cases can be designated by the description information in the memo area. A template PL11 shown in FIG. 41 is stored further in the EEPROM 43. This template PL11 is used to print the name card of respective personal information contained in the data in all cases in the layout in which the name card is arranged one by one.

FIG. 40 is a flowchart showing the data processing in the IrDA profile processing portion 74. This flowchart is similar basically to the flowchart in FIG. 37 in the above first embodiment, but specifies the template, which is designated by analyzing the description contents in the Note area, with respect to the data in all cases.

In FIG. 40, processes that are similar to respective processes in S200 to S240 and S260 to S290 in FIG. 37 are executed in S500 to S540 and S560 to S590 respectively. A process in S550 is different from the first embodiment.

In S550, the description contents in the Note area of the personal information in the first case out of all cases are analyzes, and then the template is appointed in response to the analyzed results. For example, in the instructions manual of the printer 1, plural types of layout diagrams containing the phone book template PL10 in FIG. 33D and the name card template PL11 in FIG. 41 are set forth as the printing layout for all cases and also the numbers used to designate each of them are set forth to correlate with each other. Then, it is decided that, for example, the number used to designate the layout should be described in the Note area in the personal information in the first case that has the smallest register number in all cases. When the user prints the data in all cases, he or she inputs the number of the to-be-designated layout into the memo box of the personal information having the smallest register number among all cases. As a result, the designated number, e.g., “11” is described in the data transmitted from the cellular phone 14 as the value of the property “NOTE” in the first personal information. When the CPU 41 acquires the number “11” by analyzing the data, such CPU designates the template in the name card layout for plural cases in answer to the number “11”.

Then, in S570, the designated template PL11 is read from the template storing portion 86. In this manner, respective personal information data in the data in all cases are fitted into the name card layout (each layout frame) in the template PL11 shown in FIG. 41 case by case. Thus, the XHTML data having the name card layout are generated (S580).

Then, the raster process is applied to the text data (S590), and the resultant data are converted into the print data. Then, the printing process is executed by the print engine 77 based on the print data. Thus, plural cases of personal information are printed in the name card layout shown in FIG. 41.

Then, an advantage of the third embodiment will be described hereunder.

(3-1) Since the layout can be designated by the memo area with respect to the data in all cases, plural cases of personal information can be printed in a desired layout. For example, when the user wishes to print the name cards of all members or members belonging to a group by using the personal information in all cases, there is no necessity to transmit the data every case and thus a time required in printing directly the data from the cellular phone 14 can be saved.

### Fourth Embodiment

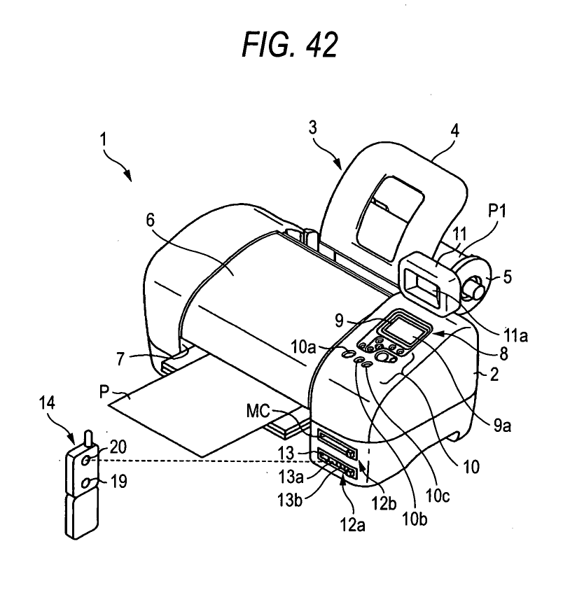

Next, a fourth embodiment of the present invention will be explained with reference to FIG. 42 to FIG. 44 hereunder.

FIG. 42 is a perspective view of a printer into which two CF card slots are provided. As shown in FIG. 42, two card slots 12a, 12b arranged at two stages vertically are provided to the right side lower portion on the front surface of the main body 2 of the printer 1. Each of two card slots 12a, 12b has the similar structure to that in the first embodiment, and both the memory card and the CF-type communication card 13 can be inserted into the slot selectively. For example, one card slot is used for the memory card, and the other card slot is used for the CF-type communication card into which the infrared communication function is installed.

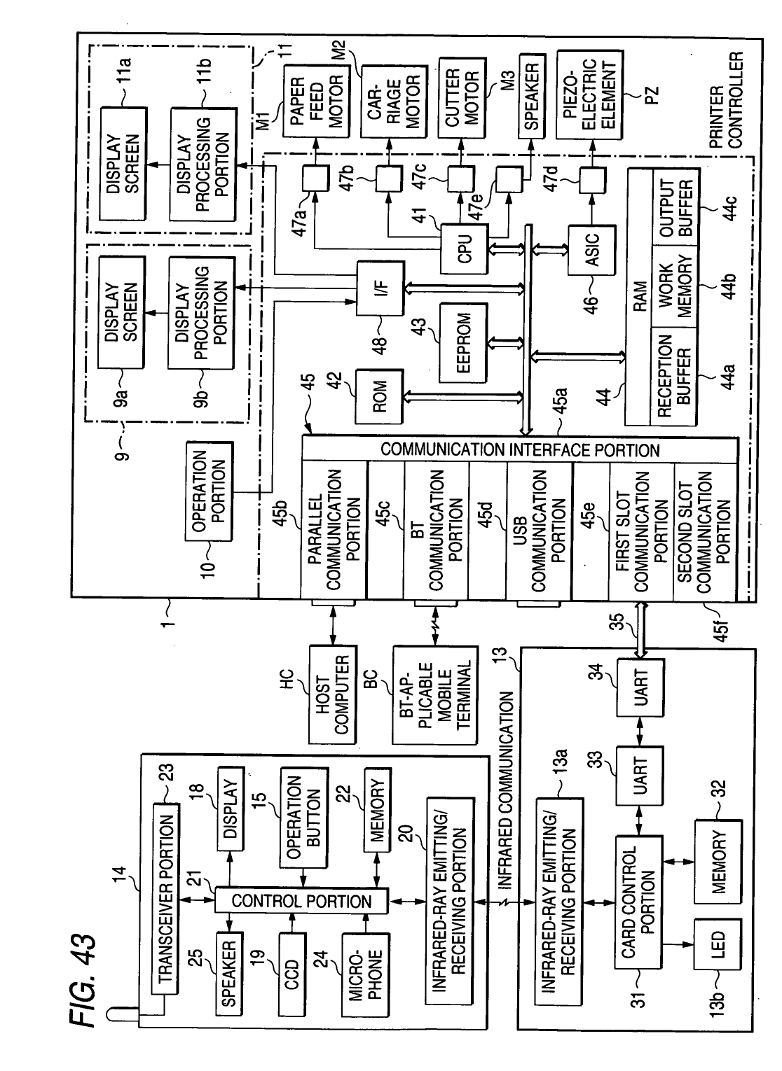

FIG. 43 show a block diagram of electrical configurations of the printer, the CF-type communication card, and the cellular phone. A different respect in the block diagram between the electrical configurations in FIG. 43 and FIG. 5 is that a second slot communication portion is provided to the printer side.

In this configuration, the CPU 41 decides the types of the cards inserted into the first card slot 12a and the second card slot 12b via the communication interface (I/F) portion 45 and the bus 49. The decision of the card type is made in compliance with the flowchart in FIG. 17.

In the case where the memory card MC is inserted into the first card slot 12a and the second card slot 12b, both cards function as the memory card. The CPU 41 receives the instruction that is selected by the user's operation of the operation portion 10, then reads the information of the selected memory card, and then save temporarily the information in the RAM 44. Then, the CPU 41 displays the image on the display screen in accordance with the user's instruction, or prints the data.

In the case where the CF-type communication card 13 is inserted into the first card slot 12a and the second card slot 12b, the CPU 41 controls the communication interface (I/F) portion 45 to open the port of the first slot communication portion 45e in the communication and close always the port of the second slot communication portion 45f.

In the case where the CF-type communication card 13 is inserted into the first card slot 12a and the memory card MC is inserted into the second card slot 12b, the CPU 41 decides which one of the data received from the CF-type communication card 13 and the information received from the memory card MC in response to the user's operation of the operation portion 10 is received first. As explained in FIG. 5, the CPU 41 instructs the card slots 12a, 12b to open the port to the data that arrive first at the communication interface (I/F) portion 45. This is similarly true of the case where the memory card MC is inserted into the first card slot 12a and the CF-type communication card 13 is inserted into the second card slot 12b.

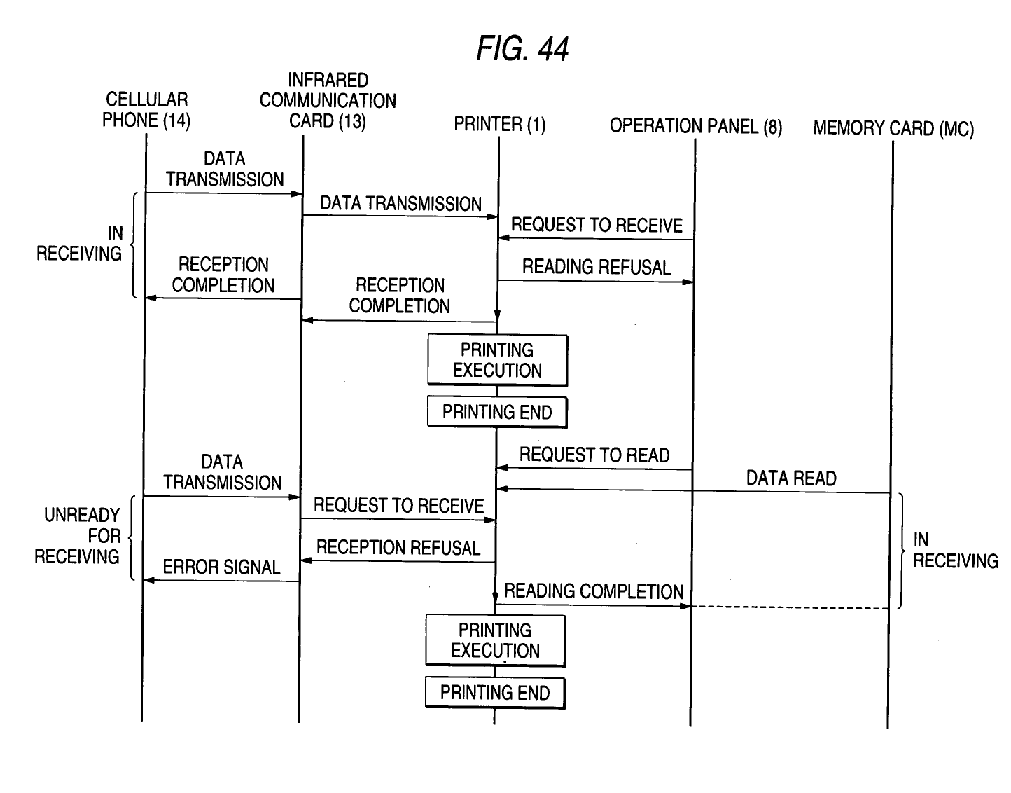

FIG. 44 shows a sequence diagram when the CF-type communication card and the memory card contend with each other.

First, on the top side in FIG. 44, when the data are transmitted from the cellular phone 14 to the infrared communication card (CF-type communication card) 13, such data are transferred from the infrared communication card 13 to the printer 1. The printer 1 when received the data transmits a notice of “reception completion” to the infrared communication card 13, and then the infrared communication card 13 transmits the notice data to the cellular phone 14. Since the notice of “reception completion” reaches the cellular phone 14, the user can confirm that the data could be transmitted to the printer 1 without fail. In this manner, the printing of the data transmitted from the cellular phone 14 can be executed. In contrast, even though the user tries to read the data from the memory card MC by operating the operation panel 8 after the printer 1 started to receive the data from the cellular phone 14, the CPU 41 rejects the reading of the data from the memory card MC. A state in which the data reading from the memory card MC is inhibited is continued until the notice of “reception completion” is transmitted after the printer 1 starts to receive the data.

In the lower side in FIG. 44, when the user operates the operation panel 8 oppositely to the upper side, the printer 1 reads earlier the data from the memory card MC. The printer 1 reads the data of the memory card MC and executes the printing. In contrast, the data transmitted from the cellular phone 14 are brought into the “unready for receiving” state until the data reading from the memory card MC is completed.

Therefore, after all a notice of “reception refusal” of the data transmitted from the cellular phone 14 is issued from the printer 1. Then, the cellular phone 14 is informed of the notice via the infrared communication card 13 as a receiving error message.

In the case where the infrared communication card 13 is inserted into the first card slot 12a and the memory card MC is inserted into the second card slot 12b, the printer 1 can print the data of the memory card MC. In this case, when the printer 1 receives the data from the infrared communication card 13 and is now printing the same data, such printer 1 cannot print the data. This is because the communication interface (I/F) portion 45 is controlled to close the receiving port for the data from the memory card MC. This control mechanism acts not only between the slot communication portions 45e, 45f but also among the parallel communication portion 45b, the BT communication portion 45c, and the USB communication portion 45d.

Then, advantages of the fourth embodiment will be described hereunder.

(4-1) In the printer in which two card slots 12a, 12b are provided, the infrared communication card 13 and the memory card MC can be inserted at the same time. Of course, two memory cards MC may be inserted, or two infrared communication cards 13 may be inserted.

(4-2) In the printer in which one slot is provided, it is decided which one of the memory card and the infrared communication card is inserted into the slot at a point of time when the card is inserted into the slot. Thus, both cards can be used in common.

(4-3) The function of converting the data in the vCard format in the infrared communication into the XHTML format that is the same as Bluetooth data is provided to the printer 1. Therefore, the subsequent print data converting functions can be shared with each other.

### Fifth Embodiment

In the first embodiment, the process of converting the vObject data in the vCard and the vNote into the XHTML data is carried out by the IrDA profile processing portion 74, etc. In contrast, the present embodiment shows an example in which a process of converting the whole vObject data containing the formats other than vCard and vNote into the XHTML data (referred to as a “vObject-XHTML converting process” hereinafter) is executed and then the vObject data transmitted from the cellular phone 14 are printed by the printer 1 in a predetermined layout. This vObject-XHTML converting process will be explained in detail hereunder.

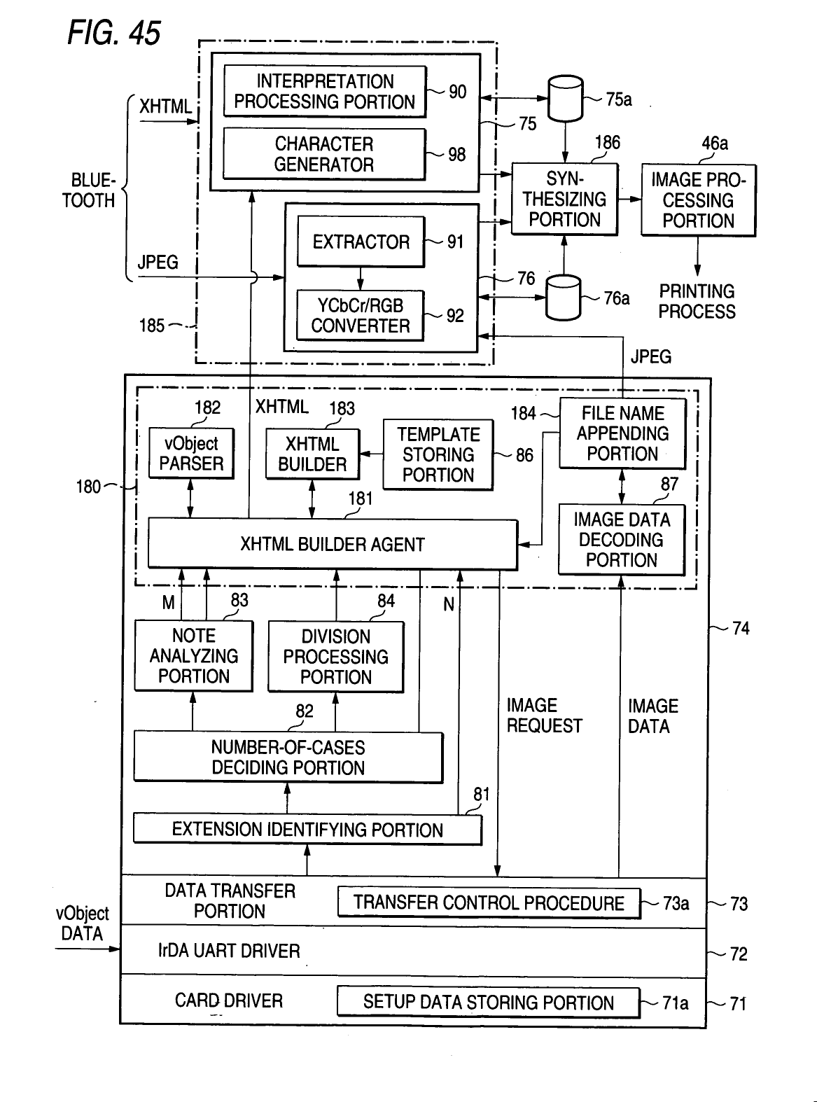

FIG. 45 is a block diagram showing functional configurations of portions concerning the vObject-XHTML converting process and other relevant portions. Here, in the vObject-XHTML converting process, the data in the format that is normally called vObject containing vCalendar, vMessage, vBookmark, etc. in addition to vCard and vNote are handled.

As shown in FIG. 45, a vObject-XHTML conversion processing portion 180 includes a XHTML builder agent 181, a vObject parser 182, a XHTML builder 183, the template storing portion 86, the image data decoding portion 87, and a file name appending portion 184.

First, the vObject data received by the data transferring portion 73 are send out to the extension identifying portion 81. Then, the extension identifying portion 81 identifies respective extensions “vcf”, “vnt”, “vcs”, “vmg”, “vbm” of vCard, vNote, vCalendar, vMessage, and vBookmark. Then, the extension identifying portion 81 sends the vCard data, perhaps which contains plural cases of data in one file, to the number-of-cases deciding portion 82, and sends directly the vNote, vCalendar, vMessage or vBookmark data to the vObject-XHTML conversion processing portion 180. Of course, the vObject data, which is likely to contain plural cases of data in the format except vCard, may be sent to the number-of-cases deciding portion 82 by registering its extension into the extension identifying portion 81. Here, configurations and process contents of the number-of-cases deciding portion 82, the Note analyzing portion 83, and the division processing portion 84 are similar to those in the above first embodiment.

The vObject-XHTML conversion processing portion 180 receives the vCard data in all cases (plural cases) from the division processing portion 84, and receives directly remaining vObject data from the data transferring portion 73. The vObject data contain only the text data, or contain only the image data, or contain both the text data and the image data. The vObject data that the vObject-XHTML conversion processing portion 180 received are first transferred to the XHTML builder agent 181.

Then, the XHTML builder agent 181 controls/manages the vObject parser 182, the XHTML builder 183, and so on. First, the XHTML builder agent 181 transfers the vObject data to the vObject parser 182 to cause it to analyze contents of the vObject data. Then, the vObject parser 182 analyzes (decodes) the contents of the vObject data to check (verify) the type of the vObject data (vCard, vCalendar, or the like), to acquire the property and the property value, to check whether or not the attached image is present, to acquire the described path (character string indicating the position at which the file is located) of the image if the attached image is present, and others.

The XHTML builder agent 181 transfers analyzed results received from the vObject parser 182 to the XHTML builder 183. At this time, if it is analyzed based on the analyzed results in the vObject parser 182 that the vObject data contain the image data, the XHTML builder agent 181 issues the instruction to the IrDA UART driver 72 to point the path of the image derived from the analyzed results and make the cellular phone 14 transfer the image data. Then, as the result of the image transfer request made in accordance with the instruction, when the image data are sent from the cellular phone 14, the data transferring portion 73 sends the image data to the image data decoding portion 87 designated by the XHTML builder agent 181. Of course, like the above first embodiment, the extension identifying portion 81 may send directly the vObject data containing only the image data without the text data to the image data decoding portion 87. In this case, the image data decoding portion 87 acquires the image data by causing the cellular phone 14 to transfer such data while designating the path of the image derived by analyzing the vObject data. Here, no file name is appended to the image data attached to the vObject data.

In the first embodiment, the image data decoding portion 87 executes the analysis of the data contents, and the like. In this embodiment, the image data decoding portion 87 executes merely the decoding process (Base64) of the encoded image data since the vObject parser 182 executes such analysis, and the like. The JPEG data obtained as the result of the decoding process are transferred from the image data decoding portion 87 to the file name appending portion 184.

The file name appending portion 184 appends a file name to the JPEG data received from the image data decoding portion 87 and then sends the resultant data to the image-data raster processing portion 76. In other words, the image data decoding portion 87 stores the JPEG data into the buffer 76a and also informs the image-data raster processing portion 76 of the effect that the JPEG data serving as the subject of process are stored into the buffer 76a. In the present embodiment, the raster processing portion for executing the raster process of the data, the layout of the text and the image in which is designed on the same page, is constructed as one raster processing portion 185 containing the text-data raster processing portion 75 and the image-data raster processing portion 76.

Meanwhile, when the XHTML builder 183 received the analyzed result of the vObject data derived by the vObject parser 182 from the XHTML builder agent 181, it reads the template corresponding to the information from the template storing portion 86, based on the designation character information M acquired from the Note analyzing portion 83 or the layout designating information acquired by a later-described method. The template is described in the XHTML language. The XHTML builder 183 biulds up the XHTML data by incorporating respective property values contained in the analyzed result into proper locations of respective properties in the template.

For example, in the case of the vCard data (see FIG. 26), the property values such as “Taro Yamada”, “ [symbol] [symbol] ”, “0123456789”, etc. are incorporated into respective pointed positions of the properties in the name card printing template format data LT1 shown in FIG. 29. Also, in the case of the image-attached vObject data, the file name used as the path indicating the stored destination of the image data (JPEG data) after the decoding process is described in the corresponding location in the template (XHTML layout data). Of course, if the image data storing format is the folder hierarchical structure, the path indicating a hierarchical structure is described. For example, in the case of the image-attached vCard data, the property values such as “Taro Yamada”, “ [symbol] [symbol] ”, “0123456789”, etc. are incorporated into the image-attached name card printing layout template LT2 in FIG. 30 and also the path of the image data (e.g., the file name “photo.jpg” appended by the file name appending portion 184) is incorporated into the position of the file name “photo.jpg” in the data in FIG. 30. Of course, if the data are stored as the folder hierarchical structure, the path indicating a hierarchical structure is incorporated into the position. In this case, the path of the image data used when the XHTML builder 183 builds up the XHTML data is obtained from the file name appending portion 184 via the XHTML builder agent 181.

Also, the conversion of the vObject data into the XHTML data is executed every one data. In this case, if the vCard data are the data in all cases (plural cases), such data are converted into the XHTML data every case since such data are divided by the division processing portion 84 and then output to the vObject-XHTML conversion processing portion 180 every case.

As the layout designating method of designating the template used in the XHTML builder 183, in the first embodiment, the designating method of describing the value M such as the number decoded by the Note analyzing portion 83, or the like into the Note area or the designating method of deciding the template to correlate uniquely with the template is employed. That is, the template corresponding to the value M such as the number acquired from the Note analyzing portion 83, or the like is read, otherwise the name card layout template is uniquely read if the vCard data in all cases have the extension “vcf”. In contrast, in the present embodiment, another layout (template) designating method except these designating methods is also employed.

Then, another layout designating method will be explained hereunder. First, a method of designating the layout by using an order sheet will be explained hereunder. The order sheet is used in a scanner built-in printer (composite machine). Various set contents are set into the printer when the contents printed on the order sheet are read by the scanner.

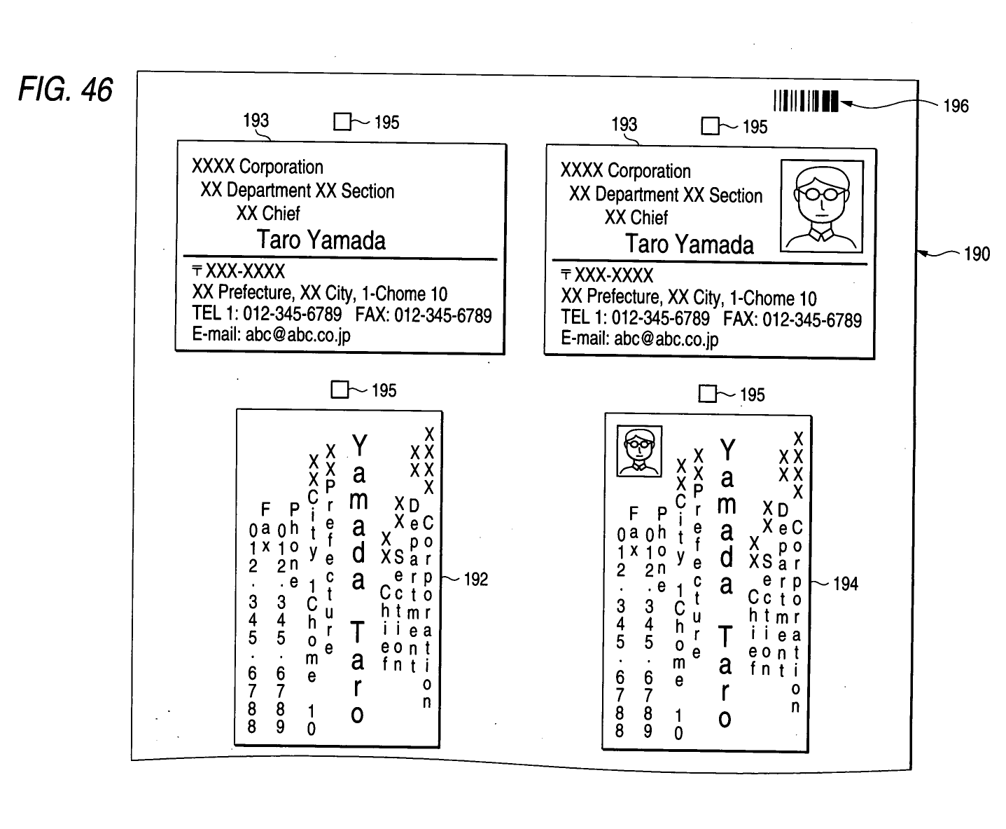

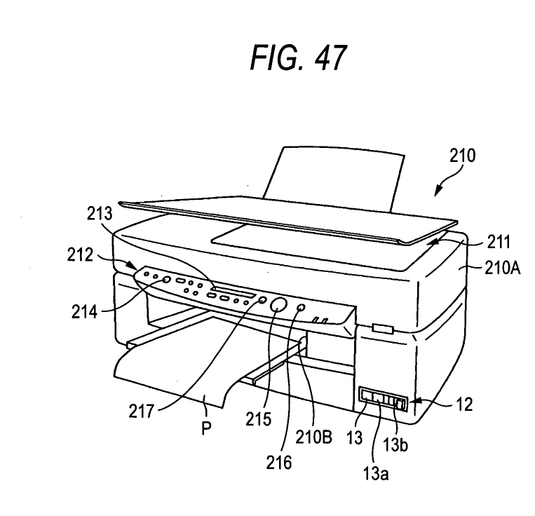

FIG. 46 is a plan view of the order sheet. Also, FIG. 47 is a perspective view of a scanner built-in printer (composite machine). An order sheet 190 is a sheet (paper) on which a plurality of layouts 191 to 194 (in this example, only four layouts are illustrated) and a check box 195 provided to correspond to each of the layouts 191 to 194 are printed. A bar code 196 is printed on the upper right portion of the order sheet 190. The layout designation used to print the vObject data received from the cellular phone 14 can be recognized by reading the bar code 196. In this example, four layouts, i.e., a laterally oriented name card layout 191 containing the text only, a vertically oriented name card layout 192 containing the text only, a laterally oriented name card layout 193 containing the text and the image, and a vertically oriented name card layout 194 containing the text and the image, are printed on the order sheet 190.

FIG. 47 is a perspective view of the printer (composite machine) having three functions of the scanner, the printer and the copying machine. A printer 210 has a scanner portion 211 in a main body 210A, and has a scanner function, a printer function, and a copying function of printing the image that are obtained by converting the image data read by the scanner portion 211 into the print data in the inside. The paper P that is printed by the printer 210 is discharged from a paper discharge port 210B that is opened on the lower side of the front surface of the main body 210A.

An operation panel portion 212 is provided to the main body 210A of the printer 210. Various operation switches such as an LCD (liquid crystal device) 213 as the display portion and a menu button 214, a print execution button 215, a copy button 216, a scanner button 217, etc. as the operation portion are arranged on the operation panel portion 212. Also, the same CF card slot 12 as the first embodiment is provided to the front surface of the main body 210A of the printer 210 in the position that satisfies positional conditions described in the first embodiment. Then, the same CF-type communication card 13 as the first embodiment is inserted into this card slot 12.

A CPU built in the printer 210 executes control programs stored in memories such as ROM, etc. (all not shown) to implement various functions of the scanner, the printer, the copying machine, etc. Also, print data of the order sheet 190, a bar code recognizing process program to execute the bar code recognizing process, a check box deciding program to decide the check box 195 against which a check mark is put, etc. are stored in the memory. An order sheet list is displayed on the LCD 213 by operating the operation switch, then the order sheet containing a desired layout is selected among the lists, and then the order sheet 190 is printed by pressing the print execution button 215. That is, when the CPU detects the pressing of the print execution button 215, such CPU executes the printing process of the order sheet that is selected at that time. In addition to the method of selecting and printing the order sheet 190 in response to the user's operation of the operation switch of the printer 210, a method of printing the order sheet selected by the operation of a keyboard or a mouse by causing a host computer to execute an order sheet designation program, which is installed as a printer driver or a part of a printing software, may be employed.

When the user gets the order sheet 190 in this manner, he or she selects/designates the layout by putting the check mark against the check box 195 (e.g., by filling up an inside of a frame thickly). Then, the user sets the order sheet 190, against which the check mark is put, on a scanner surface of the scanner built-in printer (referred to as the “printer 210” hereinafter), and then causes the scanner portion 21.1 to read the order sheet 190 by pressing the scanner button 217.

The CPU of the printer 210 reads the bar code 196 that the scanner portion 211 reads from the order sheet 190, and then recognizes that the scanning of the order sheet 190 is executed for the purpose of designating the layout in printing the data received from the cellular phone 14. Then, the scanner portion 211 specifies the check box 195, which is read from the order sheet 190 and against which the check mark is put, by the image processing and then recognizes the layout that is designated by the user. Various layouts and corresponding templates are stored in the memory such as the EEPROM, or the like in the printer 210. The CPU of the printer 210 stores the layout designation information being correlated with the layout in the memory as soon as such CPU recognized the layout designated by the user. Then, when the XHTML builder 183 builds up the XHTML data, such portion reads the layout designation information stored in the memory and reads the template corresponding to the layout designation information from the template storing portion 86.

Here, the method of causing the printer 210 to understand that the order sheet 190 is used for the purpose of designating the layout upon printing the data received from the cellular phone 14 is not limited to the designation given by the bar code 196. For example, in a situation that the printer 210 is constructed to be switched to a print layout designation mode that is applicable to the cellular phone (referred to as a “layout designation mode” hereinafter), a method of recognizing that a designated layout corresponds to the layout designated in printing the data transmitted from the cellular phone 14 when the order sheet 190 is read in this layout designation mode may also be employed.

As the method of switching the printer 210 into the layout designation mode, there may be listed a method that the printer 210 automatically recognizes to switch itself into the mode and a method that the user operates the operation switch to switch the printer 210 into the mode. According to the automatically recognizing method, the printer 210 is switched to the layout designation mode when the reception of the vObject data from the cellular phone 14 is ended, and then the scanner portion 211 is caused in this mode to read the order sheet 190. In contrast, according to the mode switching method by the switch operation, a mode selection list is displayed on the LCD 213 by operating the operation switch of the printer 210, and then the printer 210 is switched to the layout designation mode by selecting the layout designation mode among the list. Then, the scanner portion 211 is caused in this mode to read the order sheet 190.

In addition, as other layout designating method, a method of designating the layout by causing the scanner portion 211 to read the name card may be employed. When the scanner portion 211 reads the name card that is set as a sample on the scanner surface, the CPU of the printer 210 analyzes the image data of the name card to separate the data into the text and the image, and recognizes respective items such as company name, official title, name, phone number, FAX number, E-mail address, etc. by reading the description contents of the text (e.g., all character strings in that one line or the character string of the key word in that one line) or analyzing the arrangement relationship to the character strings in other lines. For example, the company name is decided by checking whether or not the character string “Inc.” is contained in that one line, and the name is decided by checking whether or not the character string that coincides with the previously registered “family name” or “given name” corresponding to “family name” or “given name” is present in that one line, whether or not the character that coincides with the registered character “o( [symbol] )”, “rou( [symbol] )”, “ko( [symbol] )”, etc., whose frequency of use in the name is high, is present as the last character, or the like. Also, the phone number is decided by checking whether or not the character string that coincides with the registered character string such as “TEL”, “tel”, or the like is present, the facsimile is decided by checking whether or not the character string that coincides with the registered character string such as “FAX”, “fax”, or the like, and the E-mail address is decided by checking whether or not the character string that coincides with the registered character string such as “E-mail”, “@”, “co.jp”, or the like. Then, the template (XHTML layout data) in which the description areas of respective items such as company, official title, name, phone number, etc. in the name card are text arrange areas, in which respective property values in the vObject data are arranged, is generated.

Once the template corresponding to the layout designated in this way is decided, the XHTML builder 183 builds up the XHTML data by incorporating the property values (texts), which are obtained when the vObject parser 182 analyzes the vCard data received from the cellular phone 14, for example, into the arrangement areas that correspond to respective properties in the template.

Then, when the XHTML data are built up, the XHTML builder agent 181 outputs the XHTML data to the interpretation processing portion 90 in the text-data raster processing portion 75. For example, in the case of the data in all cases, the XHTML data are sent out one case by one case to the interpretation processing portion 90 every time when the data are built up in the XHTML builder 183. The interpretation processing portion 90 interprets contents of the XHTML data and specifies the arrangement positions (print positions) of the text and the image on the paper area. Then, the interpretation processing portion 90 incorporates the texts (character strings) generated by the character generator 98 into the designated arrangement positions in the paper area. Also, in the image data raster processing portion, the JPEG data stored by the file name appending portion 184 are read from the buffer 76a and then the expanding process, the YcbCr/RGB converting process, etc. are applied to the read JPEG data by the JPEG extractor 91, the YcbCr/RGB converter 92, etc. Now, these processes in the raster processing portion 185 are basically similar to those in the first embodiment.

The text-data raster processing portion 75 and the image-data raster processing portion 76 constituting the raster processing portion 185, when end the process respectively, inform a synthesizing portion 186 of the instruction to start the process. Of course, in case the vObject data contain either the text only or the image only, the synthesizing portion 186 is informed of the instruction to start the process as soon as the single process is ended. When the synthesizing portion 186 received the instruction to start the process, it reads the data processed by the text-data raster processing portion 75 from the buffer 75a to check whether or not such data were originally the image-attached data. Then, if such data were originally the data to which the image is attached, the synthesizing portion 186 reads the image data designated by the path from the buffer 76a based on the path (in this example, file name) described in the data. Then, the synthesizing portion 186 synthesizes one RGB multi-valued image data by incorporating the images read from the preceding path into the data, in which the texts (character strings) read from the buffer 75a every property are assigned, in their layout positions and then sends such image data to the image processing portion 46a. The process in the image processing portion 46a is similar to that in the first embodiment.

vCalendar Data Converting Process

As the vObject data that the printer 1 can deal with, as described above, the vCalendar data, the vMessage data, and the vBookmark data may be listed in addition to the vCard data and the vNote data. In the present embodiment, a function of generating/printing a schedule sheet a day from the vCalendar data by analyzing the description contents of the vCalendar data, and a function of generating/printing a checklist sheet to check the matter to be processes on a particular day (e.g., today) (“TODO matter”) from the vCalendar data are provided. These two functions will be explained hereunder.

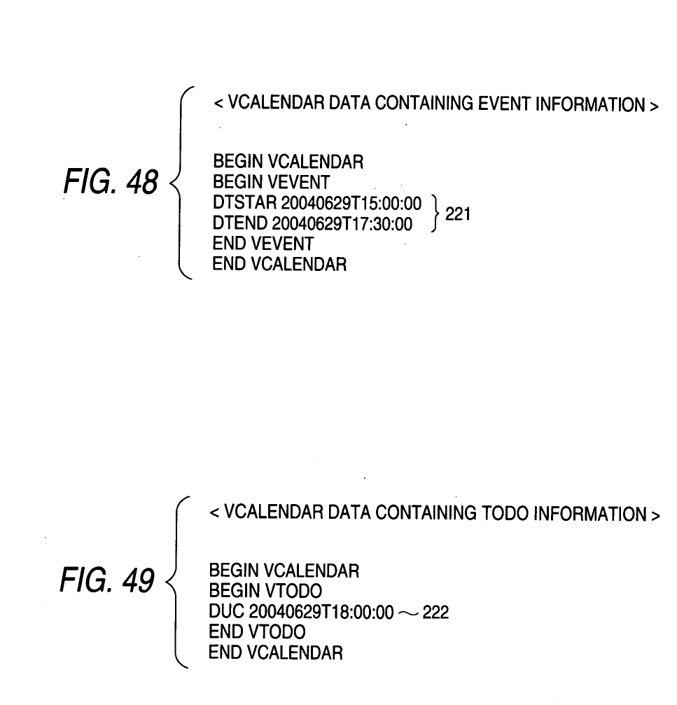

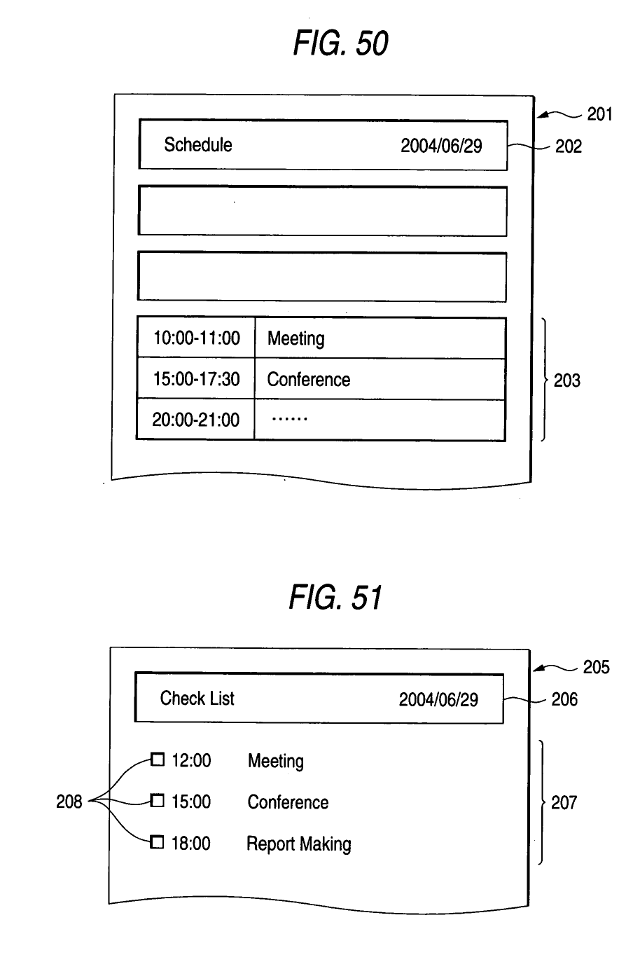

FIG. 48 is a view of the vCalendar data containing event information, and FIG. 49 is a view of the vCalendar data containing TODO information. Also, FIG. 50 is a plan view of the schedule sheet, and FIG. 51 is a plan view of the checklist sheet.

In a time appoint area 221 in the vCalendar data shown in FIG. 48, “DTSTAR” is the property indicating an event start time, and the particular content of the event start time as the property value is displayed by year, month, day, hour, minute, and second on the right side of this property. In this example, the event start time is described like “20040629T15:00:00”. Also, “DTEND” in the next line is the property indicating an event end time, and the particular content of the event end time as the property value is displayed by year, month, day, hour, minute, and second on the right side of this property. In this example, the event end time is described like “20040629T17:30:00”. Also, in addition to the event start time and the event end time, the property indicating the event contents and the value (not shown) are described in the vCalendar data containing event information. As the value of the property indicating the event contents, the texts (character strings) indicating the particular contents of the event such as “meeting”, “conference”, etc., which are written by the user, are described. In many cases, the vCalendar data contain plural cases of such event data.

Also, in a time appoint area 222 in the vCalendar data shown in FIG. 49, “DUC” is the property indicating a TODO start time to start the to-be-executed matter, and the particular content of the TODO start time as the property value is displayed by year, month, day, hour, minute, and second on the right side of this property. In this example, the event end time is described like “20040629T18:00:00”. Also, in addition to the TODO start time, the property indicating the TODO contents and the value (not shown) are described in the vCalendar data containing the TODO information. As the value of the property indicating the TODO contents, the texts (character strings) indicating the particular TODO contents such as “meeting”, “conference”, “report making”, etc., which are written by the user, are described. In many cases, the vCalendar data contain plural cases of such TODO data.

A schedule sheet 201 shown in FIG. 50 is printed by the printer 1 or 210 that received the vCalendar data from the cellular phone 14. Upon printing this sheet, a schedule sheet forming mode is selected/appointed in the printer 1 or 210. As shown in FIG. 50, the schedule sheet 201 has a title box 202 and a schedule list box 203. A title “schedule” and an objective day “2004/06/29” in the schedule are printed in the title box 202. Also, the event start time and the event end time are printed like “15:00-17:30” on the left column in the schedule list box 203, and the event contents are printed like “conference”, for example, on the left column.

Also, a checklist sheet 205 shown in FIG. 51 is printed by the printer 1 or 210 that received the vCalendar data from the cellular phone 14. Upon printing this sheet, a checklist sheet forming mode is selected/appointed in the printer 1 or 210. As shown in FIG. 51, the checklist sheet 205 has a title box 206 and a checklist area 207. A title “checklist” and an objective day “2004/06/29” in the checklist are printed in the title box 206. Also, check boxes 208 are printed on the left end position in the checklist area 207, the start time is printed like “12:00”, for example, on the next right side of the position, and the TODO contents are printed like “meeting”, for example, on the further right side. In the present embodiment, in the schedule sheet forming mode or the checklist sheet forming mode, the layout corresponding to the mode is automatically selected by the CPU. In this case, the user may select/appoint the predetermined layout among a plurality of layout templates stored previously in the memory by operating the operation switch or by causing the scanner portion 211 to read the order sheet. Also, in addition to the schedule sheet forming mode and the checklist sheet forming mode, a mode of printing both the schedule sheet and the checklist sheet from the vCalendar data at a time may be set. In addition, such a method may be employed that, when the printer 1 or 210 receives the vCalendar data, the built-in CPU analyzes the contents of the vCalendar data and then generates and prints the schedule sheet 201 if the event data (event information) are contained, and then generates and prints the checklist sheet 205 if the TODO data (TODO information) are contained.

The schedule sheet layout template and the checklist sheet layout template are stored in advance in the memory such as the EEPROM, or the like in the printer 1 or 210. The layout template is described in the XHTML language, and the arrangement areas (incorporating areas) of the texts as respective property values (e.g., “12:00”, “conference”) in the vCalendar data are set in the layout template.

The CPU of the printer 210, when received the vCalendar data containing the event information of this type, extracts the events on the same day by checking year, month, and day in the event start time sequentially (in order of user's input) from the top of the data, and then incorporates such events into the arrangement areas in the schedule list box 203 in the schedule sheet layout template to print one page. In this case, two methods described in the following can be listed as the approach of classifying the events on the same day into groups and extracting them from the vCalendar data.

First, as a first method, there is a method of putting all continued days together in a list of the same year, month, and day when the same day appears continuously as the event start year, month, and day. For example, when three events appear continuously on the same day “20040629”, the schedule sheet in which three continued events are listed on that day is formed and printed. In this case, when the continuation of that day is disconnected by the presence of the event on other day “20040630” and then the same day as the above continued day appears again after the disconnection, the event on the same day is printed on another schedule sheet. Next, as a second method, there is a method of extracting all events on the objective day on the schedule sheet by searching all the events, and then forming and printing the schedule sheet in which the extracted events on the same day are listed as the events on that day. According to this method, even though the same days do not appear continuously, all the events on the same day can be printed on one schedule sheet.

The data converting process is carried out in the vObject-XHTML conversion processing portion 180 as follows. For example, in the case where the XHTML data in the schedule sheet 201 in FIG. 50 are formed, the template is read and then the year, month, and day “20040629” in the event start time is incorporated into the date arrangement area positioned on the upper right portion of the sheet in the description form of “2004/06/29”. Also, the hour and minute “15:00” in the event start time and the hour and minute “17:30” in the event end time are incorporated into the time period arrangement area on the left side in the schedule list box 203 in the description form of “15:00-17:30”. Then, the event contents are incorporated into the event content arrangement area on the right side in the schedule list box 203.

Also, for example, in the case where the XHTML data in the checklist sheet 205 in FIG. 51 are formed, the template is read and then the year, month, and day “20040629” in the TODO start time is incorporated into the date arrangement area positioned on the upper right portion of the sheet in the description form of “2004/06/29”. Also, the hour and minute “18:00” in the TODO start time is incorporated into the start time arrangement area as the right-side area of the check box 208 positioned on the left end portion in the checklist sheet 205 in the description form of “18:00”.

These processes are executed by the vObject parser 182 and the XHTML builder 183. That is, the vObject parser 182 analyzes the contents of the vCalendar data. The XHTML builder 183 builds up the XHTML data by reading the corresponding template from the template storing portion 86 and installing the analyzed result by the vObject parser 182 into the corresponding position in the template.

Here, in the case where the number of cases of the event or the TODO matter contained in the vCalendar data is large and the data extend over plural pages when the event contents or the TODO contents are incorporated into the specified layout template, for example, following processes are also applied to include them in one page if possible. First, a method of changing the layout is applied. The layout is changed to another layout that can compress the description contents in the vertical direction, for example, decrease a line spacing, or the like. In this case, plural types of layout templates in which a line spacing is differently set respectively to permit the layout change are stored previously in the memory. Second, a method of reducing the font size is applied. Even if the data extend over plural pages after the layout is changed, the number of lines in one page is increased by reducing the font size. One or both of these two methods are used together to apply the layout or the font size that permits the data in one page if possible.

At this time, the CPU of the printer 1, 210 executes a visibility deciding process to decide whether or not the visibility is good when the layout is changed into the compressed layout or the font is changed into the font having the smaller size. The quality of the visibility is decided based on relationships among the previously set line spacing, character spacing, and font size to prevent the situation that the layout is compressed excessively by the change of the layout or the size of the character is decreased excessively by the change of the font size to worsen the visibility conspicuously. Therefore, such a disadvantage can be suppressed that, since the line spacing is extremely decreased in the layout or the size of the characters is extremely decreased, it is difficult for the user to read the printed contents on the schedule sheet 201 and the checklist sheet 205.

Then, advantages of the fifth embodiment will be described hereunder.

(5-1) The contents of the data (property values) can be printed with layout frames by transmitting the vObject data from the cellular phone 14 to the printer 1, 210.

(5-2) The layout can be designated by causing the scanner portion 211 to read the order sheet 190. Therefore, even in the configuration like the printer 1, 210 in which the number of the operation switches, and others is small rather than the keyboard, or the like and thus the operability is not good, the user can designate the desired layout selected from plural layouts by the relatively simple operation.

(5-3) The schedule sheet 201 can be printed by transmitting the vCalendar data from the cellular phone 14 to the printer 1, 210.

(5-4) The checklist sheet 205 can be printed by transmitting the vCalendar data from the cellular phone 14 to the printer 1, 210.

(5-5) When the schedule sheet 201 or the checklist sheet 205 cannot be printed on one page, the change of the layout or the change of the font size is applied to the data to print the sheet on one page. Therefore, the case where the sheet is printed to extend over plural pages can be reduced as small as possible. Also, since the visibility deciding process is executed in changing the layout or the font size, the change of the layout or the change of the font size is never executed to such an extent that the visibility becomes worse. As a result, the schedule sheet 201 or the checklist sheet 205 can be printed in the easy-see layout in the clear character size.

Then, variations of the informing process of the data receiving state in the displaying portion in the first embodiment will be set forth hereunder.

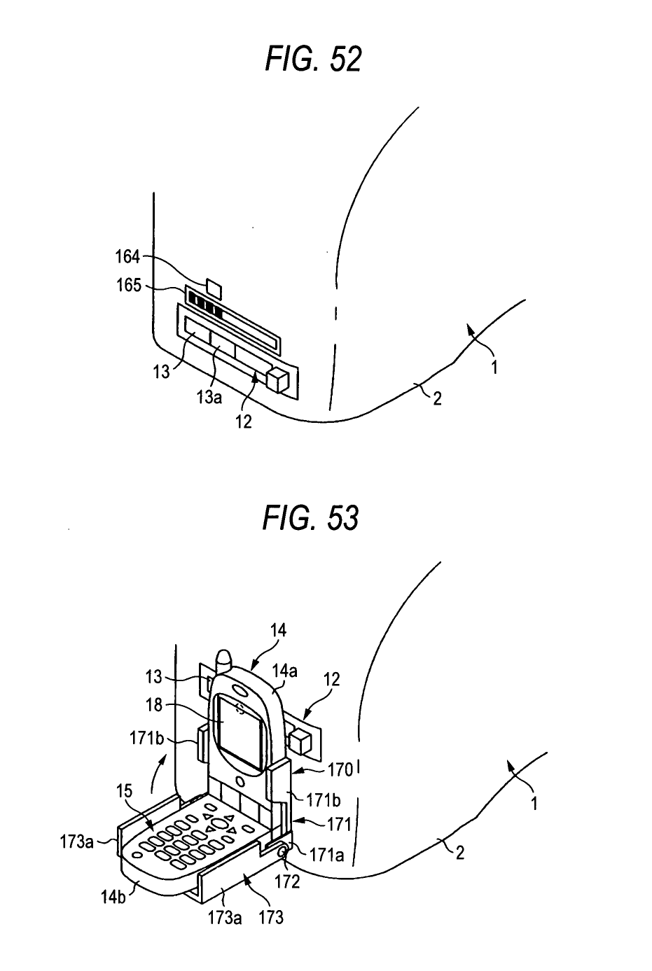

(Variation 1) As shown in FIG. 52, a display portion 164 having the LEDs 161, 162 (see FIG. 12) and an indicator 165 are provided to the main body 2. The display of the indicator 165 is controlled by the CPU 41 to indicate the progress of the data reception. The CPU 41 calculates a total time required to receive the entire data, based on the data size acquired from the header of the data and a communication speed decided for every cellular phone 14 that is recognized as the other end of the communication. Then, the CPU 41 calculates an occupying rate of a counted time of a timer, which starts its counting operation from the start of the data reception, to the total time required and causes the indicator 165 to display it.

The indicator 165 is composed of a liquid crystal screen or an LED series, for example, and is lightened to indicate an amount of receiving progress that is proportional to a rate of time that has been consumed to receive the data. Of course, in the case of the liquid crystal screen on which the numerical value can be displayed, a remaining time can be displayed by the numerical value. The indicator 165 is arranged in the position that can satisfy the same positional conditions as the displaying portion 13b, explained in the first embodiment, with respect to the infrared-ray receiving/emitting portion 13a. For example, the infrared-ray receiving/emitting portion 13a, the displaying portion 13b, and the indicator 165 are arranged to enter into the same field of view of the user (operator) who holds, the cellular phone 14 and operates it to transmit the data (particularly, in a range in which the user can check these portions without movement of the user's eye).

(Variation 2) As shown in FIG. 53, a holder 170 for holding the cellular phone 14 is provided to the main body 2 of the printer 1. In this case, the communication port 13a is arranged in the position at which such port can communicate with the cellular phone 14 held in the holder 170. Also, the displaying portion 13b is arranged in the position that is not in hiding between the cellular phone 14 held in the holder 170 and the holder 170 and the main body 2. FIG. 53 shows an example in which the infrared-ray emitting/receiving portion 20 is provided to the back surface of the cellular phone 14 and the cellular phone 14 can be held in a state that the phone is opened at an angle of about 90 degree. The holder 170 has a first holder portion 171 fixed onto the front surface of the main body 2 at the lower portion of the card slot 12, and a second holder portion 173 fitted swingably to a supporting portion 171a extended forward from the lower portion of the first holder portion 171 via a pin 172. The first holder portion 171 has a pair of holder portions 171b that hold a body portion 14a of the cellular phone 14 on the display 18 side from both sides. Meanwhile, the second holder portion 173 has a pair of holder portions 173a that supports a body portion 14b of the cellular phone 14 on the operation button 15 side and hold the body portion 14b from both sides. According to this configuration, since the data can be transmitted from the cellular phone 14 held in the holder 170 as it is, the user need not to hold the cellular phone 14 during the data transmission as it is. Therefore, the transmission error caused by movement of the hands is hard to occur. Also, since the holder 170 and the cellular phone 14 held in the holder 170 never cover the displaying portion 13b, the user can check the communication state by the displaying portion 13b. In this case, such a structure can be employed appropriately as the holder that permits the cellular phone 14 to execute the radio communication between the infrared-ray emitting/receiving portion 20 of the cellular phone 14 and the infrared-ray receiving/emitting portion 13a of the CF-type communication card 13 inserted into the card slot 12 and also holds the cellular phone 14 not to hide the displaying portion 13b. For example, a pocket-sized holder into which the cellular phone 14 can be inserted, a holder of a type that can hold the cellular phone 14 in a state that its side surface opposes to the card slot 12, etc. may be employed.

(Variation 3) In the above embodiments, the displaying portion 13b informs the user of the error, but does not inform the user of the contents of the error. In this case, the displaying portion may be constructed in such a manner that it can inform the user of the contents of the error to make the user know the type of the error. For example, the user is informed of different error contents by turning ON and ON/OFF the displaying portion in red color.

(Variation 4) In the above embodiments, the data receiving state is informed by both the display mode (lightening mode) on the displaying portion of the CF-type communication card 13 and the display of the characters and pictures on the displaying portion of the operation panel. In this case, only either one may be employed. Also, the informed contents may be shared with these two parts.

(Variation 5) In the above embodiments, the user is informed by the display, but the error may be informed by the display and the sound. For example, the sound is emitted in any one of the data receiving state, the receiving error state, and the data receiving completion. The user can know that the data reception is going well if the sound is emitted during the data reception, the user can know that the data reception is failed if the sound is emitted at the time of the receiving error, and the user can know that the data reception is completed if the sound is emitted at the time of the data receiving completion.

(Variation 6) The displaying portion may be provided to not the CF-type communication card 13 but the main body 2. The communication port is provided at the position of 10 cm or less from the bottom surface of the main body on at least one side out of both sides of the paper discharging port on the front surface of the printer 1.

(Variation 7) A part or all of the communication interface portion may be incorporated into the CF-type communication card 13 as the radio communication device. For example, the card driver 71 and the data transferring portion 73 may be built in the card side. Also, for example, the infrared-ray receiving/emitting portion 13a and the IrDA communication circuit 61 may be arranged on the card side whereas the file transferring portion 63 and the object transmitting/receiving portion 64 may be arranged on the main body side of the output device.

(Variation 8) As the division identifier used to detect the number of cases of the data, the “BEGIN:VCARD” may be used other than “END:VCARD”. Also, the command that is always described in the personal information data and is described only once in each case may be used. For example, the number of cases may be identified by “N” indicating “name”, or the like.

(Variation 9) The print layout can be automatically decided only by discriminating whether the number of the “END:VCARD” corresponds to the single case or all cases. For example, the name card layout can be automatically decided if the personal information data corresponds to the single case, and the phone book layout can be automatically decided if the personal information data corresponds to all cases. For instance, the name card layout and the phone book layout shown in FIG. 33, when the print layout is automatically decided according to the single case or all cases of the data, following rules are decided previously.

In the case of the single case data, any one of templates shown in FIGS. 33A to 33C is prepared. In the case of plural case data, the data are printed in the template of the phone book format shown in FIG. 33D. Such an advantage can be achieved that the user can print either in the name card format or in the phone book format when he or she selects simply the single case data or all case data from the cellular phone 14.

(Variation 10) In the first embodiment, the number of cases of the information contained in the data is decided by using the item (“property: value”, “END:VCARD”, or the like in the above embodiments) constituting the information in the vCard as the identifier. The identifier used to decide the number of cases of the information contained in the data is not limited to the item in the body DB of the data. For example, in the case where the file name (containing the extension) set on the cellular phone 14 side is different in the single case and all cases, the number of cases of the information contained in the data may be decided by the file name (containing the extension of the file). In this case, the print layout can be automatically decided by deciding simply whether the received data corresponds to the single case or all cases, based on the file name of the received data.

(Variation 11) In the above embodiments, explanation of the printing is made of the name card. But a card-like member such as a telephone card, a cash card, a staff member card, or the like can be similarly printed. In the above embodiments, the explanation is made by using the photograph of user's face. But the image data such as a logo mark of a company, a mark symbolically representing the activity, a photograph, or the like may be employed.

(Variation 12) The type and the size of the font may be designated by using the description information in the memo area.

(Variation 13) When the printing is executed by using the roll paper, a method of cutting the roll paper may be selected arbitrarily. For example, in the case where the data are printed in the name card layout, a rule of designating the cutting method based on the description information in the memo area either to cut the roll paper every single case data (normal state) or to cut the roll paper every predetermined cases after the data are printed in a predetermined number of cases can be made, and then this rule is registered previously on the printer 1.

(Variation 14) In the case where the data are printed in the name card layout or the phone book layout by selecting the roll paper, the method of cutting automatically the roll paper to match with the print layout mode may designated based on the description information in the memo area.

(Variation 15) Like the third embodiment, in the case where the infrared communication card is inserted into one slot in the printer 1 to which two card slots are provided and the memory card is inserted into the other slot, the data in the infrared communication can be saved in the memory card. According to this configuration, because the data are save temporarily in the memory card inserted into the printer, it is selected later whether or not the data should be printed.

(Variation 16) In the third embodiment, in the case where the infrared communication card 13 is inserted into the card slots 12a, 12b respectively, a function of executing the printing is provided to one infrared communication card 13 and a function of saving the data in the memory card in another format (e.g., SmartMedia, MEMORY STICK, or the like) is provided to the other infrared communication card 13. Also, a function of returning the message indicating whether the print data are being saved now or the data are being saved in the memory card MC is provided to the cellular phone 14. According to this configuration, the variation of the data transmitting portion from the cellular phone 14 to the printer 1 in the infrared communication is increased, and choices of the data transmission in use on the user side can be increased. The data printing and the data saving can be carried out at the same time.

The technical concepts (or ideas) that can be grasped from respective embodiments and respective variations will be set forth in the following.

(1) In the embodiments, the displaying portion is set in a radius range of 20 cm within the visual field from the communication port.

(2) In the embodiments, the displaying portion is set in a radius range of 10 cm within the visual field from the communication port.

(3) In the output device set forth in in the embodiments, the displaying portion is provided to the exposed portion of the radio communication device that is set in the slot.

(4) In the output device set forth in the embodiments, the communication port is provided to the radio communication device that is extractably inserted into the slot that the main body of the output device has and the displaying portion is provided to the radio communication device.

(5) In the output device set forth in the embodiments, the displaying portion has at least one lightening portion, and the display controlling portion turns ON the lightening portion in the lightening mode in response to the decision result of the deciding portion. According to this configuration, when the data are transmitted from the mobile terminal by using the radio communication medium (the infrared ray, or the like) having the directivity, for example, the user executes the data transmission to direct the transmitting portion of the mobile terminal to the receiving portion while looking at the receiving portion ahead in the directed direction. At this time, since the communication state is displayed on the displaying portion that lies in vicinity of the receiving portion at which the user looks now, the user can grasp easily the communication state.

(6) In the technical concept (5), the displaying portion classifies the informing contents of the receiving state by using combinations of the lightened color and the lightening mode.

(7) In the technical concept (6), the lightening mode consists of combinations of ON, OFF, and ON/OFF of the displaying portion.

(8) In any one of the technical concepts (6) and (7), the “ready for receiving” display and the “in receiving” display have the same color but the different lightening mode, and the “receiving error” display and the “reception completion” display have the different color from the “ready for receiving” display and also are different mutually in color.

(9) In the embodiments, the deciding portion decides the validity of the data immediately after the data reception is started. In this case, the error due to the unacceptable data can be detected at an early stage immediately after the data reception is started, and thus the user can be informed quickly of the effect. For example, such a situation can be avoided that the user is made unpleasant because he or she is informed of the error after he or she consumed about several tens second to one minute to end the data transmission. Here, “immediately after the data reception is started” signifies preferably 10 second or less after the data reception is started, more preferably 5 second or less after the data reception is started.

(10) In the output device set forth in the embodiments, the informing portion for informing the communication state by the sound upon receiving the data via the communication port is further provided.

(11) In the output device set forth in the technical concept (10), the informing portion informs of the communication state by the sound that is set previously to have different contents in response to the communication state.

(12) There is provided the radio communication device that is extractably inserted into the slot, which is provided to the main body of the output device, and has the configurations set forth in the embodiments.

1. An output device, comprising:
a radio communication interface portion, having a communication port capable of receiving data from a mobile terminal;
a displaying portion, informing a communication state upon receiving the data via the communication port; and
an outputting portion, executing an outputting process based on the data received via the radio communication interface portion,
wherein the displaying portion and the communication port are arranged in a visual field of an operator who operates the mobile terminal to transmit the data at a position that is a maximum communicable distance away from the communication port.

2. The output device as set forth in claim 1, wherein when a communication portion of the mobile terminal is placed the maximum communicable distance away from the communication port so as to oppose to the communication port, the displaying portion is arranged in a communicable area of the communication portion.

3. The output device as set forth in claim 1, further comprising an indicator, displaying receiving progress information of the data while the data is received from the communication port,
wherein the indicator is provided at a position that satisfies same positional condition as the displaying portion with respect to the communication port.

4. The output device as set forth in claim 1, wherein a screen of an operation panel is provided to a main body of the output device to direct upward; and
wherein the displaying portion is provided onto a front surface or a side surface of the main body of the output device.

5. The output device as set forth in claim 1, wherein the communication port is arranged at a position capable of receiving the data from the communication portion of the mobile terminal, the mobile terminal being located at a maximum communicable distance away from the communication port, and the mobile terminal being loaded on a same plane as a loading plane on which the output device is loaded.

6. The output device as set forth in claim 1, wherein the outputting portion is a printing portion that executes a printing process as the outputting process;
wherein a paper discharge port is provided on a front surface of the output device, and
wherein the communication port is arranged on at least one side of both sides of the paper discharge port at the front surface of the output device.

7. The output device as set forth in claim 1, wherein the communication port is arranged at a height of 10 cm or less from a bottom surface of the main body of the output device.

8. The output device as set forth in claim 1, further comprising a holder, holding the mobile terminal;
wherein the communication port is arranged at a position capable of communicating with the mobile terminal held in the holder, and
wherein the displaying portion is arranged at a position at which the displaying portion is not covered with the mobile terminal held in the holder and the holder.

9. The output device as set forth in claim 1, further comprising a deciding portion, deciding the communication state;
wherein the displaying portion displays a result of decision of the deciding portion.

10. An output device, comprising:
a main body;
a radio communication portion, extractably inserted into a slot that is provided in the main body; and
an outputting portion, executing an outputting process based on data that is received via the radio communication portion,
wherein the radio communication portion, including:
a communication port, receiving the data from a mobile terminal; and
a displaying portion, informing a communication state upon receiving the data via the communication port.

11. The output device as set forth in claim 10, further comprising an indicator, displaying receiving progress information of the data while the data is received from the communication port,
wherein the indicator is provided at a position that satisfies same positional condition as the displaying portion with respect to the communication port.

12. The output device as set forth in claim 10, wherein a screen of an operation panel is provided to a main body of the output device to direct upward; and
wherein the displaying portion is provided onto a front surface or a side surface of the main body of the output device.

13. The output device as set forth in claim 10, wherein the communication port is arranged at a position capable of receiving the data from the communication portion of the mobile terminal, the mobile terminal being located at a maximum communicable distance away from the communication port, and the mobile terminal being loaded on a same plane as a loading plane on which the main body of the output device is loaded.

14. The output device as set forth in claim 10, wherein the outputting portion is a printing portion that executes a printing process as the outputting process;
wherein a paper discharge port is provided on a front surface of the output device, and
wherein the communication port is arranged on at least one side of both sides of the paper discharge port at the front surface of the output device.

15. The output device as set forth in claim 10, wherein the communication port is arranged at a height of 10 cm or less from a bottom surface of the main body of the output device.

16. The output device as set forth in claim 10, further comprising a holder, holding the mobile terminal;
wherein the communication port is arranged at a position capable of communicating with the mobile terminal held in the holder, and
wherein the displaying portion is arranged at a position at which the displaying portion is not covered with the mobile terminal held in the holder and the holder.

17. The output device as set forth in claim 10, wherein the radio communication portion has a first deciding portion;
wherein the main body has a second deciding portion;
wherein the first deciding portion executes a first check of the data received by the radio communication portion;
wherein the second deciding portion executes a second check of the data transferred from the radio communication portion to the main body; and
wherein the displaying portion informs results of the first check and the second check.

18. The output device as set forth in claim 10, wherein the radio communication portion includes;
a first transferring portion, receiving the data from the mobile terminal; and
a second transferring portion, transferring the data to the main body; and
wherein the displaying portion informs an error occurrence when the error occurs in the second transferring portion after the first transferring portion completes a transferring process.

19. The output device as set forth in claim 10, further comprising a deciding portion, deciding the communication state;
wherein the displaying portion displays a result of decision made by the deciding portion.

20. An output device, comprising:
a radio communication interface portion, having a communication port that receives data from a mobile terminal;
a deciding portion, deciding a communication state upon receiving the data via the communication port;
a displaying portion, informing the communication state;
a display controlling portion, causing the displaying portion to display a result of decision made by the deciding portion; and
an outputting portion, executing an outputting process based on the data received via the radio communication interface portion.

21. An output method, comprising the steps of:
receiving data that is transmitted from a mobile terminal in a radio communication;
deciding a communication state upon receiving the data;
informing the communication state;
controlling a display mode in response to a result of decision of the communication state made in the deciding step; and
executing an outputting process based on the data received in the receiving step.

22. The output method as set forth in claim 21, further comprising a step of displaying the communication state as character information.

23. The output method as set forth in claim 21, further comprising a light emitting step of informing the communication state by a lightening mode of a light emitting portion.

24. The output method as set forth in claim 21, further comprising a step of displaying image or character information to inform a content of the communication state.

25. The output method as set forth in claim 21, wherein the display controlling step controls a lightening color of the light emitting portion in response to the result of decision.

26. The output method as set forth in claim 21, wherein the displaying step displays a content that the data can be received when it is decided that the communication state indicates a data receivable state in the deciding step.

27. The output method as set forth in claim 21, wherein the displaying step displays a content that the data are being received when the communication state decided in the deciding step indicates that the data are in reception.

28. The output method as set forth in claim 21, wherein the displaying step displays a content that a data reception is completed when the communication state decided in the deciding step indicates a data-reception completion state.

29. The output method as set forth in claim 21, wherein the displaying step displays a content that a receiving error occurs when the communication state decided in the deciding step indicates an error occurrence state.

30. The output method as set forth in claim 21, wherein the outputting process in the outputting step is a printing process.

31. The output method as set forth in claim 21, wherein the printing process is started after data reception from the mobile terminal is completed.

32. The output device, comprising:
a radio communication interface portion, having a communication port which receives data from a mobile terminal;
a deciding portion, deciding a data received state via the radio communication interface portion;
a displaying portion, displaying a communication state decided by the deciding portion by using at least one of a character and an image; and
an outputting portion, executing an outputting process based on the data received via the radio communication interface portion.

33. An output device, comprising:
a main body;
a radio communication portion, extractably inserted into a slot that is provided to the main body; and
an outputting portion, executing an outputting process based on data received via the radio communication portion;
wherein the radio communication portion includes:
a displaying portion;
a deciding portion, deciding a validity of data received by the radio communication portion; and
a display controlling portion, controlling the displaying portion to a display mode in response to a result of decision made by the deciding portion.

34. An output device, comprising:
a main body;
a radio communication portion, extractably inserted into a slot that is provided to the main body; and
an outputting portion, executing an outputting process based on data received via the radio communication portion;
wherein the radio communication portion includes:
a displaying portion,
a deciding portion, deciding a validity of data received by the radio communication portion, and
a display controlling portion, causing the displaying portion to display a result of decision made by the deciding portion.

35. An output device, comprising:
a main body;
a radio communication portion, extractably inserted into a slot that is provided to the main body;
an outputting portion, executing an outputting process based on data received via the radio communication portion;
a displaying portion;
a deciding portion, deciding a validity of data received by the radio communication portion; and
a display controlling portion, causing the displaying portion to display a result of decision made by the deciding portion,
wherein the displaying portion is provided on the radio communication portion, and
wherein the deciding portion is provided on the main body.

36. An output device, comprising:
a main body;
a radio communication portion, extractably inserted into a slot that is provided to the main body; and
an outputting portion, executing an outputting process based on data received via the radio communication portion;
wherein the radio communication portion includes:
a displaying portion; and
a first deciding portion, deciding a validity of received data;
wherein the main body includes a second deciding portion which decides another validity, a content of which are different from the first deciding portion, of data received via the radio communication device; and
wherein the displaying portion displays results of decision made by the first deciding portion and the second deciding portion.

37. An output method, comprising:
a first receiving step of receiving data that is transmitted from a mobile terminal in a radio communication;
a deciding step of deciding a validity of received data;
a displaying step of displaying a result of decision in the deciding step; and
an outputting step of executing an outputting process based on the received data.

38. The output method as set forth in claim 37, wherein the displaying step displays a display mode in response to the result of decision made in the deciding step.

39. The output method as set forth in claim 37, further comprising:
at least one second receiving step of receiving data that is transmitted in another communication that is different from the radio communication in the first receiving step; and
a limiting step of limiting a simultaneous reception of the data in the first receiving step and the data in the second receiving step.

40. The output method as set forth in claim 39, wherein the deciding step decides whether or not a communication state is ready for receiving the data.

41. The output method as set forth in claim 40, wherein the displaying step displays a content that the communication state is ready for receiving the data when it is decided in the deciding step that the communication state is ready for receiving the data.

42. The output method as set forth in claim 40, wherein the displaying step displays a content that the data are being received when the communication state decided in the deciding step indicates that the data are in reception.

43. The output method as set forth in claim 40, wherein the displaying step displays a content that a data reception is completed when the communication state decided in the deciding step indicates a data-reception completion state.

44. The output method as set forth in claim 40, wherein the displaying step displays a content that a receiving error occurs when the communication state decided in the deciding step indicates an error occurrence state.

45. The output method as set forth in claim 40, wherein the outputting process executed in the outputting step is a printing process.

46. The output method as set forth in claim 45, wherein the printing process is started after data reception from the mobile terminal is completed.

47. The output method as set forth in claim 37, wherein the deciding step decides a validity of the received data on a basis of reference data, and
wherein the reference data is of type that is applicable to an output device that executes the outputting process.

48. An output device, comprising:
a radio communication interface portion, having a communication port capable of receiving data from a mobile terminal;
an informing portion, informing a communication state upon receiving the data via the communication port; and
an outputting portion, executing an outputting process based on the data received via the radio communication interface portion;
wherein the informing portion informs the communication state by a sound that is set previously to different contents in response to the communication state.

49. An output method, comprising:
a first receiving step of receiving data transmitted from a mobile terminal in a radio communication;
a first deciding step of deciding a validity of received data;
a second deciding step of deciding another validity, contents of which are different from the first deciding step, of the received data; and
a displaying step of displaying results of decision made in the first deciding step and the second deciding step.

50. A radio communication device, comprising:
a main body of the communication device, which is set extractably in a slot that is provided on a main body of an output device;
a communication port, receiving data from a mobile terminal, and provided on an exposed area of the main body of the communication device when the main body of the communication device is inserted into the slot; and
a displaying portion, displaying a display mode in response to a communication state upon receiving the data via the communication port, and provided on an exposed area of the main body of the communication device when the main body of the communication device is inserted into the slot.

51. A radio communication device, comprising:
a main body, for being set extractably in a slot that is provided to a main body of an output device;
a communication port, receiving data from a mobile terminal, and provided to an exposed area of the main body when the main body is inserted into the slot;
a displaying portion, provided to an exposed area of the main body when the main body is inserted into the slot;
a monitoring portion, monitoring a communication state upon receiving the data via the communication port; and
a display controlling portion, controlling the displaying portion into a display mode in response to a monitoring result obtained by the monitoring portion.

52. A computer-readable recording medium for causing a computer to execute the output method set forth in any one of claims 21 to 31.

53. A computer-readable recording medium for causing a computer to execute the output method set forth in any one of claims 37 to 47.

54. A computer-readable recording medium for causing a computer to execute the output method set forth in claim 49.
